(19) United States
(12) Patent Application Publication
(10) Pub. No.: US 2026/0185019 A1
(43) Pub. Date: Jul. 2, 2026

(54) Detergents and Cleaning Compositions with Improved Bleaching Performance

(71) Applicant: Symrise AG, Holzminden (DE)

(72) Inventors: Tony BARTOLINI, Herblay-sur-Seine (FR); Anne-Laure AZAIS, Poissy (FR)

(21) Appl. No.: 19/124,283

(22) PCT Filed: Oct. 25, 2023
(86) PCT No.: PCT/EP2023/079852

§ 371 Date: Apr. 24, 2025

(30) Foreign Application Priority Data
Oct. 25, 2022 (WO) PCT/EP2022/079763

(51) Int. Cl. C11D 3/395; C11D 3/386

(52) U.S. Cl. CPC C11D 3/3951; C11D 3/38636; C11D 3/3953; C11D 3/3958

(57) ABSTRACT

The present invention refers generally to the field of detergents and cleaning compositions. In particular, the present invention relates to detergents and cleaning compositions comprising specific hydroxyl compounds and having improved bleaching performance. More specifically, the present invention relates to detergents and cleaning compositions that comprise an effective amount of a specific type of bleach boosting agent, such as alkanediols as defined herein, glyceryl caprylate, 4-hydroxyacetophenone, tropolone, or a mixture of said bleach boosting agents, and a surfactant, and the use of said detergents and cleaning compositions for the preparation of a detergent and cleaning product for household, institutional and industrial application. Furthermore, the present invention relates to a method of treating a bleachable stained and/or soiled substrate using the detergents and cleaning compositions according to the present invention. Additionally, the present invention relates to the use of a specific bleach boosting substance as defined herein for improving the bleaching power of a bleaching agent in a detergent and cleaning composition and/or for boosting stain and/or soil removal of a detergent and cleaning composition. Finally, the present invention relates to a method of improving the bleaching power of a bleaching agent in a detergent and cleaning composition and/or of boosting stain and/or soil removal of a detergent and cleaning composition by adding an effective amount of a specific bleach boosting agent, such as alkanediols as defined herein, glyceryl caprylate, 4-hydroxyacetophenone, tropolone, or a mixture of said bleach boosting agents, to said detergent and cleaning composition.

### TECHNICAL FIELD

The present invention refers generally to the field of detergents and cleaning compositions. In particular, the present invention relates to detergents and cleaning compositions comprising specific hydroxyl compounds and having improved bleaching performance.

More specifically, the present invention relates to detergents and cleaning compositions that comprise an enzyme and an effective amount of a specific type of bleach boosting agent, such as alkanediols as defined herein, glyceryl caprylate, 4-hydroxyacetophenone, tropolone, or a mixture of said bleach boosting agents, and a surfactant, and the use of said detergents and cleaning compositions for the preparation of a detergent and cleaning product for household, institutional and industrial application. Furthermore, the present invention relates to a method of treating a stained and/or soiled substrate using the detergents and cleaning compositions according to the present invention. Additionally, the present invention relates to the use of specific bleach boosting substances as defined herein for improving the bleaching power of a bleaching agent in a detergent and cleaning composition and for boosting stain and/or soil removal of a detergent and cleaning composition. Finally, the present invention relates to a method of improving the bleaching power of a bleaching agent in a detergent and cleaning composition and of boosting stain and/or soil removal of a detergent and cleaning composition by adding an effective amount of a specific type of bleach boosting agent, such as alkanediols as defined herein, glyceryl caprylate, 4-hydroxyacetophenone, tropolone, or a mixture of said bleach boosting agents, to said detergent and cleaning composition.

### BACKGROUND ART

Detergents and cleaning compositions must remove a wide variety of stains and soils form different substrate type under a broad range of cleaning conditions. Detergents and cleaning compositions, in particular for laundry and textile cleaning, dishwashing and the like are composed predominantly of surfactants or a mixture of surfactants, whose main task is to remove water-insoluble substances like dirt and grease from surfaces such as fabric, clothes, dishes, wares, etc., and hard surfaces such as metals, plastics, glass, ceramics, etc. Other than surfactant, modern detergent and cleaning formulations consist of builders, chelating agents, co-builders and other polymer additives used for specific washing or cleaning effects such as soil release and anti-redeposition, dye transfer inhibition and rheology modification. In addition to said ingredients, one or more bleaching agents as a further active substance are added to the detergents and cleaning compositions.

Aqueous solutions of sodium hypochlorite (NaOCl) are strong bleaching agents. However, they have some disadvantages since they are nonselective and capable of oxidizing a broad spectrum of fabric dyes, fading them, damage coloured silk and wool fabrics and are therefore limited to use in white laundry and thy have a strong odor. Bleaching with sodium hypochlorite NaOCl is also the subject of much debate due to the potential generation of chlorinated by-products which are deemed harmful to the environment.

As bleaching agents, oxygen bleaches are much less effective than chlorine bleaches. However, they do have some advantages over chlorine bleaches, such as less potential damage to textile fibers and dyes, and lack of strong odor.

Attempts have been made to increase the bleaching power of hydrogen peroxide-based bleaches by the addition of heavy metal catalysts. However, the effectiveness of these systems remains controversial; and early attempt to incorporate a catalyst into a laundry detergent led to fabric damage.

The loss of bleaching power in a detergent and cleaning composition results in a loss of cleaning performance.

The detergent and cleaning industry is permanently searching for ingredients which can resolve these negative aspects.

Thus, there is still an ongoing need for substances with the ability for enhancing bleaching performance in detergents and cleaning compositions containing bleaching agents by improving removal of bleachable stain and/or soil on substrates.

In addition, there is a need for detergents and cleaning compositions which are less complex, highly effective, which avoid the use of unfavourable ingredients under environmental and health aspects.

Accordingly, it is therefore an object of the present invention to provide for multi-use detergents and cleaning compositions with a superior bleaching performance and with an improved cleaning performance.

Moreover, it is an object of the present invention to provide for a method of treating a stained and/or soiled substrate that furnished an improved cleaning performance in terms of improved bleachable stain and/or soil removal.

It is another object of the present invention to provide for substances, which are capable of boosting the bleaching power of a bleaching agent a bleaching agent mixture in a detergent and cleaning composition and/or of facilitating/improving the removal of stain and/or soil, in particular bleachable stain and/or soil, from a substrate, and, thus, improving the cleaning performance of a detergent and cleaning composition.

Finally, it is an object of the present invention, to provide a method of increasing the bleaching power of a bleaching agent in a detergent and cleaning composition and/or to improving the overall cleaning performance of a detergent and cleaning composition in terms of stain and/or soil removal, in particular bleachable stain and/or soil removal.

Surprisingly, it has been found that the addition of an effective amount of a specific type of bleach boosting agent, such as alkanediols having a carbon chain of 5 to 11 carbon atoms, glyceryl caprylate, 4-hydroxyacetophenone, tropolone, or a mixture of said bleach boosting agents, to a detergent and cleaning composition comprising a bleaching agent or a mixture of bleaching agents, has a positive impact in that they enhance the bleaching power of the bleaching agent or of the bleaching agent mixture. The detergents and cleaning compositions according to the present invention show a superior bleaching power, compared to detergents and cleaning compositions without such a bleach boosting agent.

Surprisingly, it has been found that the addition of an effective amount of a specific type of bleach boosting agent, such as alkanediols having a carbon chain of 5 to 11 carbon atoms, glyceryl caprylate, 4-hydroxyacetophenone, tropolone, or a mixture of said bleach boosting agents, to a detergent and cleaning composition, facilitate/improves removal of bleachable stain and/or soil, resulting in a more cleanliness, compared to detergents and cleaning compositions without such a bleach boosting agent.

Thus, the detergents and cleaning compositions in combination with said specific type of bleach boosting agent, such as alkanediols, glyceryl caprylate, 4-hydroxyacetophenone, or tropolone, or a mixture of said bleach boosting agents, exhibit improved overall performance, resulting from a combination of enhanced bleaching power of the bleaching agent and improved removal of bleachable stain and/or soil, im comparison to detergents and cleaning compositions without such a bleach boosting agent.

Conversely, also because of the boosting effect, the amount of bleaching agent and other ingredients for increasing the bleaching in these detergents and cleaning compositions can be reduced to achieve a similar cleaning effect, i.e. without loss of cleaning performance. The detergents and cleaning compositions show even at a low rate of addition of the bleach boosting agent improved bleaching and improved cleaning performance.

### SUMMARY OF THE INVENTION

The present invention was made in view of the disadvantages described above. To solve the above-mentioned drawbacks, the present invention provides a detergent and cleaning composition having improved bleaching performance and improved cleaning performance in terms of improved bleachable stain and/or soil removal.

In order to accomplish the above problem, the present invention provides in a first aspect a detergent and cleaning composition, comprising or consisting of
(a1) at least one bleaching agent and optionally at least one bleach activator;
(b1) 1,2-heptanediol;
(c1) at least one surfactant; and
(d1) optionally at least one enzyme or an enzyme formulation, comprising at least one enzyme;
or
(a2) at least one bleaching agent and optionally at least one bleach activator;
(b2) 2,3-heptanediol;
(c2) at least one surfactant; and
(d2) optionally at least one enzyme or an enzyme formulation, comprising at least one enzyme;
or
(a3) at least one bleaching agent and optionally at least one bleach activator;
(b3) a mixture comprising 1,2-heptanediol and 2,3-heptanediol; and
(c3) at least one surfactant; and
(d3) optionally at least one enzyme or an enzyme formulation, comprising at least one enzyme.

Alternatively, in another aspect, the present invention provides a detergent and cleaning composition, comprising or consisting of
(a) at least one bleaching agent and optionally at least one bleach activator;
(b) at least one bleach boosting agent selected from the group consisting of
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) tropolone; and
   any mixture thereof;
(c) at least one surfactant; and
(d) optionally at least one enzyme or an enzyme formulation, comprising at least one enzyme.

In a preferred variant, the present invention provides a detergent and cleaning composition, comprising or consisting of
(c) at least one bleaching agent and optionally at least one bleach activator;
(d) at least one bleach boosting agent selected from the group consisting of
   (b^{I}) at least one linear alkanediol having a carbon chain of 5 to 11 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) tropolone; and
   any mixture thereof;
(e) at least one surfactant; and
(f) optionally at least one enzyme or an enzyme formulation, comprising at least one enzyme.

In a preferred variant, the present invention provides a detergent and cleaning composition, comprising or consisting of
(e) at least one bleaching agent and optionally at least one bleach activator;
(f) at least one bleach boosting agent selected from the group consisting of
   (b^{I}) at least one linear alkanediol having a carbon chain of 5 to 11 carbon atoms or a mixture comprising at least one first linear alkanediol having a carbon chain of 5 to 11 carbon atoms and one or more second linear alkanediols having a carbon chain of 5 to 11 carbon atoms which is different from the first linear alkanediol;
   (b^{II}) glyceryl caprylate;
   (b^{III}) 4-hydroxyacetophenone;
   (b^{IV}) tropolone; and
   any mixture thereof;
(g) at least one surfactant; and
(h) optionally at least one enzyme or an enzyme formulation, comprising at least one enzyme.

In a further aspect, the present invention provides for the use of the detergent and cleaning composition as, or for the preparation of a detergent and cleaning product.

In a further aspect, the present invention provides for a detergent and cleaning product.

In a still further aspect, the present invention provides for a method of treating a stained and/or soiled substrate, comprising the steps of
treating the substrate with the detergent and cleaning composition or product according to the present invention; and
rinsing said substrate in water to remove said composition or product.

In a further aspect, the present invention provides for the use of at least one bleach boosting agent selected from the group consisting of
(b^{I}) at least one linear alkanediol having a carbon chain of 5 to 11 carbon atoms or a mixture comprising at least one first linear alkanediol having a carbon chain of 5 to 11 carbon atoms and one or more second linear alkanediols having a carbon chain of 5 to 11 carbon atoms which is different from the first linear alkanediol;
(b^{II}) glyceryl caprylate;
(b^{III}) 4-hydroxyacetophenone;
(b^{IV}) tropolone; and
any mixture thereof;
for improving the bleaching power of a bleaching agent in a detergent and cleaning composition and/or for boosting bleachable stain and/or soil removal of a detergent and cleaning composition.

In a final aspect, the present invention provides for a method of improving the bleaching power of a bleaching agent in a detergent and cleaning composition and/or of boosting stain and/or soil removal of a detergent and cleaning composition, comprising the steps of
(i) providing a detergent and cleaning composition comprising a bleaching agent; and
(ii) adding thereto an effective amount of at least one bleach boosting agent selected from the group consisting of
   (b^{I}) at least one linear alkanediol having a carbon chain of 5 to 11 carbon atoms or a mixture comprising at least one first linear alkanediol having a carbon chain of 5 to 11 carbon atoms and one or more second linear alkanediols having a carbon chain of 5 to 11 carbon atoms which is different from the first linear alkanediol;
   (b^{II}) glyceryl caprylate;
   (b^{III}) 4-hydroxyacetophenone;
   (b^{IV}) tropolone; and
   any mixture thereof.

The present invention is specified in the appended claims. The invention itself, and its preferred variants, other objects and advantages, are however also apparent from the following detailed description in conjunction with the accompanying examples and figures.

All percentages are by weight unless otherwise indicated.

Numeric ranges recited within the specification and given in the form “x to y” include the values defining the range and include each integer within the defined range. When multiple preferred numeric ranges are specified in this format, all ranges created by combining the various endpoints are also included.

In the context of the present invention, the term “comprising” means that the named components are essential, but other components may be added and is still embraced by the present invention.

The term “consisting of” as used according to the present invention means that the total amount of components (a) to (c) of a composition adds up to 100% by weight, based on the total weight of the composition, and signifies that the subject matter is closed-ended and can only include the limitations that are expressly recited.

Whenever reference is made to “comprising” it is intended to cover both meanings as alternatives, that is the meaning can be either “comprising” or “consisting of”, unless the context dictates otherwise.

In the context of the present invention, the term “at least one . . . ” means that the detergent and cleaning composition according to the present invention can comprise either one or a mixture of two, three, four, five, six or even more different of the respective components following said term.

The term “and/or” expresses that a linkage exists, or an alternative is provided.

The term “optionally” means that the subsequently described component may but need not to be present in the detergent and cleaning composition, and that the description includes variants, where the compound is included or variants, where the compound is absent.

The term “stability” in the context of the present invention means resistance or the degree of resistance to change, unfolding, disintegration, denaturation or activity loss. Non-limiting examples of stability include storage stability and reflects the stability of a polypeptide, such as an enzyme, as a function of time, e.g. how much activity is retained when said polypeptide is kept in a detergent or cleaning formulation. The stability is influenced by many factors, such as presence of chelators, pH, temperature, detergent composition, e.g. amount of builders, surfactants, etc.

The term “boosting” in the context of the present invention means “improving”, “enhancing”, “increasing”. Correspondingly, a “boosting agent” is either a single agent or a mixture of substances capable of “improving”, “enhancing”, “increasing” certain features or properties as defined herein. In particular the bleach boosting agent according to the present invention improves, enhances or increases the bleaching power of a detergent or cleaning composition comprising a bleaching agent, thus resulting in an enhanced bleaching power and improved removal of bleachable stain and/or soil.

As used herein, the term “alkyl” refers to saturated hydrocarbons having one or more carbon atoms, including straight-chain alkyl groups (such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, etc.), cyclic alkyl groups (or cycloalkyl or alicyclic or carbocyclic groups) (such as cyclopropyl, cyclopentyl, cyclohexyl, cycloheptyl, cyclooctyl, etc.), branched-chain alkyl groups (such as isopropyl, tert-butyl, sec-butyl, isobutyl, etc.) and alkyl substituted alkyl groups (such as cycloalkyl-substituted alkyl groups).

Unless otherwise specified, the term “alkyl” includes both unsubstituted alkyls and substituted alkyls. As used herein, the term “substituted alkyls” refers to alkyl groups having substituents, replacing one or more hydrogens on one or more carbons of the hydrocarbon backbone. Such substituents may include, for example, alkenyl, alkynyl, halogen, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonate, cyano, amino, imino, sulfhydryl, alkylthio, arylthiol, thiocarboxylate, sulfates, alkylsulfinyl, sulfonates, nitro, etc.

### DETAILED DESCRIPTION OF THE INVENTION

In a first aspect, the present invention relates to a detergent and cleaning composition, comprising or consisting of
(a1) at least one bleaching agent and optionally at least one bleach activator;
(b1) 1,2-heptanediol;
(c1) at least one surfactant; and
(d1) optionally at least one enzyme or an enzyme formulation, comprising at least one enzyme.

Alternatively, the present invention relates in a first aspect to a detergent and cleaning composition, comprising or consisting of
(a2) at least one bleaching agent and optionally at least one bleach activator;
(b2) 2,3-heptanediol;
(c2) at least one surfactant; and
(d2) optionally at least one enzyme or an enzyme formulation, comprising at least one enzyme.

In a further alternative, the present invention relates in a first aspect to a detergent and cleaning composition, comprising or consisting of
(a3) at least one bleaching agent and optionally at least one bleach activator;
(b3) a mixture comprising 1,2-heptanediol and 2,3-heptanediol;
(c3) at least one surfactant; and
(d3) optionally at least one enzyme or an enzyme formulation, comprising at least one enzyme.

Alternatively, in another aspect, the present invention relates to a detergent and cleaning composition, comprising or consisting of
(a) at least one bleaching agent and optionally at least one bleach activator;
(b) at least one bleach boosting agent selected from the group consisting of
   (b^{I}) at least one linear alkanediol having a carbon chain of 5 to 11 carbon atoms or a mixture comprising at least one first linear alkanediol having a carbon chain of 5 to 11 carbon atoms and one or more second linear alkanediols having a carbon chain of 5 to 11 carbon atoms which is different from the first linear alkanediol;
   (b^{II}) glyceryl caprylate;
   (b^{III}) 4-hydroxyacetophenone;
   (b^{IV}) tropolone; and
   any mixture thereof;
(c) at least one surfactant; and
(d) optionally at least one enzyme or an enzyme formulation, comprising at least one enzyme.

In a more preferred variant, the present invention relates to a detergent and cleaning composition, wherein the at least one linear alkanediol has a carbon chain length from 7 to 11 carbon atoms.

The term “detergent and cleaning composition” as contemplated herein, is understood to mean all products that are suitable and commonly used for washing or cleaning. Detergents and cleaning compositions are composed predominantly of surfactants or a mixture of surfactants. Other than surfactant, the detergents and cleaning compositions normally consists of builders and chelating agents, co-builders and other polymer additives used for specific effects such as anti-redeposition, dye transfer inhibition, rheology modification. Detergents and cleaning compositions refer to compositions that find use in the removal of undesired compounds from items to be cleaned, such as textiles (such as fabrics, clothes), dishes, floors, hard surfaces (such as metals, plastics and ceramics). These deposits might be caused by stains and soils, germs and other contaminants. Detergents are the most commonly used cleaning compositions for textiles. The detergents and cleaning compositions may be used for both household cleaning, institutional cleaning and industrial cleaning. The detergents and cleaning compositions also includes disinfectants that kills all vegetative cells including recognized pathogenic microorganism. The detergents and cleaning compositions can be used by the detergent composition itself or by a detergent product or by a use solution thereof.

The detergents and cleaning compositions according to the present invention are preferably used for removing stain and/or soil from textile, fabrics, laundry, dishes, ware, medical and dental instruments, hard surfaces, etc. More preferably, the detergents and cleaning compositions according to the present invention are preferably used for removing bleachable stain and/or soil.

Within the scope of the present invention the terms “cleaning” and “washing” are used synonymously and refer to the reduction and/or removal of deposits, i.e. the removal of undesired compounds from items to be cleaned, on tableware/dishes and other kitchen utensils such as cutlery/silverware, pots, pans, bakeware and the like.

These deposits might be formed by stains caused by tea, chocolate, coffee, grass, red wine, grass/mud, fruit juice, blood, tomato puree, unused motor oil, salad dressing balsamic, cooked beef fat, French squeezy mustard, make-up, and the like or by soils caused by grease, starch based soils such as rice, pasta, protein based soils such as egg yolk, chocolate, mayonnaise, lipstick starch based soil, and the like and other remaining on the surfaces. Deposits are thus any form of unwanted residues of impureness, of dirt, food, grease etc.

The term “substrate” in the context of the present invention includes fabrics, textiles, laundry, dishes, ware, carpets, any hard surfaces, medical and dental instruments, and the like which can be contaminated with stain and/or soil and can be treated by a washing or cleaning process.

As used herein, the term “fabric cleaning” includes detergents and cleaning compositions or products designed for cleaning stained and/or soiled material. Such compositions or products include but are not limited to, laundry detergent compositions, fabric softening compositions, fabric enhancing compositions, fabric freshening compositions, laundry prewash, laundry pre-treat, laundry additives, spray products, dry cleaning agents or compositions, laundry rinse additive, wash additive, post-rinse fabric treatment, ironing aids, unit dose formulations, delayed delivery formulations, detergent contained on or in a porous substrate or nonwoven sheet, substrate having fibres preferably said fibres including active agents, and other suitable forms that may be apparent to one skilled in the art.

As used herein, the term “fabric care” relates to various fabric benefits including smoothness, shape maintenance, resilience, colour preservation, pilling control and others.

The term “dish” or “ware” as used herein, refers to a solid surface, such as a counter top, tile, floor, wall, panel, window, plumbing fixture, kitchen and bathroom furniture, appliance, engine, circuit board, and dish. Hard surfaces may include for example, health care surfaces, such as surfaces of medical or dental instruments, medical or dental devices, electronic apparatus employed for monitoring patient health, and floors, walls or fixtures of structures in which health care occurs, and food processing surfaces, such as a surface of a took, a machine, equipment, a structure, or the like, that is employed as part of a food processing, preparation or storage activity. The term “ware” in the context of the present invention refers to items such as eating and cooking utensils, dishes, and other hard surfaces such as showers, sinks, toilets bathtubs, countertops, windows, mirrors, and floors.

The term “surface” as used herein, refers to a solid surface, such as a counter top, tile, floor, wall, panel, window, plumbing fixture, kitchen and bathroom furniture, appliance, engine, circuit board, and dish. Hard surfaces may include for example, health care surfaces, such as surfaces of medical or dental instruments, medical or dental devices, electronic apparatus employed for monitoring patient health, and floors, walls or fixtures of structures in which health care occurs, and food processing surfaces, such as a surface of a tool, a machine, equipment, a structure, or the like, that is employed as part of a food processing, preparation or storage activity.

Surprisingly, it was found that the addition of a bleach boosting agent as specified or a mixture of said bleach boosting agents, to a detergents and cleaning compositions according to the present invention provides for both, enhanced bleaching performance, improved stain and/or soil removal, preferably bleachable stain and/or soil removal, and, thus improved overall performance of the detergent and cleaning composition.

The bleaching agent in combination with a bleach boosting agent is preferably used for the bleaching of stain and/or soil, in particular in an aqueous surfactant containing liquor. The term “bleaching of stain and/or soil” is to be understood in its broadest sense and includes the bleaching of colored dirt present on a textile, fabric, dish, on a surface, the bleaching of colored dirt that is present in the washing liquor and has been removed from the textile or a surface, and the oxidative destruction of textile dyes that are present in the washing liquor and have been removed from textiles under the washing conditions before said textile dyes can be absorbed onto textiles of different colors.

### Bleaching Agent/Bleach Activator/Component (a1, a2, a3, a)

The detergent and cleaning composition according to the present invention comprises at least one bleaching agent as component (a). The bleaching agent provides for a bleaching effect and cleanliness benefit.

Bleaching agents are substances that possess useful oxidative or reductive properties that decompose stains and soils into colorless, soluble particles. Bleaching agents can be used for textile, for laundering as well as for surfaces. Bleaching agents can also brighten and whiten fabrics.

Stains and/or soils are discolorations caused by intensely coloured substances, which even in small amounts can affect the colour and appearance of a fabric. Coloured stains and/or soils are usually either vegetable in origin (typically anthocyanin, carotenoid, or porphyrin in structure) or caused by artificial food colorants and cosmetic ingredients. Very often, stains are complex mixtures of food preparations and beverages.

Bleaching agents work by cutting the stain and/or soil molecule into smaller pieces and polar groups are introduced, so that the stain becomes more hydrophilic and easier to remove or disperse in the bleaching process. Alternatively, bleaching agents may work by removing the colour of the stain and/or soil so it becomes invisible. These two processes may work simultaneously on a given stain and/or soil.

Bleaching agents can be included directly in a detergent and cleaning composition to remove bleachable stain and/or soil during a washing or cleaning cycle or they can also be offered as stain remover, such as pre-spotter or vanish, for pre-treatment before a washing or cleaning cycle, that have been formulated to boost the stain and/or soil removal efficacy of detergents and cleaning compositions.

The most common bleaching agents generally fall into three categories: (1) halogen bleaches and their related compounds, such as chlorine bleaches, such as sodium hypochlorite and sodium dichloroisocyanurate, (2) oxygen (oxygen based) bleaches, such as hydrogen peroxide, percarbonates, perborates, perphosphates, persulfates, persilicates, and percarboxylic acid bleaches, and (3) reducing bleaches, such as sulfur dioxide, sulfurous acid, bisulfites, sulfites, and the like.

Halogen bleaches: Halogen bleaching agents are the most cost-effective bleaching agents and are mostly based on chlorine or bromine. They are very effective at removing stains and soils. The most common halogen bleaches may be divided into four classes: chlorine, hypochlorites, N-choro compounds, and chlorine dioxide.

Oxygen bleaches: Oxygen-based bleaches, also known as peroxygen bleaches, contain the peroxide linkage: (—O—O—) in which one of the oxygen atoms is active. Hydrogen peroxide is one of the most common of these bleaching agents.

Hydrogen peroxide bleaching is performed in alkaline solution where part of the hydrogen peroxide is converted to the perhydroxy anion H2O2⇄H+ +HO2-. The perhydroxy anion HO2- is generally believed to be the active bleaching species. The alkaline agents most commonly used to generate HO2- are caustic soda, carbonates, silicates, pyrophosphates and polyphosphates.

Suitable organic or inorganic peroxygen compounds are organic peracids or peracid salts of organic acids, such as phthalimido peroxycaproic acid, perbenzoic acid or salts of diperdodecanedioic acid, but in particular inorganic peroxygen compounds such as hydrogen peroxide and inorganic salts that release hydrogen peroxide under the conditions of cleaning, such as perborate, percarbonate and/or persilicate, and hydrogen peroxide inclusion compounds, such as H2O2 urea adducts. Hydrogen peroxide can also be produced by means of an enzymatic system, i.e., an oxidase and the substrate thereof. If solid peroxygen compounds are intended to be used, these may be used in the form of powders or granules, which may also be coated in a manner known in principle.

The peroxygen compounds can be added to the detergent and cleaning composition as such or in the form of agents containing them. The use of alkali percarbonate, alkali perborate monohydrate or hydrogen peroxide in the form of aqueous solutions containing from 3 wt. % to 10 wt. % of hydrogen peroxide is particularly preferred.

Here and in the following, sodium is the preferred alkali metal.

Hydrogen peroxide reacts with many compounds, such as carbonates, borates, pyrophosphates, sulfates, silicates and with a variety of organic carboxylic acids, esters and anhydrides to give peroxy compounds or peroxyhydrates. A number of these compounds are stable solids that hydrolyse readily to give hydrogen peroxide in solution, the most important being sodium perborate and sodium percarbonate. Solid oxygen bleaches, are preferred for stability and compatibility with other sensitive ingredients. Another solid oxygen bleach, peroxymonosulfuric acid (the peroxygen product of hydrogen peroxide and sulfuric acid) is a powerful oxidizing agent. A commercially available salt, potassium peroxymonosulfate, is a white solid having a satisfactory shelf life and an active oxygen content of about 4.4%. It is a triple salt with the composition 2KHSO5·K2SO4·KHSO4.

Suitable peroxygen bleaching compounds include sodium percarbonate, sodium perborate tetrahydrate and sodium perborate monohydrate, which serve as bleaching agents and yield H2O2 in water. Other usable bleaches are peroxypyrophosphates, urea peroxyhydrate, and sodium peroxide. Persulfate bleach (e.g., OXONEO®, manufactured commercially by DuPont) can also be used. Optionally, the percarbonate can be coated with silicate, borate or water-soluble surfactants.

Other usable bleaching agents are H2O2 supplying peracids or peracid salts. Peracids are compounds containing the functional group —OOH derived from an organic or inorganic acid functionality. Typical structures include CH3C(O)OOH derived from acetic acid and HOS(O)2OOH derived from sulfuric acid. Peracids have superior cold water bleaching capability versus hydrogen peroxide due to the greater electrophilicity of the peracid peroxygen group. The cold water bleaching performance in detergent systems accounts for their emergent utilization.

Peracids can be introduced into the bleaching system by two methods: Peracids can be manufactured separately and delivered to the detergent and cleaning composition with the other components or as an adjunct. Peracids can also be formed in situ from their corresponding carboxylic acids in the presence of H2O2 utilizing the perhydrolysis reaction shown in the following equation: R—C(O)-L+HO2-→R—C(O)OOH+L-, where L denotes a leaving group. Another way to get peracetic acid in situ during the washing cycle is hydrogen peroxide reacting with TAED. Hydrogen peroxide is released from sodium percarbonate. This principle is mainly used in laundry powders and auto dishwashing powders.

As used herein, the term “peracid” may also be referred to as a “percarboxylic acid” or “peroxocarboxylic acid” having the general formula R—(COOOH) n in which R can be hydrogen and alkyl, and n is 1, 2 or 3. The term “alkyl” is as defined herein. In a preferred variant, R includes an alkyl of 1 to 22 carbon atoms. Preferred are peracids wherein R is selected from the group consisting of C1, C2, C3, C4, C5, C6, C7, C8, C9, C10, C11, C12, C13, C14, C15, C16, C17, C18, C19, C20, C21 and C22.

In a preferred variant, the peracid has 1 to 10 carbon atoms, in particular 2 to 4 carbon atoms.

In a still more preferred variant, the bleaching agent includes peroxyacetic acid, peroxyoctanoic acid, peroxypropionic acid, peroxylactic acid, peroxyheptanoic acid, peroxyoctanoic acid and/or peroxynonanoic acid. In still other embodiments, the C1 to C22 percarboxylic acid comprises peroxyacetic acid, peroxyoctanoic acid and/or peroxysulfonated oleic acid. In a most preferred variant, the peroxycarboxylic acid includes peroxyacetic acid.

One preferred percarboxylic acid is phthalimido peroxycaproic acid.

In another variant, R is an alkyl of 1 to 22 carbon atoms substituted with a hydroxyl group or other polar substituent. In another preferred variant, the percarboxylic acid is a sulfoperoxycarboxylic acid.

Most preferred examples of this class of agents include peroxyacetic acid, magnesium monoperoxyphthalate hexahydrate, the magnesium salt of 3-meta-chloro perbenzoic acid, 4-nonylamino-4-oxoperoxybutyric acid and diperoxydodecanedioic acid.

In additional variants, mixed peroxycarboxylic acid compositions may be employed.

All other inorganic or organic peroxy bleaching agents known from the prior art can also be used.

One further source of hydrogen peroxide in detergents and cleaning compositions is the use of oxidase enzymes, such as glucose oxidase, which uses glucose substrate to generate hydrogen peroxide.

Bleaching agents other than oxygen bleaching agents are also known in the art and can be utilized herein. One type of non-oxygen bleaching agent of particular interest includes photoactivated bleaching agents such as the sulfonated zinc and/or aluminium phthalocyanines. If used, detergent compositions will typically contain from about 0.025% to about 1.25% by weight of such bleaching agents, especially sulfonate zinc phthalocyanine.

Another category of bleaching agents used according to the present invention includes chlorine or bromine releasing bleaching agents. Examples of suitable chlorine or bromine liberating substances include heterocyclic N-bromo and N-chloroamides, such as trichloroisocyanuric acid, tribromoisocyanuric acid, dibromoisocyanuric acid and dichloroisocyanuric acid and/or their salts with cations such as potassium and sodium; hydantoin compounds, such as 1,3-dichloro-5,5-dimethylhydantoin are also suitable.

Reducing Bleaches: Reducing agents generally used in bleaching include sulfur dioxide, sulfurous acid, bisulfites, sulfites, hydrosulfites (dithionites), sodium sulfoxylate formaldehyde and sodium borohydride.

Preferably, the bleaching agent of the detergent and cleaning composition according to the present invention is selected from the group consisting of
chlorine bleaches, selected from the group consisting of sodium hypochlorite (NaOCl);
peroxygen bleaches, selected from the group consisting of
   hydrogen peroxide (H2O2), alkali metal peroxide,
   alkali metal percarbonates,
   alkali metal perborates,
   alkali metal perphosphates,
   alkali metal persulfates and
   alkali metal persililcates,
and any mixture thereof;
percarboxylic acid bleaches and salts thereof;
photoactivated bleaches, selected from sulfonated zinc, aluminium phthalocyanines, and any mixture thereof;
chlorine or bromine releasing bleaches, such as heterocyclic N-bromo and N-chloroamides, such as trichloroisocyanuric acid, tribromoisocyanuric acid, dibromoisocyanuric acid and dichloroisocyanuric acid; hydantoin compounds, such as 1,3-dichloro-5,5-dimethylhydantoin;
   and any mixture thereof.

In the afore specified bleaching agents, the alkali metal is preferred sodium.

Hydrogen peroxide based bleaches have the advantage of being more fabric- and color-safe. They can also be used without seriously diminishing the effectiveness of enzymatic detergents and cleaning compositions or products.

Thus, in a more preferred variant, the detergent and cleaning composition according to the present invention comprises a bleaching agent which is selected from the group consisting of
peroxygen bleaches, selected from the group consisting of.
   hydrogen peroxide (H2O2), alkali metal peroxide,
   alkali metal percarbonates,
   alkali metal perborates,
   alkali metal perphosphates,
   alkali metal persulfates and
   alkali metal persililcates,
and any mixture thereof;
percarboxylic acid bleaches and salts thereof;
   and any mixture thereof.

In the afore specified bleaching agents, sodium is the preferred alkali metal.

In a most preferred variant, the bleaching agent is selected from the group consisting of hydrogen peroxide, sodium percarbonate, sodium perborate, peracetic acid, glucose oxidase, phthalimido peroxycaproic acid, and any mixture thereof.

The above specified bleaching agents can be used either singular or in the form of mixtures of two, three, or even more bleaching agents, either from the same bleaching agent category or as mixture of bleaching agents of different bleaching agent categories.

The above specified bleaching agents, used according to the present invention, are well known from the art.

The detergents and cleaning compositions of the present invention optionally include at least one or more substances effective for activating bleaching agents, so-called bleach activators. In particular peroxygen bleaching agents are preferably combined with bleach activators.

Bleach activators are essentially N- and O-acyl compounds that form peroxy acids upon perhydrolysis (meaning hydrolysis by hydrogen peroxide from the bleach, persalts). For example, TAED produces in the wash liquor bleach-active peroxyacetic acid or from DOBA peroxydodecanoic acid. Peroxy acids are more active bleaches than hydrogen peroxide at lower temperatures (<60° C.) but are too unstable to be stored in their active form, and hence must be generated in situ. In all cases, the activator is chemically reacted according to the degree of contamination in the laundry and thus “consumed”.

Due to their advantageous properties, bleach activators allow a lower washing temperature than would be required otherwise to achieve the full activity of bleaching agents in the wash liquor. Bleaching agents, usually peroxides, are usually sufficiently active only at 60° C. and up. With bleach activators, this activity can be achieved at lower temperatures. They are not included in any liquid laundry detergents.

Typical bleach activators are the nonanoyloxybenzene sulfonate (NOBS) and tetraacetyl ethylene diamine (TAED) activators, and mixtures thereof can also be used. Preferred amido-derived bleach activators include (6-octanamido-caproyl)oxybenzenesulfonate, (6-nonanamidocaproyl)oxybenzenesulfonate, (6-decanamidocaproyl)oxybenzenesulfonate, and mixtures thereof. Another class of bleach activators comprises the benzoxazine-type activators disclosed in U.S. Pat. No. 4,966,723, incorporated herein by reference. Highly preferred lactam activators include benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof, optionally adsorbed into solid carriers, e.g. acyl caprolactams, preferably benzoyl caprolactam, adsorbed into sodium perborate.

Another group of bleach activators include polyacylated alkylenediamines, especially tetraacetylethylenediamine (TAED), acylated triazine derivatives, especially 1,5-diacetyl-2,4-dioxohexahydro-1,3,5-triazine (DADHT), acylated glycolurils, especially tetraacetylglycoluril (TAGU), N-Acylimides, in particular N-nonanoylsuccinimide (NOSI), acylated phenolsulfonates, in particular n-nonanoyl- or isononanoyloxybenzenesulfonate (n- or iso-NOBS) are particularly preferably used.

In a preferred variant, the bleach activator used in the detergent and cleaning composition according to the present invention is selected from the group consisting of
polyacylated alkylenediamines, preferably tetraacetylethylenediamine (TAED);
acylated triazine derivatives, preferably 1,5-diacetyl-2,4-dioxohexahydro-1,3,5-triazine (DADHT);
acylated glycolurils, preferably tetraacetylglycoluril (TAGU);
N-acylimides, preferably N-nonanoylsuccinimide (NOSI);
acylated phenolsulfonates, preferably n-nonanoyl- or isononanoyloxybenzenesulfonate (n- or iso-NOBS);
lactams, preferably benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof, optionally adsorbed onto solid carriers;
   and any mixture thereof.

TAED is very particularly preferred.

The above specified bleach activators can be used in the detergent and cleaning composition as single substance. Also combinations of said bleach activators can be used.

During the washing cycle (laundry, dish wash) in the presence of water, percarbonate releases H2O2 in the wash liquor. This H2O2 will react with TAED ingredient (bleach activator also added in the washing powder) to generate in situ peracetic acid (=percarboxylic acid). This peracetic acid will do the bleach effect. Peracetic acid is a very strong bleaching agent, i.e. stronger than H2O2. For other applications which are liquid, only H2O2 bleaches are used.

### Bleach Boosting Agent/Component (b1, b2, b3, b)

The detergent and cleaning composition according to the present invention further includes at least one bleach boosting agent as component (b1, b2, b3, b).

In a preferred variant, the detergent and cleaning composition according to the present invention includes a mixture of bleach boosting agents.

Bleach boosting agents within the meaning of the present invention are (b1) 1,2-heptanediol; (b2) 2,3-heptanediol; (b3) a mixture of 1,2-heptanediol and 2,3-heptanediol; (b^{I}) at least one linear alkanediol having a carbon chain of 5 to 11 carbon atoms or a mixture comprising at least one first linear alkanediol having a carbon chain of 5 to 11 carbon atoms and one or more second linear alkanediols having a carbon chain of 5 to 11 carbon atoms which is different from the first linear alkanediol; (b^{II}) glyceryl caprylate; (b^{III}) 4-hydroxyacetophenone; (b^{IV}) tropolone; and any mixture of said bleach boosting agents.

The bleach boosting agents (b) as specified above were found to efficiently enhance the bleaching power of a bleaching agent or a bleaching agent mixture in a detergent and cleaning composition. In addition, the bleach boosting agents (b) as specified above were found to considerably improve bleachable stain and/or removal from substrates such as laundry, fabrics, textiles, dishes, ware, surfaces, medical and dental instruments, and the like.

### Alkanediols (b1, b2, b3, b1)

The bleach boosting component (b) in the detergent and cleaning composition according to the first aspect of the present invention is either (b1) 1,2-heptanediol or (b2) 2,3-heptanediol, or (b3) a mixture comprising both heptanediols, i.e. 1,2-heptanediol plus 2,3-heptanediol.

1,2-Heptanediol belongs to the category of alkanediols and is a straight chain alkanediol with the general formula:

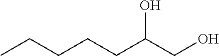

It has a carbon chain with 7 carbon atoms and the two functional OH groups of the alkanediol are in alpha, beta position and chemically bonded to the C1 and C2 carbon atoms in the alkanediol chain.

2,3-Heptanediol belongs to the category of alkanediols and is a straight chain alkanediol with the general formula:

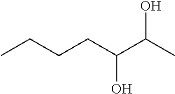

It has a carbon chain with 7 carbon atoms and the two functional OH groups of the alkanediol are in beta, gamma position and chemically bonded to the C2 and C3 carbon atoms in the alkanediol chain.

Alternatively, the alkanediol bleach boosting component (b) in the detergent and cleaning composition according to the other aspect of the present invention is selected from the group consisting of
(b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol

Alkanediols are glycols, i.e. any of a class of organic compounds belonging to the alcohol family; in the molecule of a glycol, two hydroxyl (—OH) groups are attached to different carbon atoms of a carbon chain.

Straight chain 1,2-alkanediols have been used for more than 15 years as multifunctional actives. Short chain 1,2-alkanediols are amphiphilic compounds and thus, like 1,2-pentanediol, 1,2-hexanediol and 1,2-heptanediol, are soluble both in water and oils. In contrast, 1,2-octanediol is a solid and tends to precipitate or recrystallize in oily solutions as well as in water at ≥0.5%. On the other hand, 1,2-decanediol is a solid and soluble only in oils. Apart from moisturizing, some 1,2-alkanediols are used as viscosity modifiers.

The bleach boosting agent (b^{I}) of the detergent and cleaning composition according to the present invention is in a first alternative at least one linear alkanediol having a carbon chain of 5 to 11 carbon atoms, and preferably a carbon chain of 7 to 11 carbon atoms.

Moreover, in a second alternative of this other aspect, the bleach boosting agent (b^{I}) may include a first linear alkanediol in combination with a second linear alkanediol, preferably at least one first linear alkanediol having a carbon chain of 5 to 11 carbon atoms (preferably a carbon chain of 7 to 11 carbon atoms) and at least one second linear alkanediol having a carbon chain of 5 to 11 carbon atoms (preferably a carbon chain of 7 to 11 carbon atoms). Therefore, the invention also entails a mixture comprising a first and a second alkanediol as described herein.

Since the first linear alkanediol of the invention can be selected from the same lists and types of compounds as the linear alkanediol according to the first alternative of the other aspect, in the following, reference is made to the linear alkanediol in general, which can also be the first linear alkanediol. In mixtures of first and second linear alkanediols, where these are specifically different, the specific terms “first” and “second” will be used to distinguish the two alkanediol components.

As used in this document, the phrase “at least one linear alkanediol” or “at least one first linear alkanediol” means that the composition can comprise one linear alkanediol having a carbon chain of 5 to 11 carbon atoms or can comprise one first linear alkanediol having a carbon chain of 5 to 11 carbon atoms or can comprise more than one linear alkanediol or can comprise more than one linear alkanediol or more than one first linear alkanediol having a carbon chain of 5 to 11 carbon atoms, i.e. two, three, four or more different linear alkanediols or first linear alkanediols having a carbon chain of 5 to 11 carbon atoms.

The at least one linear alkanediol or the at least one first linear alkanediol according to the present invention consists of a chain of 5 to 11 carbon atoms (preferably 7 to 11 carbon atoms) joined to each other by single covalent bonds with two OH functional groups attached to two different carbon atoms in the chain.

The at least one linear alkanediol or the at least one first linear alkanediol having a carbon chain of 5 to 11 carbon atoms in the detergent and cleaning composition according to the other aspect of the present invention is selected from the group consisting of pentanediol, hexanediol, heptanediol, octanediol, nonanediol, decanediol, and undecanediol.

In a more preferred variant, the at least one linear alkanediol or the at least one first linear alkanediol has a carbon chain of 5 to 10 carbon atoms and is selected from the group consisting of pentanediol, hexanediol, heptanediol, octanediol, nonanediol, and decanediol.

In a more preferred variant, the at least one linear alkanediol or the at least one first linear alkanediol has a carbon chain of 5 to 9 carbon atoms and is selected from the group consisting of pentanediol, hexanediol, heptanediol, octanediol, and nonanediol.

In a more preferred variant, the at least one linear alkanediol or the at least one first linear alkanediol is selected from the group consisting of alkanediols having a lower number of carbon atoms of 5 to 8, i.e. pentanediol, hexanediol, heptanediol, octanediol, and any mixture thereof, or is selected from the group consisting of alkanediols having a number of carbon atoms of 6 to 8, i.e. hexanediol, heptanediol, octanediol, and any mixture thereof, or is selected from the group consisting of alkanediols having a number of carbon atoms of 7 and 8, i.e. heptanediol, octanediol, and any mixture thereof.

In a still more preferred variant, the at least one linear alkanediol or the at least one first linear alkanediol is selected from the group consisting of alkanediols having a number of carbon atoms of 7 to 11, i.e. heptanediol, octanediol, nonanediol, decanediol, undecanediol, and any mixture thereof, or is selected from the group consisting of alkanediols having a number of carbon atoms of 7 to 10, i.e. heptanediol, octanediol, nonanediol, decanediol, and any mixture thereof or is selected from the group consisting of alkanediols having a number of carbon atoms of 7 to 9, i.e. heptanedol, octanediol, nonanediol, and any mixture thereof, or is selected from the group consisting of alkanediols having a number of carbon atoms of 7 and 8, i.e. heptanediol, and octanediol, and any mixture thereof.

In a still more preferred variant, the at least one linear alkanediol or the at least one first linear alkanediol is selected from the group consisting of alkanediols having a higher number of carbon atoms of 9 to 11, i.e. nonanediol, decanediol, undecanediol, and any mixture thereof, or is selected from the group consisting of alkanediols having a number of carbon atoms of 9 and 10, i.e. nonanediol, decanediol, and any mixture thereof.

In a still more preferred variant, the at least one linear alkanediol or the at least one first linear alkanediol is either pentanediol, hexanediol, heptanediol or octanediol, or any mixture thereof.

In a still more preferred variant, the at least one linear alkanediol or the at least one first linear alkanediol is either heptanediol, octanediol, nonanediol, decanediol, undecanediol, or any mixture thereof.

In a still more preferred variant, the at least one linear alkanediol or the at least one first linear alkanediol is either nonanediol, decanediol, undecanediol, or any mixture thereof.

In a most preferred variant, the at least one linear alkanediol or the at least first linear alkanediol is heptanediol.

In a second alternative, the detergent and cleaning composition according to the other aspect of the present invention comprises as bleach boosting agent (b) a mixture comprising at least one first linear alkanediol having a carbon chain of 5 to 11 carbon atoms (preferably a carbon chain of 7 to 11 carbon atoms) and one or more second linear alkanediol having a carbon chain of 5 to 11 carbon atoms (preferably a carbon chain of 7 to 11 carbon atoms) which is/are different from the first linear alkanediol.

This means that the bleach boosting agent (b) is an alkanediol mixture comprising at least one first linear alkanediol having a carbon chain of 5 to 11 carbon atoms and one or more, i.e. two, three, four or more, second linear alkanediols having a carbon chain of 5 to 11 carbon atoms. In this alternative, the first linear alkanediol can be any of the alkanediols as described herein for the linear alkanediol in general and in particular for the first alternative of the other aspect.

For example, the mixture can include one first linear alkanediol and one, two, three or more second linear alkanediols; or the mixture can include two first linear alkanediols and one, two, three or more second linear alkanediols, etc. with the proviso, that in each mixture, the first linear alkanediols and the second linear alkanediols are different from each other.

The second linear alkanediol preferably consists of a chain of 5 to 11 carbon atoms joined to each other by single covalent bonds with two OH functional groups attached to two different carbon atoms in the chain.

The at least one second linear alkanediol having a carbon chain of 5 to 11 carbon atoms in the detergent and cleaning composition according to the present invention is selected from the group consisting of pentanediol, hexanediol, heptanediol, octanediol, nonanediol, decanediol, and undecanediol.

In a more preferred variant, the at least one second linear alkanediol has a carbon chain of 5 to 10 carbon atoms and is selected from the group consisting of pentanediol, hexanediol, heptanediol, octanediol, nonanediol, and decanediol.

In a more preferred variant, the at least one second linear alkanediol is selected from the group consisting of pentanediol, hexanediol, heptanediol, octanediol and nonanediol, most preferably heptanediol, octanediol and nonanediol.

In a more preferred variant, the at least one second linear alkanediol is selected from the group consisting of alkanediols having a lower number of carbon atoms of 5 to 8, i.e. pentanediol, hexanediol, heptanediol, octanediol, and any mixture thereof, or is selected from the group consisting of alkanediols having a number of carbon atoms of 6 to 8, i.e. hexanediol, heptanediol, octanediol, and any mixture thereof, or is selected from the group consisting of alkanediols having a number of carbon atoms of 7 and 8, i.e. heptanediol, octanediol, and any mixture thereof.

In a preferred variant, the at least one second linear alkanediol is selected from the group consisting of alkanediols having a number of carbon atoms of 7 to 11, i.e. heptanediol, octanediol, nonanediol, decanediol, undecanediol, and any mixture thereof, or is selected from the group consisting of alkanediols having a number of carbon atoms of 7 to 10, i.e. heptanediol, octanediol, nonanediol, decanediol, and any mixture thereof or is selected from the group consisting of alkanediols having a number of carbon atoms of 7 to 9, i.e. heptanedol, octanediol, nonanediol, and any mixture thereof, or is selected from the group consisting of alkanediols having a number of carbon atoms of 7 and 8, i.e. heptanediol, and octanediol, and any mixture thereof.

In a still more preferred variant, the at least one linear alkanediol or the at least one first linear alkanediol is selected from the group consisting of alkanediols having a higher number of carbon atoms of 9 to 11, i.e. nonanediol, decanediol, undecanediol, and any mixture thereof, or is selected from the group consisting of alkanediols having a number of carbon atoms of 9 and 10, i.e. nonanediol, decanediol, and any mixture thereof.

The phrase “different from each other means” that the first linear alkanediols and the second linear alkanediols in the mixture are either different with regard to the length of their carbon chain, i.e. number of the carbon atoms, or with regard to their constitutional isomerism.

Likewise, the number of the carbon atoms of the first linear alkanediols and the second linear alkanediols in the mixture can also be same. For example, the first linear alkanediol and the second linear alkanediol have a carbon chain of 7 carbon atoms, but the first linear alkanediol and the second linear alkanediol are different with regard to their constitutional isomerism or with regard to their stereoisomerism.

If both the first and the second alkanediol is for example heptanediol, then the second linear alkanediol heptanediol is a different constitutional isomer or stereoisomer from the first linear alkanediol, according to the second alternative of the other aspect.

In a preferred variant, the detergent and cleaning composition according to the other aspect of the present invention comprises a mixture comprising at least one first linear alkanediol having a carbon chain of 5 to 11 carbon atoms and one or more second linear alkanediol having a carbon chain of 5 to 11 carbon atoms, wherein the number of the carbon atoms of the first and the second alkanediol is either same or different.

If both, the first and the second alkanediol have the same number of carbon atoms, such an alkanediol combination is herein also referred to as “homo alkanediol mixture” or “homo combination”. For example, the first linear alkanediol and the second linear alkanediol have a carbon chain of 7 carbon atoms, but the first linear alkanediol and the second linear alkanediol are different with regard to their constitutional isomerism or in regard to their stereoisomerism.

If the first and the second alkanediol have a different number of carbon atoms, such an alkanediol combination is herein also referred to as “hetero alkanediol mixture” or “hetero combination”. For example, the first linear alkanediol has a carbon chain of 7 carbon atoms and the second linear alkanediol has a carbon chain of 8 carbon atoms. However, beyond that, the first linear alkanediol and the second linear alkanediol can be different in regard to their constitutional isomerism or with regard to their stereoisomerism.

In a preferred variant the present invention relates to a detergent and cleaning composition, wherein the at least one linear alkanediol or the first linear alkanediol is selected from the group consisting of pentanediol, hexanediol, heptanediol, octanediol, nonanediol, decanediol, undecanediol, dodecanediol, tridecanediol, and tetradecanediol; and/or the one or more second linear alkanediol is selected from the group consisting of pentanediol, hexanediol, heptanediol, octanediol, nonanediol, decanediol, undecanediol, dodecanediol, tridecanediol, and tetradecanediol.

Particular preferred is a bleach boosting agent mixture, wherein the at least first linear alkanediol is selected from an alkanediol having a lower number of carbon atoms from 5 to 8 and wherein the one or more second alkanediol is selected from an alkanediol having a higher number of carbon atoms from 9 to 11.

Most preferred is a bleach boosting agent mixture, wherein the at least first linear alkanediol is selected from the group consisting of pentanediol, hexanediol, heptanediol, octanediol, and any mixture thereof, and the one or more second alkanediol is selected from the group consisting of nonanediol, decanediol, undecanediol, and any mixture thereof.

The term “alkanediol” within the context of the present invention also includes its constitutional isomers or position isomers. Constitutional isomers are compounds that have the same molecular formula and different connectivity. Position isomers, a particular form of constitutional isomerism, are structural isomers that can be viewed as differing only on the position of a functional group on a parent structure, which in this case, in particular, is the position of the two alcohol functions.

Depending on the number of the carbon atoms of the carbon chain of the alkanediol, there are various position isomers of the alkanediol: (x,x+1) constitutional isomers; (x,x+2) constitutional isomers; (x,x+3) constitutional isomers; etc. and alpha, omega constitutional isomers when the alcohol functions are at the terminal ends of the carbon chain, wherein x stands for the number of the carbon atom in the alkanediol chain, to which the OH groups of the alkanediol are chemically bonded. For example: if x is 1, the two OH groups of the alkanediol are chemically bonded to the C1 and C2 carbon atoms in the alkanediol chain; if x is 2, the two OH groups of the alkanediol are chemically bonded to the C2 and C3 carbon atoms in the alkanediol chain, etc.

In the (x,x+1) constitutional isomers, the two OH functional groups are vicinal attached to two different adjacent carbon atoms in the chain. In the (x,x+2) constitutional isomers, the two OH functional groups are attached to two different carbon atoms in the chain where the two carbon atoms are separated by one C atom. In the (x,x+3) constitutional isomers, the two OH functional groups are attached to two different carbon atoms in the chain where the two carbon atoms are separated by two C atoms. In the alpha, omega constitutional isomers, the two functional groups are attached to the first C atom and to the terminal C atom.

In a preferred variant of the detergent and cleaning composition according to the other aspect of the present invention, the linear alkanediol having a carbon chain of 5 to 11 carbon atoms, is preferably a vicinal (x,x+1) diol, selected from the group consisting of a 1,2-diol, 2,3-diol, 3,4-diol, 4,5-diol, further (x,x+1) diols, and mixtures thereof, preferably an alpha, beta-1,2-constitutional isomer.

In a more preferred variant of the detergent and cleaning composition according to the other aspect of the present invention, the first linear alkanediol and/or the second linear alkanediol having a carbon chain of 5 to 11 carbon atoms is a vicinal (x,x+1) diol, selected from the group consisting of a 1,2-diol, 2,3-diol, 3,4-diol, 4,5-diol, further (x,x+1) diols, and mixtures thereof, preferably an alpha, beta-1,2-constitutional isomer.

Preferably, the linear alkanediol, the first linear alkanediol and/or the second linear alkanediol having a carbon chain of 5 to 11 carbon atoms are selected form 1,2-diols and/or 2,3-alkanediols.

Thus, according to a preferred variant of the detergent and cleaning composition according to the other aspect of the present invention, the at least one linear alkanediol, the first linear alkanediol and/or the second linear alkanediol is an (x,x+1) constitutional isomer, wherein x stands for the number of the carbon atom in the alkanediol chain, to which the OH groups of the alkanediol are chemically bonded, in particular a 1,2-alkanediol, a 2,3-alkanediol, a 3,4-alkanediol, or mixtures thereof, preferably a 1,2-alkanediol or a 2,3-alkanediol.

In a further preferred variant of the detergent and cleaning composition according to the other aspect of the present invention, the linear alkanediol having a carbon chain of 5 to 11 carbon atoms, is preferably a non-vicinal (x,x+2) diol, selected from the group consisting of a 1,3-diol, 2,4-diol, 3,5-diol, further (x,x+2) diols, and mixtures thereof, preferably an alpha, gamma-1,3-constitutional isomer.

According to the present invention, vicinal (x,x+1) diols are most preferred, such as alpha, beta or beta, gamma or gamma, delta etc.

In a still more preferred variant of the detergent and cleaning composition according to the other aspect of the present invention, the linear alkanediol and in particular the first linear alkanediol and/or the second linear alkanediol, is a 1,2-alkanediol, a 2,3-alkanediol, a 3,4-alkanediol, or mixtures thereof, more preferred 2,3-alkanediol.

The 1,2-alkanediols of the linear alkanediol, in particular the first linear alkanediol having a carbon chain of 5 to 11 carbon atoms and/or the second linear alkanediol having a carbon chain of 5 to 11 carbon atoms, can preferably be those as represented by the following formulae:

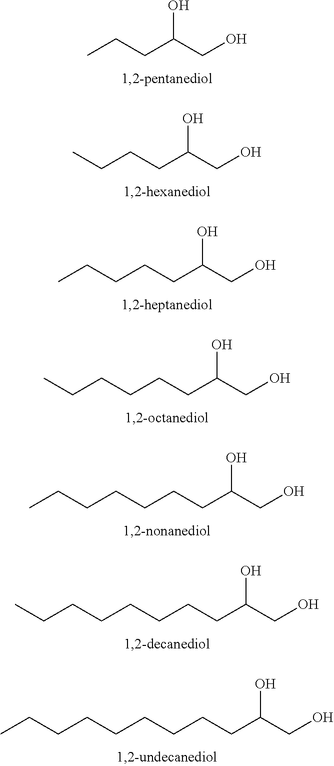

The 2,3-alkanediols of the linear alkanediol of the invention, in particular the first linear alkanediol having a carbon chain of 5 to 11 carbon atoms and/or the second linear alkanediol having a carbon chain of 5 to 11 carbon atoms, can preferably be those as represented by the following formulae:

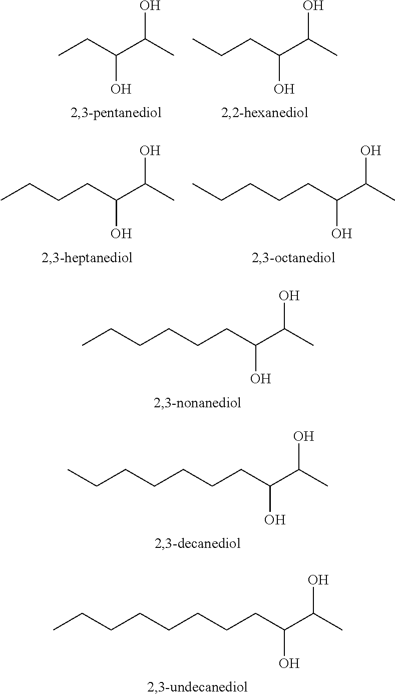

The 3,4-alkanediols of the linear alkanediol, preferably the first linear alkanediol having a carbon chain of 5 to 11 carbon atoms and/or the second linear alkanediol having a carbon chain of 5 to 11 carbon atoms, can preferably be those as represented by the following formulae:

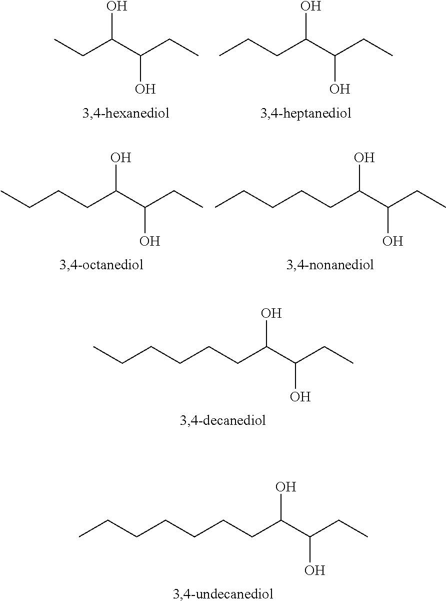

In a preferred variant of the detergent and cleaning composition according to the other aspect of the present invention, the linear alkanediol or the first linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
and any mixture thereof.

In a preferred variant of the detergent and cleaning composition according to the other aspect of the present invention, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
and any mixture thereof.

In a preferred variant of the detergent and cleaning composition according to the other aspect of the present invention, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
and any mixture thereof.

In a preferred variant of the detergent and cleaning composition according to the other aspect of the present invention, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
and any mixture thereof.

In a preferred variant of the detergent and cleaning composition according to the other aspect of the present invention, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
and any mixture thereof.

According to a preferred variant, in the detergent and cleaning composition according to the present invention the linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, and any mixture thereof.

According to a more preferred variant, in the detergent and cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, and any mixture thereof.

According to an even more preferred variant, in the detergent and cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, and any mixture thereof.

According to a further preferred variant, in the detergent and cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol, and any mixture thereof.

According to a most preferred variant, in the detergent and cleaning composition according to the present invention the linear alkanediol or the first linear alkanediol is selected from the group consisting of 1,2-heptanediol, 2,3-heptanediol, 1,2-octanediol, 2,3-octanediol, and any mixture thereof.

Of the aforesaid linear alkanediols or the first linear alkanediols, the following (x,x+1) constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, 2,3-tridecanediol or mixtures thereof. Said alkanediols are liquid at a purity of 90 to 99%.

Of the aforesaid liquid alkanediols 1,2-pentanediol, 2,3-pentanediol, 1,2-hexanediol, 2,3-hexanediol, 1,2-heptanediol, 2,3-heptanediol, 2,3-octanediol, 2,3-nonanediol, or mixtures of said liquid alkanediols are particularly preferred.

In a further preferred variant of the detergent and cleaning composition according to the present invention, the linear alkanediol or the first linear alkanediol is selected from the group consisting of:
1,2-pentanediol, 2,3-pentanediol,
1,2-hexanediol, 2,3-hexanediol,
1,2-heptanediol, 2,3-heptanediol,
1,2-octanediol, 2,3-octanediol,
and any mixture thereof.

In a further preferred variant of the detergent and cleaning composition according to the present invention, the linear alkanediol or the first linear alkanediol is selected from the group consisting of:
1,2-heptanediol, 2,3-heptanediol,
1,2-octanediol, 2,3-octanediol,
1,2-nonanedol, 2,3-nonanediol,
1,2-decanediol, 2,3-decanediol,
1,2-undecanediol, 2,3-undecanediol,
and any mixture thereof.

More preferred, in the detergent and cleaning composition according to the present invention, the linear alkanediol or the first linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the linear alkanediol or the first linear alkanediol can also preferably be selected from the group consisting of 1,2-octanediol, 2,3-octanediol, and mixtures thereof.

Even more preferred, in the detergent and cleaning composition according to the present invention, the linear alkanediol or the first linear alkanediol is an alpha,beta or a beta, gamma diol as either 1,2-heptanediol or 2,3-heptandediol or a mixture thereof. However, the linear alkanediol or the first linear alkanediol can also preferably be an alpha, beta or a beta, gamma diol as either 1,2-octanediol or 2,3-octanediol or a mixture thereof. A mixture comprising 1,2-heptanediol and 2,3-octanediol or a mixture comprising 1,2-octanediol and 2,3-heptanediol is also possible.

Most preferred, the linear alkanediol or the first linear alkanediol is 1,2-pentanediol or 2,3-pentanediol or 1,2-hexanediol or 2,3-hexanediol or 1,2-heptanediol or 2,3-heptanediol or 1,2-octanediol or 2,3-octanediol or 1,2-nonanediol or 2,3-nonanediol.

Likewise, in a further preferred variant of the detergent and cleaning composition according to the present invention, the linear alkanediol or the first linear alkanediol is selected from the group consisting of 1,2-nonanediol, 2,3-nonanediol, 1,2-decanediol, 2,3-decanediol, 1,2-undecanediol, 2,3-undecanediol, and any mixture thereof.

More preferred, in the detergent and cleaning composition according to the present invention, the linear alkanediol or the first linear alkanediol is selected from the group consisting of 1,2-nonanediol, 2,3-nonanediol, and mixtures thereof, or can also be preferably selected from the group consisting of 1,2-decanediol, 2,3-decanediol, and mixtures thereof, or can also be preferably selected from the group consisting of 1,2-undecanediol, 2,3-undecanediol, and mixtures thereof.

In a more preferred variant, the at least one linear alkanediol or the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the at least one linear alkanediol or the at least one first linear alkanediol is either 1,2-pentanediol or 1,2-hexanediol or 1,2-heptanediol or 1,2-octanediol, or any mixture thereof.

In a most preferred variant, the at least one linear alkanediol or the at least first linear alkanediol is 1,2-heptanediol.

It was found that these alkanediols show particular pronounced bleaching performance improving properties. In addition, it was found that these alkanediols remarkably improve stain and/or soil removal. 1,2-Alkanediols having a lower number of carbon atoms are thus efficient for use as bleach boosting agents and bleachable stain and/or soil removal enhancer in detergents and cleaning compositions. Both, the improved bleaching performance and improved stain and/or soil removal result in a better performance of the detergent and cleaning composition in a washing or cleaning process in comparison to a detergent and cleaning composition without the addition of said bleach boosting agents.

In a more preferred variant, the at least one linear alkanediol or the at least one first linear alkanediol is selected from the group consisting of 1,2-alkanediols having a number of carbon atoms of 7 to 11, i.e. 1,2-heptanediol, 1,2-octanediol, 1,2-nonanediol, 1,2-decanediol, 1,2-undecanediol, and any mixture thereof, or is selected from the group consisting of 1,2-alkanediols having a number of carbon atoms of 7 to 10, i.e. 1,2-heptanediol, 1,2-octanediol, 1,2-nonanediol, 1,2-decanediol, and any mixture thereof, or is selected from the group consisting of 1,2-alkanediols having a number of carbon atoms of 7 to 9, i.e. 1,2-heptanediol, 1,2-octanediol, 1,2-nonanediol, and any mixture thereof.

It was found that these alkanediols show particular pronounced bleaching performance improving properties. In addition, it was found that these alkanediols remarkably improve stain and/or soil removal. 1,2-Alkanediols having a number of carbon atoms of 7 to 11 are thus efficient for use as bleach boosting agents and bleachable stain and/or soil removal enhancer in detergents and cleaning compositions. Both, the improved bleaching performance and improved stain and/or soil removal result in a better performance of the detergent and cleaning composition in a washing or cleaning process in comparison to a detergent and cleaning composition without the addition of said bleach boosting agents.

In a still more preferred variant, the at least one linear alkanediol or the at least one first linear alkanediol is selected from the group consisting of 1,2-alkanediols having a higher number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the at least one linear alkanediol or the at least one first linear alkanediol is either 1,2-decanediol or 1,2-undecanediol or any mixture thereof.

It was found that these alkanediols show pronounced bleaching performance improving properties. In addition, it was found that these alkanediols improve stain and/or soil removal. 1,2-Alkanediols having a higher number of carbon atoms are thus efficient for use as bleach boosting agents and bleachable stain and/or removal enhancer in detergents and cleaning compositions comprising an enzyme. Both, the improved bleaching performance and improved stain and/or soil removal result in a better overall performance of the detergent and cleaning composition in a washing or cleaning process in comparison to a detergent and cleaning composition without the addition of said bleach boosting agents.

In a still more preferred variant, the linear alkanediol or the first linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 1,2-heptanediol, 1,2-octanediol, and any mixture thereof.

In a still more preferred variant, the at least one linear alkanediol or the at least one first linear alkanediol is either 2,3-pentanediol or 2,3-hexanediol or 2,3-heptanediol or 2,3-octanediol or any mixture thereof.

In a most preferred variant, the at least one linear alkanediol or the at least first linear alkanediol is 2,3-heptanediol.

It was found that these alkanediols show particular pronounced bleaching performance improving properties. In addition, it was found that these alkanediols remarkably improve stain and/or soil removal. 2,3-Alkanediols having a lower number of carbon atoms are thus efficient for use as bleach boosting agents and bleachable stain and/or soil removal enhancer in detergents and cleaning compositions. Both, the improved bleaching performance and improved stain and/or soil removal result in a better performance of the detergent and cleaning composition in a washing or cleaning process in comparison to a detergent and cleaning composition without the addition of said bleach boosting agents.

In a more preferred variant, the at least one linear alkanediol or the at least one first linear alkanediol is selected from the group consisting of 2,3-alkanediols having a number of carbon atoms of 7 to 11, i.e. 2,3-heptanediol, 2,3-octanediol, 2,3-nonanediol, 2,3-decanediol, 2,3-undecanediol, and any mixture thereof, or is selected from the group consisting of 2,3-alkanediols having a number of carbon atoms of 7 to 10, i.e. 2,3-heptanediol, 2,3-octanediol, 2,3-nonanediol, 2,3-decanediol, and any mixture thereof, or is selected from the group consisting of 2,3-alkanediols having a number of carbon atoms of 7 to 9, i.e. 2,3-heptanediol, 2,3-octanediol, 2,3-nonanediol, and any mixture thereof.

It was found that these alkanediols show particular pronounced bleaching performance improving properties. In addition, it was found that these alkanediols remarkably improve stain and/or soil removal. 2,3-Alkanediols having a number of carbon atoms of 7 to 11 are thus efficient for use as bleach boosting agents and bleachable stain and/or soil removal enhancer in detergents and cleaning compositions. Both, the improved bleaching performance and improved stain and/or soil removal result in a better performance of the detergent and cleaning composition in a washing or cleaning process in comparison to a detergent and cleaning composition without the addition of said bleach boosting agents.

In a still more preferred variant, the at least one linear alkanediol or the at least one first linear alkanediol is selected from the group consisting of 2,3-alkanediols having a higher number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

In a still more preferred variant, the at least one linear alkanediol or the at least one first linear alkanediol is either 2,3-decanediol, 2,3-undecanediol, or any mixture thereof.

It was found that these alkanediols show pronounced bleaching performance improving properties. In addition, it was found that these alkanediols improve stain and/or soil removal. 2,3-Alkanediols having a higher number of carbon atoms are thus efficient for use as bleach boosting agents and bleachable stain and/or removal enhancer in detergents and cleaning compositions comprising an enzyme. Both, the improved bleaching performance and improved stain and/or soil removal result in a better overall performance of the detergent and cleaning composition in a washing or cleaning process in comparison to a detergent and cleaning composition without the addition of said bleach boosting agents.

In a preferred variant of the detergent and cleaning composition according to the present invention, the second linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octancediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
and any mixture thereof.

In a more preferred variant of the detergent and cleaning composition according to the other aspect of the present invention, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
and any mixture thereof.

In a still more preferred variant of the detergent and cleaning composition according to the other aspect of the present invention, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
and any mixture thereof.

In an even more preferred variant of the detergent and cleaning composition according to the other aspect of the present invention, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
and any mixture thereof.

In a most preferred variant of the detergent and cleaning composition according to the other aspect of the present invention, the second linear alkanediol is selected from the group consisting of:
1,2-heptanediol, 2,3-heptanediol, 3,4-heptanediol,
1,2-octanediol, 2,3-octanediol, 3,4-octanediol,
and any mixture thereof.

According to a preferred variant, in the detergent and cleaning composition according to the present invention the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, and any mixture thereof.

According to a further preferred variant, in the detergent and cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, and any mixture thereof.

According to a further preferred variant, in the detergent and cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, and any mixture thereof.

According to a further preferred variant, in the detergent and cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, and any mixture thereof.

According to a further preferred variant, in the detergent and cleaning composition according to the present invention the second linear alkanediol is selected from the group consisting of 1,2-heptanediol, 2,3-heptanediol, 1,2-octanediol, 2,3-octanediol, and any mixture thereof.

Of the aforesaid second linear alkanediols, the following (x,x+1) constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, or 2,3-tridecanediol. Said alkanediols are liquid at a purity of 90 to 99%.

Of the aforesaid liquid alkanediols 1,2-pentanediol, 2,3-pentanediol, 1,2-hexanediol, 2,3-hexanediol, 1,2-heptanediol, 2,3-heptanediol, 2,3-octanediol, 2,3-nonanediol or mixtures of said liquid alkanediols are particularly preferred.

In a further preferred variant of the detergent and cleaning composition according to the other aspect of the present invention, the second linear alkanediol is selected from the group consisting of:
1,2-pentanediol, 2,3-pentanediol,
1,2-hexanediol, 2,3-hexanediol,
1,2-heptanediol, 2,3-heptanediol,
1,2-octanediol, 2,3-octanediol, and any mixture thereof.

In a further preferred variant of the detergent and cleaning composition according to the present invention, the linear alkanediol or the first linear alkanediol is selected from the group consisting of:
1,2-heptanediol, 2,3-heptanediol,
1,2-octanediol, 2,3-octanediol,
1,2-nonanedol, 2,3-nonanediol,
1,2-decanediol, 2,3-decanediol,
1,2-undecanediol, 2,3-undecanediol,
and any mixture thereof.

More preferred, in the detergent and cleaning composition according to the other aspect of the present invention, the second linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the second linear alkanediol can also preferably be selected from the group consisting of 1,2-octanediol, 2,3-octanediol, and mixtures thereof.

Even more preferred, in the detergent and cleaning composition according to the present invention, the second linear alkanediol is an alpha, beta or a beta, gamma diol as either 1,2-pentanediol or 2,3-pentanediol or a mixture thereof. However, the second linear alkanediol can also preferably be an alpha,beta or a beta, gamma diol as either 1,2-hexanediol or 2,3-hexanediol or a mixture thereof. A mixture comprising 1,2-pentanediol and 2,3-hexanediol or a mixture comprising 2,3-pentanediol and 1,2-hexanediol is also possible.

Most preferred, the second linear alkanediol is 1,2-pentanediol or 2,3-pentanediol or 1,2-hexanediol or 2,3-hexanediol or 1,2-heptanediol or 2,3-heptanediol, or 2,3-octanediol or 2,3-nonanediol.

Likewise, in a further preferred variant of the detergent and cleaning composition according to the present invention, the second linear alkanediol is selected from the group consisting of 1,2-nonanediol, 2,3-nonanediol, 1,2-decanediol, 2,3-decanediol, 1,2-undecanediol, 2,3-undecanediol, and any mixture thereof.

More preferred, in the detergent and cleaning composition according to the present invention, the second linear alkanediol is selected from the group consisting of 1,2-nonanediol, 2,3-nonanediol, and mixtures thereof, or can also be preferably selected form the group consisting of 1,2-decanediol, 2,3-decanediol, and mixtures thereof, or can also be preferably selected from the group consisting of 1,2-undecanediol, 2,3-undecanediol, and mixtures thereof.

In a more preferred variant, the second linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the second linear alkanediol is either 1,2-pentanediol or 1,2-hexanediol or 1,2-heptanediol or 1,2-octanediol or any mixture thereof.

In a most preferred variant, the second linear alkanediol is 1,2-heptanediol.

It was found that these alkanediols show particular pronounced bleaching performance improving properties. In addition, it was found that these alkanediols remarkably improve stain and/or soil removal. 1,2-Alkanediols having a lower number of carbon atoms are thus efficient for use as bleach boosting agents and bleachable stain and/or soil removal enhancer in detergents and cleaning compositions. Both, the improved bleaching performance and improved stain and/or soil removal result in a better overall performance of the detergent and cleaning composition in a washing or cleaning process in comparison to a detergent and cleaning composition without the addition of said bleach boosting agents.

In a more preferred variant, the second linear alkanediol is selected from the group consisting of 1,2-alkanediols having a number of carbon atoms of 7 to 11, i.e. 1,2-heptanediol, 1,2-octanediol, 1,2-nonanediol, 1,2-decanediol, 1,2-undecanediol, and any mixture thereof, or is selected from the group consisting of 1,2-alkanediols having a number of carbon atoms of 7 to 10, i.e. 1,2-heptanediol, 1,2-octanediol, 1,2-nonanediol, 1,2-decanediol, and any mixture thereof, or is selected from the group consisting of 1,2-alkanediols having a number of carbon atoms of 7 to 9, i.e. 1,2-heptanediol, 1,2-octanediol, 1,2-nonanediol, and any mixture thereof.

It was found that these alkanediols show particular pronounced bleaching performance improving properties. In addition, it was found that these alkanediols remarkably improve stain and/or soil removal. 1,2-Alkanediols having a number of carbon atoms of 7 to 11 are thus efficient for use as bleach boosting agents and bleachable stain and/or soil removal enhancer in detergents and cleaning compositions. Both, the improved bleaching performance and improved stain and/or soil removal result in a better performance of the detergent and cleaning composition in a washing or cleaning process in comparison to a detergent and cleaning composition without the addition of said bleach boosting agents.

In a still more preferred variant, the second linear alkanediol is selected from the group consisting of 1,2-alkanediols having a higher number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the second linear alkanediol is either 1,2-decanediol or 1,2-undecanediol or any mixture thereof.

It was found that these alkanediols show pronounced bleaching performance improving properties. In addition, it was found that these alkanediols improve stain and/or soil removal. 1,2-Alkanediols having a higher number of carbon atoms are thus efficient for use as bleach boosting agents and bleachable stain and/or removal enhancer in detergents and cleaning compositions comprising an enzyme. Both, the improved bleaching performance and improved stain and/or soil removal result in a better overall performance of the detergent and cleaning composition in a washing or cleaning process in comparison to a detergent and cleaning composition without the addition of said bleach boosting agents.

In a still more preferred variant, the second linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 1,2-heptanediol, 1,2-octanediol, and any mixture thereof.

In a still more preferred variant, the second linear alkanediol is either 2,3-pentanediol or 2,3-hexanediol or 2,3-heptanediol or 2,3-octanediol or any mixture thereof.

In a most preferred variant, the second linear alkanediol is 2,3-heptanediol.

It was found that these alkanediols show particular pronounced bleaching performance improving properties. In addition, it was found that these alkanediols remarkably improve bleachable stain and/or soil removal. 2,3-Alkanediols having a lower number of carbon atoms are thus efficient for use as bleach boosting agents and bleachable stain and/or soil removal enhancer in detergents and cleaning compositions. Both, the improved bleaching performance and improved stain and/or soil removal result in a better performance of the detergent and cleaning composition in a washing or cleaning process in comparison to a detergent and cleaning composition without the addition of said bleach boosting agents.

In a more preferred variant, the at least one linear alkanediol or the at least one first linear alkanediol is selected from the group consisting of 2,3-alkanediols having a number of carbon atoms of 7 to 11, i.e. 2,3-heptanediol, 2,3-octanediol, 2,3-nonanediol, 2,3-decanediol, 2,3-undecanediol, and any mixture thereof, or is selected from the group consisting of 2,3-alkanediols having a number of carbon atoms of 7 to 10, i.e. 2,3-heptanediol, 2,3-octanediol, 2,3-nonanediol, 2,3-decanediol, and any mixture thereof, or is selected from the group consisting of 2,3-alkanediols having a number of carbon atoms of 7 to 9, i.e. 2,3-heptanediol, 2,3-octanediol, 2,3-nonanediol, and any mixture thereof.

It was found that these alkanediols show particular pronounced bleaching performance improving properties. In addition, it was found that these alkanediols remarkably improve stain and/or soil removal. 2,3-Alkanediols having a number of carbon atoms of 7 to 11 are thus efficient for use as bleach boosting agents and bleachable stain and/or soil removal enhancer in detergents and cleaning compositions. Both, the improved bleaching performance and improved stain and/or soil removal result in a better performance of the detergent and cleaning composition in a washing or cleaning process in comparison to a detergent and cleaning composition without the addition of said bleach boosting agents.

In a still more preferred variant, the second linear alkanediol is selected from the group consisting of 2,3-alkanediols having a higher number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

In a still more preferred variant, the second linear alkanediol is either 2,3-decanediol or 2,3-undecanediol or any mixture thereof.

It was found that these alkanediols show pronounced bleaching performance improving properties. In addition, it was found that these alkanediols improve stain and/or soil removal. 2,3-Alkanediols having a higher number of carbon atoms, and more specifically more than 10 carbon atoms, are thus efficient for use as bleach boosting agents and bleachable stain and/or removal enhancer in detergents and cleaning compositions comprising an enzyme. Both, the improved bleaching performance and improved stain and/or soil removal result in a better overall performance of the detergent and cleaning composition in a washing or cleaning process in comparison to a detergent and cleaning composition without the addition of said bleach boosting agents.

In a further preferred variant, in the detergent and cleaning composition according to the present invention the at least one linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof; and/or the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

In a more preferred variant, the detergent and cleaning composition according to the present invention which comprises a mixture or a combination comprising at least one first linear alkanediol and one or more second linear alkanediol thus includes any one of the following mixtures/combinations:
1,2-pentanediol in combination with one of 1,2-hexanediol, 1,2-heptanediol, 1,2-octanediol, 1,2-nonanediol, 1,2-decanediol, 1,2-undecanediol; or
1,2-hexanediol in combination with one of 1,2-pentanediol, 1,2-heptanediol, 1,2-octanediol, 1,2-nonanediol, 1,2-decanediol, 1,2-undecanediol; or
1,2-heptanediol in combination with one of 1,2-pentanediol, 1,2-hexanediol, 1,2-octanediol, 1,2-nonanediol, 1,2-decanediol, 1,2-undecanediol; or
1,2-octanediol in combination with one of 1,2-pentanediol, 1,2-hexanediol, 1,2-heptanediol, 1,2-nonanediol, 1,2-decanediol, 1,2-undecanediol; or
1,2-nonanediol in combination with one of 1,2-pentanediol, 1,2-hexanediol, 1,2-heptanediol, 1,2-octanediol, 1,2-decanediol, 1,2-undecanediol; or
1,2-decanediol in combination with one of 1,2-pentanediol, 1,2-hexanediol, 1,2-heptanediol, 1,2-octanediol, 1,2-nonanediol, 1,2-undecanediol; or
1,2-undecanediol in combination with one of 1,2-pentanediol, 1,2-hexanediol, 1,2-heptanediol, 1,2-octanediol, 1,2-nonanediol, 1,2-decanediol; or
1,2-pentanediol in combination with one of 2,3-pentanediol, 2,3-hexanediol, 2,3-heptanediol, 2,3-octanediol, 2,3-nonanediol, 2,3-decanediol, 2,3-undecanediol; or
1,2-hexanediol in combination with one of 2,3-pentanediol, 2,3-hexanediolm, 2,3-heptanediol, 2,3-octanediol, 2,3-nonanediol, 2,3-decanediol, 2,3-undecanediol; or
1,2-heptanediol in combination with one of 2,3-pentanediol, 2,3-hexanediol, 2,3-heptanediol, 2,3-octanediol, 2,3-nonanediol, 2,3-decanediol, 2,3-undecanediol; or
1,2-octanediol in combination with one of 2,3-pentanediol, 2,3-hexanediol, 2,3-heptanediol, 2,3-octanediol, 2,3-nonanediol, 2,3-decanediol, 2,3-undecanediol; or
1,2-nonanediol in combination with one of 2,3-pentanediol, 2,3-hexanediol, 2,3-heptanediol, 2,3-octanediol, 2,3-nonanediol, 2,3-decanediol, 2,3-undecanediol; or
1,2-decanediol in combination with one of 2,3-pentanediol, 2,3-hexanediol, 2,3-heptanediol, 2,3-octanediol, 2,3-nonanediol, 2,3-decanediol, 2,3-undecanediol; or
1,2-undecanediol in combination with one of 2,3-pentanediol, 2,3-hexanediol, 2,3-heptanediol, 2,3-octanediol, 2,3-nonanediol, 2,3-decanediol, 2,3-undecane-diol; or
2,3-pentanediol in combination with one of 1,2-pentanediol, 1,2-hexanediol, 1,2-heptanediol, 1,2-octanediol, 1,2-nonanediol, 1,2-decanediol, 1,2-undecanediol; or
2,3-hexanediol in combination with one of 1,2-pentanediol, 1,2-hexanediol, 1,2-heptanediol, 1,2-octanediol, 1,2-nonanediol, 1,2-decanediol, 1,2-undecanediol; or
2,3-heptanediol in combination with one of 1,2-pentanediol, 1,2-hexanediol, 1,2-heptanediol, 1,2-octanediol, 1,2-nonanediol, 1,2-decanediol, 1,2-undecanediol; or
2,3-octanediol in combination with one of 1,2-pentanediol, 1,2-hexanediol, 1,2-heptanediol, 1,2-octanediol, 1,2-nonanediol, 1,2-decanediol, 1,2-undecanediol; or
2,3-nonanediol in combination with one of 1,2-pentanediol, 1,2-hexanediol, 1,2-heptanediol, 1,2-octanediol, 1,2-nonanediol, 1,2-decanediol, 1,2-undecanediol; or
2,3-decanediol in combination with one of 1,2-pentanediol, 1,2-hexanediol, 1,2-heptanediol, 1,2-octanediol, 1,2-nonanediol, 1,2-decanediol, 1,2-undecanediol; or
2,3-undecanediol in combination with one of 1,2-pentanediol, 1,2-hexanediol, 1,2-heptanediol, 1,2-octanediol, 1,2-nonanediol, 1,2-decanediol, 1,2-undecanediol; or
2,3-pentanediol in combination with one of 2,3-hexanediol, 2,3-heptanediol, 2,3-octanediol, 2,3-nonanediol, 2,3-decanediol, 2,3-undecanediol; or
2,3-hexanediol in combination with one of 2,3-pentanediol, 2,3-heptanediol, 2,3-octanediol, 2,3-nonanediol, 2,3-decanediol, 2,3-undecanediol; or
2,3-heptanediol in combination with one of 2,3-pentanediol, 2,3-hexanediol, 2,3-octanediol, 2,3-nonanediol, 2,3-decanediol, 2,3-undecanediol; or
2,3-octanediol in combination with one of 2,3-pentanediol, 2,3-hexanediol, 2,3-heptanediol, 2,3-nonanediol, 2,3-decanediol, 2,3-undecanediol; or
2,3-nonanediol in combination with one of 2,3-pentanediol, 2,3-hexanediol, 2,3-heptanediol, 2,3-octanediol, 2,3-decanediol, 2,3-undecanediol; or
2,3-decanediol in combination with one of 2,3-pentanediol, 2,3-hexanediol, 2,3-heptanediol, 2,3-octanediol, 2,3-nonanediol, 2,3-undecanediol; or
2,3-undecanediol in combination with one of 2,3-pentanediol, 2,3-hexanediol, 2,3-heptanediol, 2,3-octanediol, 2,3-nonanediol, 2,3-decanediol.

In a particular preferred variant, in the detergent and cleaning composition according to the present invention, the linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof.

In a more particular preferred variant, the detergent and cleaning composition according to the present invention which comprises a mixture or a combination comprising at least one first linear alkanediol and one or more second linear alkanediol includes any one of the following mixtures/combinations:
a mixture comprising 1,2-pentanediol and 2,3-pentanediol; or
a mixture comprising 1,2-hexanediol and 2,3-hexanediol; or
a mixture comprising 1,2-heptanediol and 2,3-heptanediol; or
a mixture comprising 1,2-octanediol and 2,3-octanediol; or
a mixture comprising 1,2-nonanediol and 2,3-nonanediol; or
a mixture comprising 1,2-decanediol and 2,3-decanediol; or
a mixture comprising 1,2-undecanediol and 2,3-undecanediol

In said homo alkanediol mixtures the first linear alkanediol and the second linear alkanediol have the same number of carbon atoms.

Particularly favourable is a mixture including 1,2-pentanediol in combination with 2,3-pentanediol or a mixture including 1,2-heptanediol in combination with 2,3-heptanediol, or a mixture including 1,2-octanediol in combination with 2,3-octanediol and/or 3,4-octanediol.

Due to their outstanding bleaching agent boosting effect and improved stain and/or soil removal efficacy a homo alkanediol mixture comprising 1,2-nonanediol and 2,3-nonanediol or a homo alkanediol mixture comprising 1,2-decanediol and 2,3-decanediol or a homo alkanediol mixture comprising 1,2-undecanediol and 2,3-undecanediol are most preferred.

The above specified homo alkanediol mixtures according to the present invention, comprising a 1,2-alkanediol and a 2,3-alkanediol are characterized by a synergistically intensified action, i.e. the alkanediol mixtures boost a bleaching agent in a detergent and cleaning composition in a synergistic way compared to their respective single 1,2-alkanediol or 2,3-alkanediol substances.

Said synergistic effect or action in boosting a bleaching agent was found for the homo mixture including 1,2-pentanediol and 2,3-pentanediol.

Said synergistic effect in boosting a bleaching agent is also observed for the homo mixture including 1,2-hexanediol and 2,3-hexanediol.

The homo mixture including 1,2-heptanediol and 2,3-heptanediol is particularly beneficial since it has a particular pronounced synergistic boosting effect on the bleaching power of a bleaching agent in a detergent and cleaning composition.

The alkanediol mixture comprising 1,2-octanediol and 2,3-octanediol or the alkanediol mixture comprising 1,2-nonanediol and 2,3-nonanediol are particularly advantageous, since the mixtures are effective in synergistically boosting a bleaching agent in a detergent and cleaning composition.

Also, the alkanediol mixture comprising 1,2-decanediol and 2,3-decanediol or the alkanediol mixture comprising 1,2-undecanediol and 2,3-undecanediol synergistically enhance the bleaching performance of a bleaching agent in a detergent and cleaning composition.

The afore-mentioned synergistically improving effect towards the performance of a bleaching agent in a detergent and cleaning composition is particularly pronounced for the homo mixture including 1,2-heptanediol and 2,3-heptanediol or the homo mixture including 1,2-octanediol and 2,3-octanediol or the homo mixture including 1,2-nonanediol and 2,3-nonanediol.

The afore specified homo alkanediol mixtures including a 1,2-alkanediol and the corresponding 2,3-alkanediol display a remarkably synergistic boosting effect and are clearly superior to the individually corresponding 1,2-alkanediols or 2,3-alkanediols and having the same concentration.

In a particular preferred variant, the detergent and cleaning composition according to the present invention which comprises a mixture or a combination comprising at least one first linear alkanediol and one or more second linear alkanediol thus may include any of the following mixtures/combinations:
a mixture comprising 1,2-hexanediol and 1,2-octanediol; or
a mixture comprising 1,2-hexanediol and 2,3-octanediol; or
a mixture comprising 1,2-octanediol and 2,3-hexanediol; or
a mixture comprising 1,2-octanediol and 2,3-heptanediol; or
a mixture comprising 1,2-pentanediol and 2,3-hexanediol; or
a mixture comprising 1,2-pentanediol and 2,3-heptanediol; or
a mixture comprising 1,2-pentanediol and 2,3-octanediol; or
a mixture comprising 1,2-pentanediol and 1,2-nonanediol; or
a mixture comprising 1,2-pentanediol and 2,3-nonanediol; or
a mixture comprising 1,2-heptanediol and 1,2-pentanediol; or
a mixture comprising 1,2-heptanediol and 1,2-hexanediol; or
a mixture comprising 1,2-heptanediol and 1,2-octanediol; or
a mixture comprising 1,2-heptanediol and 2,3-octanediol; or
a mixture comprising 1,2-heptanediol and 1,2-nonanediol; or
a mixture comprising 1,2-heptanediol and 2,3-nonanediol; or
a mixture comprising 1,2-heptanediol and 1,2-decanediol; or
a mixture comprising 1,2-heptanediol and 1,2-undecanediol.

The afore specified alkanediol mixtures according to the present invention, comprising a first linear alkanediol and a second linear alkanediol, are characterized by synergistically intensified action, i.e. the alkanediol mixtures enhance the bleaching performance of a bleaching agent in a detergent and cleaning composition in a synergistic way compared to the corresponding individual 1,2-alkanediol and/or 2,3-alkanediol substances.

In a particular preferred variant, the detergent and cleaning composition according to the present invention which comprises a mixture or a combination comprising at least one first linear alkanediol and one or more second linear alkanediol thus may include the following mixture/combination:
a mixture comprising 1,2-hexanediol and 1,2-octanediol.

Surprisingly, said alkanediol mixture has a particularly pronounced bleaching agent boosting effect.

Beside the afore-described bleaching agent boosting effect, the afore specified mixtures or combinations comprising at least one first linear alkanediol and one or more second linear alkanediol simultaneously have also a synergistic bleachable stain and/or soil removal efficacy, compared to the corresponding individual 1,2-alkanediol and/or 2,3-alkanediol substances.

Still more preferred is a bleach boosting agent mixture, wherein the at least first linear alkanediol is selected from a 1,2-alkanediol having a lower number of carbon atoms from 5 to 8 and the one or more second alkanediol is selected from a 1,2-alkanediol having a higher number of carbon atoms from 9 to 11.

Most preferred is a bleach boosting agent mixture, wherein the at least first linear alkanediol is selected from the group consisting of 1,2-pentanediol, 1,2-hexanediol, 1,2-heptanediol, 1,2-octanediol, and any mixture thereof, and the one or more second alkanediol is selected from the group consisting of 1,2-nonanediol, 1,2-decanediol, 1,2-undecanediol, and any mixture thereof.

Most preferred is a bleach boosting agent blend, wherein the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, and the one or more second alkanediol is selected from the group consisting of 1,2-alkanediols having a higher number of carbon atoms of 9 to 11, i.e. 1,2-nonanediol, 1,2-decanediol, 1,2-undecanediol, and any mixture thereof.

Surprisingly, such alkanediol mixtures of short chain alkanediols and long chain alkanediols have a particularly pronounced bleaching agent boosting effect. In addition, such alkanediol mixtures are also characterized by a remarkable improved bleachable stain and/or soil removal efficacy.

More preferred are such alkanediol mixtures, wherein the difference between the number of carbon atoms of the at least first linear alkanediol and the number of carbon atoms of the one or more second alkanediol is at least 2 carbon atoms. In those alkanediol mixtures, short-chained and long-chained alkanediols are combined with each other resulting in improved enzyme stabilization.

Still more preferred is a bleach boosting agent mixture, wherein the difference between the number of carbon atoms of the at least first linear alkanediol and the number of carbon atoms of the one or more second alkanediol is at least 3 carbon atoms. With such alkanediol mixtures, the bleaching power effect is particularly pronounced.

Such combinations may include any of the following mixtures/combinations:
1,2-pentanediol in combination with one of 1,2-octanediol, 1,2-nonanediol, 1,2-decanediol, 1,2-undecanediol; or
1,2-hexanediol in combination with one of 1,2-nonanediol, 1,2-decanediol, 1,2-undecanediol; or
1,2-heptanediol in combination with one of 1,2-decanediol, 1,2-undecanediol; and
1,2-octanediol in combination with one of 1,2-undecanediol.

In a further preferred variant according to the present invention in the detergent and cleaning composition the linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, and any mixtures thereof.

In a more preferred variant of the detergent and cleaning composition according to the present invention, the linear alkanediol is selected from the group consisting of 2,3-pentanediol, 2,3-hexanediol, 2,3-heptanediol, 2,3-octanediol, 2,3-nonanediol, and any mixtures thereof.

Surprisingly, the addition of 2,3-pentanediol, 2,3-hexanediol, 2,3-heptanediol as well as other 2,3-alkanediols such as 2,3-octanediol, 2,3-nonanediol, 2,3-decanediol, 2,3-undecanediol, to a detergent and cleaning composition comprising a bleaching agent result in a remarkable bleaching agent boosting effect, compared to a detergent and cleaning composition without the addition of an 2,3-alkanediol.

According to a particularly preferred variant, the detergent and cleaning composition according to the present invention comprises at least one bleach boosting agent selected from the group consisting of at least one linear 1,2-alkanediol having a carbon chain of 5 to 8 atoms, or a mixture comprising at least one first linear 1,2-alkanediol having a carbon chain of 5 to 8 carbon atoms and one or more second linear 1,2-alkanediol having a carbon chain of 5 to 8 carbon atoms, which is different from the first linear 1,2-alkanediol.

In a still more preferred variant, the detergent and cleaning composition according to the present invention comprises at least one bleach boosting agent selected from the group consisting of at least one linear 1,2-alkanediol having a carbon chain of 6 to 7 atoms, or a mixture comprising at least one first linear 1,2-alkanediol having a carbon chain of 6 to 7 carbon atoms and one or more second linear 1,2-alkanediol having a carbon chain of 6 to 7 carbon atoms, which is different from the first linear 1,2-alkanediol.

Surprisingly, it was found that these short-chained 1,2-alkanediols are particularly efficient bleach boosting agents, which can also efficiently be incorporated into a broad range of detergents and cleaning compositions. In addition, it was found that these substances show outstanding improved bleachable stain and/or soil removal properties of a detergent and cleaning composition. Thus, such detergents and cleaning compositions show improved cleaning performance compared to a detergent and cleaning composition without the addition of such substances.

According to a particularly preferred variant, the detergent and cleaning composition according to the present invention comprises at least one bleach boosting agent selected from the group consisting of at least one linear 1,2-alkanediol having a carbon chain of 7 to 11 atoms, or a mixture comprising at least one first linear 1,2-alkanediol having a carbon chain of 7 to 11 carbon atoms and one or more second linear 1,2-alkanediol having a carbon chain of 7 to 11 carbon atoms, which is different from the first linear 1,2-alkanediol.

In a more preferred variant, the detergent and cleaning composition according to the present invention comprises at least one bleach boosting agent selected from the group consisting of at least one linear 1,2-alkanediol having a carbon chain of 9 to 11 atoms, or a mixture comprising at least one first linear 1,2-alkanediol having a carbon chain of 9 to 11 carbon atoms and one or more second linear 1,2-alkanediol having a carbon chain of 9 to 11 carbon atoms, which is different from the first linear alkanediol.

Surprisingly, it was found that these long-chained 1,2-alkanediols are particularly suitable bleach boosting agents, which can also efficiently be incorporated into a broad range of detergents and cleaning compositions. In addition, it was found that these substances show outstanding improved bleachable stain and/or soil removal properties of a detergent and cleaning composition. Thus, such detergents and cleaning compositions show improved cleaning properties compared to detergent and cleaning composition without the addition of such substances.

In a further preferred variant, the detergent and cleaning composition according to the present invention comprises at least one bleach boosting agent selected from the group consisting of at least one linear 1,2-alkanediol having a log Pow value of ≤1, or a mixture comprising at least one first linear 1,2-alkanediol having a log Pow value of ≤1 and one or more second linear 1,2-alkanediol having a log Pow value of $1, which is different from the first linear 1,2-alkanediol.

The 1,2-alkanediols having a log Pow value of ≤1 are selected from the group consisting of 1,2-pentanediol (log Pow=0.06), 1,2-hexanediol (log Pow=0.58), 1,2-heptanediol (log Pow=0.9), and any mixture thereof. Said 1,2-alkanediols are more soluble in water.

The Pow value is the partition coefficient of a chemical compound for the two-phase system consisting of the two immiscible solvents n-octanol and water at equilibrium. This value is therefore a comparison of the solubility of the solute in these two liquids. Hence the partition coefficient measures how hydrophilic or hydrophobic a chemical substance is.

The log Pow value is a constant defined in the following manner:

Log Pow=log 10 (Partition Coefficient)

Partition Coefficient, P=[n-octanol]/[water]
where [ ] indicates the concentration of solute in the organic and/or aqueous partition.
The log Pow value is determined at a standard temperature of 25° C.

The log Pow value≤1 means the compound has a higher affinity for the aqueous phase (it is more hydrophilic) and, thus, more soluble in water; a log Pow value ≥1 denotes a higher concentration in the lipid phase (i.e., the compound is more lipophilic) and, thus, more soluble in fat-like solvents.

Surprisingly, it was found that 1,2-alkanediols having a Pow value of ≤1 are particularly suitable bleach boosting agents, which can also efficiently be incorporated into a broad range of detergents and cleaning compositions. In addition, it was found that the aforesaid 1,2-alkanediols exhibit outstanding improved stain and/or soil removal properties in a detergent and cleaning composition. Thus, detergents and cleaning compositions comprising 1,2-alkanediols having a Pow value of ≤1 show improved cleaning properties compared to detergent and cleaning composition without the addition of such 1,2-alkanediols.

In a still further preferred variant, the detergent and cleaning composition according to the present invention comprises at least one bleach boosting agent selected from the group consisting of at least one linear 1,2-alkanediol having a log Pow value of ≥1, or a mixture comprising at least one first linear 1,2-alkanediol having a log Pow value of ≥1 and one or more second linear 1,2-alkanediol having a log Pow value of ≥1, which is different from the first linear 1,2-alkanediol.

The 1,2-alkanediols having a log Pow value of ≥1 are selected from the group consisting of 1,2-octanediol (log Pow=2.1), 1,2-nonanediol, 1,2-decanediol, 1,2-undecanediol, and any mixtures thereof. Said 1,2-alkanediols are more soluble in fat-like solvents, for example n-octanol.

Surprisingly, it was found that 1,2-alkanediols having a Pow value of ≥1 are suitable bleach boosting agents, which can also efficiently be incorporated into a broad range of detergents and cleaning compositions. In addition, it was found that the aforesaid 1,2-alkanediols exhibit outstanding improved stain and/or soil removal properties in a detergent and cleaning composition. Thus, detergents and cleaning compositions comprising 1,2-alkanediols having a Pow value of ≥1 show improved cleaning properties compared to detergent and cleaning composition without the addition of such 1,2-alkanediols.

The term “alkanediol” within the context of the present invention also includes its stereoisomers. Stereoisomers are molecules that have the same molecular formula and differ only in how their atoms are arranged in three-dimensional space. In accordance with said definition, the linear alkanediol of the invention or the first linear alkanediol having a carbon chain of 5 to 11 carbon atoms or the second linear alkanediol having a carbon chain of 5 to 11 carbon atoms as described above in detail encompass the following stereoisomers:

1,2-alkanediol stereoisomers:

| | |
|---|---|
| (2S)-pentane-1,2-diol, | (2R)-pentane-1,2-diol, |
| (2S)-hexane-1,2-diol, | (2R)-hexane-1,2-diol, |
| (2S)-heptane-1,2-diol, | (2R)-heptane-1,2-diol, |
| (2S)-octane-1,2-diol, | (2R)-octane-1,2-diol, |
| (2S)-nonane-1,2-diol, | (2R)-nonane-1,2-diol, |
| (2S)-decane-1,2-diol, | (2R)-decane-1,2-diol, |
| (2S)-undecane-1,2-diol, | (2R)-undecane-1,2-diol, |
| (2S)-dodecane-1,2-diol, | (2R)-dodecane-1,2-diol, |
| (2S)-tridecane-1,2-diol, | (2R)-tridecane-1,2-diol, |
| (2S)-tetradecane-1,2-diol, | (2R)-tetradecane-1,2-diol, |

2,3-alkanediol stereoisomers:

| | |
|---|---|
| (2S,3S)-pentane-2,3-diol, | (2R,3R)-pentane-2,3-diol, |
| (2S,3S)-hexane-2,3-diol, | (2R,3R)-hexane-2,3-diol, |
| (2S,3S)-heptane-2,3-diol, | (2R,3R)-heptane-2,3-diol, |
| (2S,3S)-octane-2,3-diol, | (2R,3R)-octane-2,3-diol, |
| (2S,3S)-nonane-2,3-diol, | (2R,3R)-nonane-2,3-diol, |
| (2S,3S)-decane-2,3-diol, | (2R,3R)-decane-2,3-diol, |
| (2S,3S)-undecane-2,3-diol, | (2R,3R)-undecane-2,3-diol, |
| (2S,3S)-dodecane-2,3-diol, | (2R,3R)-dodecane-2,3-diol, |
| (2S,3S)-tridecane-2,3-diol, | (2R,3R)-tridecane-2,3-diol, |
| (2S,3S)-tetradecane-2,3-diol, | (2R,3R)-tetradecane-2,3-diol, |
| (2S,3R)-pentane-2,3-diol, | (2R,3S)-pentane-2,3-diol, |
| (2S,3R)-hexane-2,3-diol, | (2R,3S)-hexane-2,3-diol, |
| (2S,3R)-heptane-2,3-diol, | (2R,3S)-heptane-2,3-diol, |
| (2S,3R)-octane-2,3-diol, | (2R,3S)-octane-2,3-diol, |
| (2S,3R)-nonane-2,3-diol, | (2R,3S)-nonane-2,3-diol, |
| (2S,3R)-decane-2,3-diol, | (2R,3S)-decane-2,3-diol, |
| (2S,3R)-undecane-2,3-diol, | (2R,3S)-undecane-2,3-diol, |
| (2S,3R)-dodecane-2,3-diol, | (2R,3S)-dodecane-2,3-diol, |
| (2S,3R)-tridecane-2,3-diol, | (2R,3S)-tridecane-2,3-diol, |
| (2S,3R)-tetradecane-2,3-diol, | (2R,3S)-tetradecane-2,3-diol. |

3,4-alkanediol stereoisomers:

| | |
|---|---|
| (3R,4R)-pentane-3,4-diol, | (3S,4S)-pentane-3,4-diol, |
| (3R,4R)-hexane-3,4-diol, | (3S,4S)-hexane-3,4-diol, |
| (3R,4R)-heptane-3,4-diol, | (3S,4S)-heptane-3,4-diol, |
| (3R,4R)-octane-3,4-diol, | (3S,4S)-octane-3,4-diol, |
| (3R,4R)-nonane-3,4-diol, | (3S,4S)-nonane-3,4-diol, |
| (3R,4R)-decane-3,4-diol, | (3S,4S)-decane-3,4-diol, |
| (3R,4R)-undecane-3,4-diol, | (3S,4S)-undecane-3,4-diol, |
| (3R,4R)-dodecane-3,4-diol, | (3S,4S)-dodecane-3,4-diol, |
| (3R,4R)-tridecane-3,4-diol, | (3S,4S)-tridecane-3,4-diol, |
| (3R,4R)-tetradecane-3,4-diol, | (3S,4S)-tetradecane-3,4-diol, |

| | |
|---|---|
| (3R,4S)-pentane-3,4-diol, | (3S,4R)-pentane-3,4-diol, |
| (3R,4S)-hexane-3,4-diol, | (3S,4R)-hexane-3,4-diol, |
| (3R,4S)-heptane-3,4-diol, | (3S,4R)-heptane-3,4-diol, |
| (3R,4S)-octane-3,4-diol, | (3S,4R)-octane-3,4-diol, |
| (3R,4S)-nonane-3,4-diol, | (3S,4R)-nonane-3,4-diol, |
| (3R,4S)-decane-3,4-diol, | (3S,4R)-decane-3,4-diol, |
| (3R,4S)-undecane-3,4-diol, | (3S,4R)-undecane-3,4-diol, |
| (3R,4S)-dodecane-3,4-diol, | (3S,4R)-dodecane-3,4-diol, |
| (3R,4S)-tridecane-3,4-diol, | (3S,4R)-tridecane-3,4-diol, |
| (3R,4S)-tetradecane-3,4-diol, | (3S,4R)-tetradecane-3,4-diol. |

In the context of the present text, the terms “1,2-diol”, “2,3-diol” or “3,4-diol” includes both the corresponding S-configured enantiomers and also the R-enantiomer as well as arbitrary mixtures of these S- and R-configured enantiomers, i.e. mixtures of racemates of the respective diols.

The alkanediol mixture of the detergent and cleaning composition according to the first aspect of the present invention comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

In the detergent and cleaning composition according to the first aspect of the present invention, 1,2-heptanediol and 2,3-heptanediol are comprised in the mixture preferably in a ratio in a range of 98:2 to 99.9:0.1.

In the detergents and cleaning compositions according to the first aspect of the present invention, 1,2-heptanediol and 2,3-heptanediol are comprised in the alkanediol mixture preferably in a ratio in a range of 95:5 to 99.9:0.1.

Preferably, 1,2-heptanediol and 2,3-heptanediol are comprised in the mixture of the detergent and cleaning composition according to the first aspect of the present invention in a ratio of ≥95:≤5, more preferred in a ratio of ≥96:≤4; still more preferred in a ratio of ≥97:≤3, and most preferred in a ratio of ≥98:≤2.

Most of all the mixtures of the detergent and cleaning composition according to the first aspect of the present invention comprises 1,2-heptanediol and 2,3-heptanediol in a ratio of ≥95:≤5, including the ratios ≥95.5:≤4.5; ≥96:≤4; ≥96.5:≤3.5; ≥97:≤3; ≥97.5:2.5 and ≥98.0:≤2.0.

Even more preferred the alkanediol mixture of the detergent and cleaning composition according to the first aspect of the present invention comprises 1,2-heptanediol and 2,3-heptanediol in a ratio of ≥98:≤2, including the ratios of ≥98.1:≤1.9; ≥98.2:≤1.8; ≥98.3:≤1.7; ≥98.4:≤1.6; ≥98.5:≤1.5; ≥98.6:≤1.4; ≥98.7:≤1.3; ≥98.8:≤1.2; ≥98.9:≤1.1; ≥99:≤1.0; ≥99.1:≤0.9; ≥99.2:≤0.8; ≥99.3:≤0.7; ≥99.4:≤0.6; ≥99.5:≤0.5; ≥99.6:≤0.4; ≥99.7:≤0.3; ≥99.8:≤0.2 and ≥99.9:≤0.1.

The first linear alkanediol and the second linear alkanediol as defined in detail above, are present in the alkanediol mixture according to the second aspect of the present invention in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

In the detergent and cleaning composition according to the other aspect of the present invention, the first linear alkanediol and the second linear alkanediol are comprised in the mixture preferably in a ratio in a range of 98:2 to 99.9:0.1

In the detergent and cleaning composition according to the other aspect of the present invention, the first linear alkanediol and the second alkanediol are comprised in the alkanediol mixture preferably in a ratio in a range of 95:5 to 99.9:0.1.

Preferably, the first linear alkanediol and the second alkanediol are comprised in the mixture of the detergent and cleaning composition according to the other aspect of the present invention in a ratio of ≥95:≤5, more preferred in a ratio of ≥96:≤4; still more preferred in a ratio of ≥97:≤3, and most preferred in a ratio of ≥98:≤2.

Most of all the mixtures of the detergent and cleaning composition according to the other aspect of the present invention comprises the first linear alkanediol and the second linear alkanediol in a ratio of ≥95:≤5, including the ratios ≥95.5:≤4.5; ≥96:≤4; ≥96.5:≤3.5; ≥97:≤3; ≥97.5:2.5 and ≥98.0:≤2.0.

Even more preferred the alkanediol mixture of the detergent and cleaning composition according to the other aspect of the present invention comprises the first linear alkanediol and the second alkanediol in a ratio of ≥98:≤2, including the ratios of ≥98.1:≤1.9; ≥98.2:≤1.8; ≥98.3:≤1.7; ≥98.4:≤1.6; ≥98.5:≤1.5; ≥98.6:≤1.4; ≥98.7:≤1.3; ≥98.8:≤1.2; ≥98.9:≤1.1; ≥99:≤1.0; ≥99.1:≤0.9; ≥99.2:≤0.8; ≥99.3:≤0.7; ≥99.4:≤0.6; ≥99.5:≤0.5; ≥99.6:≤0.4; ≥99.7:≤0.3; ≥99.8:≤0.2 and ≥99.9:≤0.1.

Alternatively, said ratio ranges for the first and second alkanediol are switched, such that the second alkanediol is the main component and the first alkanediol is the secondary component.

In an advantageous variant according to the other aspect of the present invention, the alkanediol mixture comprises as first linear alkanediol an 1,2-alkanediol, such as 1,2-pentanediol, 1,2-hexanediol, 1,2-heptanediol, 1,2-octanediol, 1,2-nonanediol, 1,2-decanediol, 1,2-undecanediol, and as second linear alkanediol the corresponding 2,3-alkanediols, such as 2,3-pentanediol, 2,3-hexanediol, 2,3-heptanediol, 2,3-octanediol, 2,3-nonanediol, 2,3-decanediol, 2,3-undecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol:second alkanediol or ranges of ratios as described above are also applicable.

In a still further variant, according to the other aspect of the present invention, the alkanediol mixture comprises as first linear alkanediol an 2,3-alkanediol, such as 2,3-pentanediol, 2,3-hexanediol, 2,3-heptanediol, 2,3-octanediol, 2,3-nonanediol, 2,3-decanediol, 2,3-undecanediol, and as second linear alkanediol the corresponding 1,2-alkanediols, such as 1,2-pentanediol, 1,2-hexanediol, 1,2-heptanediol, 1,2-octanediol, 1,2-nonanediol, 1,2-decanediol, 1,2-undecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol:second alkanediol or ranges of ratios as described above are also applicable.

In a more advantageous variant according to the other aspect of the present invention, in the alkanediol mixtures comprising a combination of a 1,2-alkanediol as first linear alkanediol and the corresponding 2,3-alkanediol as second linear alkanediol, such as
1,2-pentanediol and 2,3-pentanediol, or
1,2-hexanediol and 2,3-hexanediol, or
1,2-heptanediol and 2,3-heptanediol, or
1,2-octanediol and 2,3-octanediol, or
1,2-nonanediol and 2,3-nonanediol, or
1,2-decanediol and 2,3-decanediol, or
1,2-undecanediol and 2,3-undecenaediol, or
1,2-dodecanediol and 2,3-dodecanediol, or
1,2-tridecanediol and 2,3-tridecanediol, or
1,2-tetradecanediol and 2,3-tetradecanediol,
the first linear alkanediol and the second linear alkanediol are present in a ratio in a range of 50:50 to 99.9:0.1, preferably in a ratio in a range of 75:25 to 99:1, more preferred in a ratio in a range of 80:20 to 98:2 or still more preferred in ratio in a range of 90:10 to 95:5.

Likewise, for said alkanediol mixtures the ratios of first linear alkanediol:second alkanediol or ranges of ratios as described above are also applicable.

A preferred variant according to the other aspect the present invention also encompasses a mixture including as first linear alkanediol 1,2-hexanediol and as second linear alkanediol 1,2-octanediol either in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

Thus, according to another preferred variant, the present invention relates to a detergent and cleaning composition,
(i) wherein the mixture comprising 1,2-heptanediol and 2,3-heptanediol comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5; or
(ii) wherein the mixture comprising at least one first linear alkanediol and one or more second linear alkanediol comprises the first linear alkanediol and the second alkanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5.

By the above specified mixing ratios, the afore mentioned alkanediol mixtures show a synergistically intensified bleaching agent boosting and bleachable stain and/or soil removal effect in comparison with the corresponding individual alkanediol-substances.

The alkanediols are obtained either by synthesis from petrochemical or other fossil fuel sources by known methods such as olefin bis-hydroxylation, hydrolysis from epoxide or various chemical transformations or from bioderived feedstock by fermentation or from bio-based natural and renewable feedstock such as biomass by catalytic synthesis as it is described in US 2019/0241491 A1 and US 2020/0189995 A1. The alkanediols used according to the present invention comprise either petrochemically derived and biobased natural and renewable feedstock derived alkanediols. Preferably, the alkanediols are from bio-based sources and are thus bio-alkanediols.

Beyond the above specified alkanediols, the bleach boosting agent of the detergent and cleaning composition according to the present invention is either (b^{II}) glyceryl caprylate, or (b^{III}) 4-hydroxyacetophenone, or (b^{IV}) tropolone, or any mixture of the aforementioned agents.

Glyceryl Caprylate (b^{II})

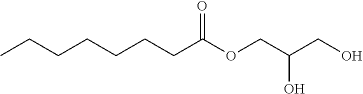

is a natural emollient derived from glycerine and plant fatty acids, usually appearing as a white waxy solid. This ingredient is used in many skincare products for its emollient and moisturising properties, to help maintain the balance of moisture in the skin. In additional, glyceryl caprylate (b^{II}) is used as antimicrobial active component in cosmetic preparations.

It was surprisingly found that the oily, surface-active co-emulsifier glyceryl caprylate is a further suitable bleach boosting agent within the meaning of the present invention.

4-Hydroxyacetophenone (4-HAP) (b^{III})

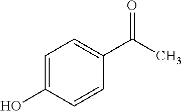

possesses oxidation-inhibiting, fungicidal and bacterial growth-inhibiting properties and is therefore used to stabilize cosmetic preparations.

It was surprisingly found that the 4-HAP is a further suitable bleach boosting agent within the meaning of the present invention.

### Tropolone (b^{V})

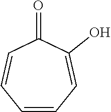

is known for its antibacterial, antifungal, anti-inflammatory, antioxidant, and chelating properties and is therefore used in cosmetic formulations.

It was surprisingly found that tropolone act as bleaching agent booster in a detergent and cleaning composition within the meaning of the present invention.

The above specified bleach boosting agents (b^{II}) (b^{III}), and (b^{IV}) can be used in the detergent and cleaning composition either individually or in the form of mixtures of two, or even more bleach boosting agents.

In a particular preferred variant, the at least one bleach boosting agent (b) in the detergent and cleaning composition according to the present invention includes any of the following mixtures/combinations:
a mixture comprising (b^{II}) glyceryl caprylate and (b^{III}) 4-hydroxyacetophenone;
a mixture comprising (b^{II}) glyceryl caprylate and (b^{IV}) tropolone; and
a mixture comprising (b^{III}) 4-hydroxyacetophenone and (b^{IV}) tropolone.

For said bleach boosting agent mixtures even a synergistic bleach boosting effect can be observed.

Similarly, the above specified single bleach boosting agents (b^{II}) (b^{III}), and (b^{IV}) or mixtures of two or three bleach boosting agents (b^{II}), (b^{III}), and (b^{IV}) can also be used in the detergent and cleaning composition in mixture with one or two alkanediol(s) bleach boosting agents (b^{I}) as defined herein. Preferably, such mixtures contain two, or even more bleach boosting agents as defined herein.

In a particular preferred variant, the at least one bleach boosting agent (b) in the detergent and cleaning composition according to the present invention includes any of the following mixtures/combinations:
a mixture comprising (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above, and (b^{II}) glyceryl caprylate;
a mixture comprising (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above, and (b^{III}) 4-hydroxyacetophenone;
a mixture comprising (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above, and (b^{V}) tropolone.

In a preferred variant, the deter detergent and cleaning composition according to the present invention includes any of the following boosting agent mixtures/combinations selected from the group consisting of:
a mixture comprising (b^{II}) glyceryl caprylate and 1,2-pentanediol;
a mixture comprising (b^{II}) glyceryl caprylate and 1,2-hexanediol;
a mixture comprising (b^{II}) glyceryl caprylate and 1,2-heptanediol;
a mixture comprising (b^{II}) glyceryl caprylate and 1,2-octanediol;
a mixture comprising (b^{II}) glyceryl caprylate and 1,2-nonanediol;
a mixture comprising (b^{II}) glyceryl caprylate and 1,2-decanediol;
a mixture comprising (b^{II}) glyceryl caprylate and 1,2-undecanediol;
a mixture comprising (b^{III}) 4-hydroxyacetophenone and 1,2-pentanediol;
a mixture comprising (b^{III}) 4-hydroxyacetophenone and 1,2-hexanediol;
a mixture comprising (b^{III}) 4-hydroxyacetophenone and 1,2-heptanediol;
a mixture comprising (b^{III}) 4-hydroxyacetophenone and 1,2-octanediol;
a mixture comprising (b^{III}) 4-hydroxyacetophenone and 1,2-nonanediol;
a mixture comprising (b^{III}) 4-hydroxyacetophenone and 1,2-decanediol;
a mixture comprising (b^{II}) 4-hydroxyacetophenone and 1,2-undecanediol;
a mixture comprising (b^{V}) tropolone and 1,2-pentanediol;
a mixture comprising (b^{V}) tropolone and 1,2-hexanediol;
a mixture comprising (b^{V}) tropolone and 1,2-heptanediol;
a mixture comprising (b^{V}) tropolone and 1,2-octanediol;
a mixture comprising (b^{V}) tropolone and 1,2-nonanediol;
a mixture comprising (b^{V}) tropolone and 1,2-decanediol;
a mixture comprising (b^{V}) tropolone and 1,2-undecanediol;

Surprisingly, it was found that the above specified mixtures/combinations are particularly efficient bleach boosting agents, which can also efficiently be incorporated into a broad range of detergents and cleaning compositions. In addition, it was found that these mixtures of bleach boosting agents remarkably improve bleachable stain and/or soil removal. Both, the improved bleaching performance and improved stain and/or soil removal result in a better performance of the detergent and cleaning composition in a washing or cleaning process in comparison to a detergent and cleaning composition without the addition of said bleach boosting agents.

Surprisingly, for said bleach boosting agent mixtures even a synergistic bleach boosting effect can be observed.

Most preferred, the deter detergent and cleaning composition according to the present invention includes a mixture of bleach boosting agents comprising an 1,2-alkanediol combined with 4-hydroxyacetophenone selected from the group consisting of:
a mixture comprising (b^{III}) 4-hydroxyacetophenone and 1,2-pentanediol;
a mixture comprising (b^{III}) 4-hydroxyacetophenone and 1,2-hexanediol;
a mixture comprising (b^{III}) 4-hydroxyacetophenone and 1,2-heptanediol;
a mixture comprising (b^{III}) 4-hydroxyacetophenone and 1,2-octanediol;
a mixture comprising (b^{III}) 4-hydroxyacetophenone and 1,2-nonanediol;
a mixture comprising (b^{III}) 4-hydroxyacetophenone and 1,2-decanediol;
a mixture comprising (b^{III}) 4-hydroxyacetophenone and 1,2-undecanediol.

It was found that these mixtures show outstanding synergistic bleach boosting power in a detergent and cleaning composition. Thus, such detergents and cleaning compositions show improved cleaning properties compared to detergent and cleaning composition without the addition of such bleach boosting combinations.

However, a particular pronounced bleaching agent boosting effect can be observed for the following bleach boosting agents:
1,2-pentanediol;
1,2-hexanediol;
1,2-heptanediol;
1,2-octanediol;
1,2-nonanediol;
1,2-decanediol;
1,2-undecanediol;
glyceryl caprylate;
4-hydroxyacetophenone;
tropolone;
a mixture comprising 1,2-hexanediol and 1,2-octanediol;
a mixture comprising 1,2-hexanediol and 1,2-octanediol and tropolone; and
a mixture comprising 4-hydroxyacetophenone and 1,2-octanediol.

For the detergent and cleaning composition according to the present invention, the list of bleach boosting agents (b) specified herein can be arbitrary combined with the list of bleaching agents specified herein.

In a particular advantageously variant, the detergent and cleaning composition according to the present invention comprises one of the following combinations of components (a) and (b):
chlorine bleaches plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; or.
hydrogen peroxide (H2O2) plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; or
alkali metal percarbonates plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; or
alkali metal perborates plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; or
alkali metal perphosphates plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; or
alkali metal persulfates plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; or
alkali metal persilicates plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; or
percarboxylic acid bleaches plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; or
photoactivated bleaches plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; and
chlorine or bromine releasing bleaches plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; and
oxidase enzymes plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone.

In a particular preferred variant, the detergent and cleaning composition according to the present invention comprises one of the following combinations of components (a) and (b):
hydrogen peroxide (H2O2) plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}); or
sodium percarbonate plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; or
sodium perborate plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone; or
peracetic acid plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) (b^{V}) tropolone;
phthalimido peroxycaproic acid plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone;
glucose oxidase plus one or more of the following bleach boosting agents: (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined above; (b^{II}) glyceryl caprylate; (b^{III}) 4-hydroxyacetophenone; or (b^{IV}) tropolone.

In a more preferred variant, the detergent and cleaning composition according to the present invention comprises one of the following combinations of components (a) and (b):
hydrogen peroxide plus 1,2-pentanediol;
hydrogen peroxide plus 1,2-hexanediol;
hydrogen peroxide plus 1,2-heptanediol;
hydrogen peroxide plus 1,2-octanediol;
hydrogen peroxide plus glyceryl caprylate;
hydrogen peroxide plus 4-hydroxyacetophenone;
hydrogen peroxide plus tropolone;
hydrogen peroxide plus a mixture comprising 1,2-hexanediol and 1,2-octanediol;
hydrogen peroxide plus a mixture comprising 1,2-hexanediol and 1,2-octanediol and tropolone;
hydrogen peroxide plus a mixture comprising 4-hydroxyacetophenone and 1,2-octanediol;
sodium percarbonate plus 1,2-pentanediol;
sodium percarbonate plus 1,2-hexanediol;
sodium percarbonate plus 1,2-heptanediol;
sodium percarbonate plus 1,2-octanediol;
sodium percarbonate plus glyceryl caprylate;
sodium percarbonate plus 4-hydroxyacetophenone;
sodium percarbonate plus tropolone;
sodium percarbonate plus a mixture comprising 1,2-hexanediol and 1,2-octanediol;
sodium percarbonate plus a mixture comprising 1,2-hexanediol and 1,2-octanediol and tropolone;
sodium percarbonate plus a mixture comprising 4-hydroxyacetophenone and 1,2-octanediol;
sodium perborate plus 1,2-pentanediol;
sodium perborate plus 1,2-hexanediol;
sodium perborate plus 1,2-heptanediol;
sodium perborate plus 1,2-octanediol;
sodium perborate plus glyceryl caprylate;
sodium perborate plus 4-hydroxyacetophenone;
sodium perborate plus tropolone;
sodium perborate plus a mixture comprising 1,2-hexanediol and 1,2-octanediol;
sodium perborate plus a mixture comprising 1,2-hexanediol and 1,2-octanediol and tropolone;
sodium perborate plus a mixture comprising 4-hydroxyacetophenone and 1,2-octanediol;
peracetic acid plus 1,2-pentanediol;
peracetic acid plus 1,2-hexanediol;
peracetic acid plus 1,2-heptanediol;
peracetic acid plus 1,2-octanediol;
peracetic acid plus glyceryl caprylate;
peracetic acid plus 4-hydroxyacetophenone;
peracetic acid plus tropolone;
peracetic acid plus a mixture comprising 1,2-hexanediol and 1,2-octanediol;
peracetic acid plus a mixture comprising 1,2-hexanediol and 1,2-octanediol and tropolone;
peracetic acid plus a mixture comprising 4-hydroxyacetophenone and 1,2-octanediol;
phthalimido peroxycaproic acid plus 1,2-pentanediol;
phthalimido peroxycaproic acid plus 1,2-hexanediol;
phthalimido peroxycaproic acid plus 1,2-heptanediol;
phthalimido peroxycaproic acid plus 1,2-octanediol;
phthalimido peroxycaproic acid plus glyceryl caprylate;
phthalimido peroxycaproic acid plus 4-hydroxyacetophenone;
phthalimido peroxycaproic acid plus tropolone;
phthalimido peroxycaproic acid plus a mixture comprising 1,2-hexanediol and 1,2-octanediol;
phthalimido peroxycaproic acid plus a mixture comprising 1,2-hexanediol and 1,2-octanediol and tropolone;
phthalimido peroxycaproic acid plus a mixture comprising 4-hydroxyacetophenone and 1,2-octanediol;
glucose oxidase plus 1,2-pentanediol;
glucose oxidase plus 1,2-hexanediol;
glucose oxidase plus 1,2-heptanediol;
glucose oxidase plus 1,2-octanediol;
glucose oxidase plus glyceryl caprylate;
glucose oxidase plus 4-hydroxyacetophenone;
glucose oxidase plus tropolone;
glucose oxidase plus a mixture comprising 1,2-hexanediol and 1,2-octanediol;
glucose oxidase plus a mixture comprising 1,2-hexanediol and 1,2-octanediol and tropolone; or
glucose oxidase plus a mixture comprising 4-hydroxyacetophenone and 1,2-octanediol.

In a further preferred variant, the detergent and cleaning composition according to the present invention comprises one of the following combinations of components (a) and (b):
hydrogen peroxide plus 1,2-nonanediol;
hydrogen peroxide plus 1,2-decanediol;
hydrogen peroxide plus 1,2-undecanediol;
sodium percarbonate plus 1,2-nonanediol;
sodium percarbonate plus 1,2-decanediol;
sodium percarbonate plus 1,2-undecanediol;
sodium perborate plus 1,2-nonanediol;
sodium perborate plus 1,2-decanediol;
sodium perborate plus 1,2-undecanediol;
peracetic acid plus 1,2-nonanediol;
peracetic acid plus 1,2-decanediol;
peracetic acid plus 1,2-undecanediol;
phthalimido peroxycaproic acid plus 1,2-nonanediol;
phthalimido peroxycaproic acid plus 1,2-decanediol;
phthalimido peroxycaproic acid plus 1,2-undecanediol;
glucose oxidase plus 1,2-nonanediol;
glucose oxidase plus 1,2-decanediol;
glucose oxidase plus 1,2-undecanediol.

It was unexpectedly found that the aforesaid combinations comprising a bleaching agent and a bleach boosting agent result in superior bleaching performance in a detergent and cleaning composition, i.e. the bleaching performance of such detergent and cleaning composition is better than the bleaching performance of a detergent and cleaning composition which does not include a bleach boosting agent.

However, said combinations comprising a bleaching agent and a bleach boosting agent do not only have a remarkable bleaching power, but are simultaneously beneficial in laundry detergents, detergents for manual and automatic dishwash, cleaners for medical and dental instruments, stain removers and the like, since they exhibit an enhanced bleachable stain and/or soil removal activity, resulting in an improved cleaning performance upon application, in comparison to a detergent and cleaning composition without the addition of said bleach boosting agents.

### Surfactant/Component (c1, c2, c3, c)

The detergent and cleaning composition according to the present invention includes at least one surfactant. (c1, c2, c3, c).

Surfactants are added for a number of reasons, the main purposes being their washing and surface-active properties. They remove soils from the clothing and surfaces in the washing and cleaning process and keep it suspended in the washing solution. Some surfactants perform other functions such as foam inhibition.

The detergent and cleaning composition according to the present invention may comprise any kind of surfactant, namely anionic surfactants, cationic surfactants, non-ionic surfactants, amphoteric/zwitterionic surfactant, and any mixture thereof.

Suitable surfactants which can be incorporated into the detergents and cleaning compositions according to the present invention are:

### Anionic Surfactants

Suitable anionic surfactants for the detergent and cleaning composition according to the present invention may include any conventional anionic surfactants. Typical examples for anionic surfactants encompass:
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide;
   and any mixture thereof.

In a preferred variant of the detergent and cleaning composition according to the present invention, the anionic surfactant is selected from the group consisting of
C10 to C13 alkyl benzene sulfonates;
C12 to C15 alkyl sulfates;
C12 to C14 alkyl sulfates, ethoxylated with 1 to 3 moles ethylene oxide;
C12 to C16 alpha-olefin sulfonates;
C8 to C18 alkyl carboxylates, ethoxylated with 3 to 10 moles ethylene oxide;
   and any mixture thereof.

In a more preferred variant of the detergent and cleaning composition according to the present invention, the anionic surfactant is selected from the group consisting of
dodecyl benzene sulfonate;
dodecyl sulfate;
dodecyl sulfate, ethoxylated with 2 moles ethylene oxide;
C12 to C14 alpha-olefin sulfonates;
C18 alkyl carboxylates, ethoxylated with 9 to 10 moles ethylene oxide;
   and any mixture thereof.

For laundry detergents, the anionic surfactant is most preferred selected from the group consisting of dodecyl benzene sulfonate, dodecyl sulfate, dodecyl sulfate, ethoxylated with 2 moles ethylene oxide, and any mixture thereof.

For hand dishwashing detergents, the anionic surfactant is most preferred selected from the group consisting of dodecyl sulfate, dodecyl sulfate, ethoxylated with 2 moles ethylene oxide, and any mixture thereof.

For hard surface cleaning detergents, the anionic surfactant is most preferred selected from the group consisting of dodecyl sulfate, dodecyl sulfate, ethoxylated with 2 moles ethylene oxide, and any mixture thereof.

### Cationic Surfactants

Suitable cationic surfactants for the detergent and cleaning composition according to the present invention may include any conventional cationic surfactants. Typical examples for cationic surfactants encompass:
quaternary C8 to C18 alkyl ethanolamines;
quaternary C8 to C18 alkyl ammonium compounds;
C8 to C18 alkyl ammonium methosulfates;
   and any mixture thereof.

In a preferred variant of the detergent and cleaning composition according to the present invention, the cationic surfactant is selected from the group consisting of
quaternary C12 to C18 alkyl ethanolamines;
quaternary C12 to C18 alkyl ammonium compounds;
C12 to C18 alkyl ammonium methosulfates;
   and any mixture thereof.

In a more preferred variant of the detergent and cleaning composition according to the present invention, the cationic surfactant is selected from the group consisting of
quaternary C16 to C18 alkyl ethanolamines;
quaternary C16 to C18 alkyl ammonium compounds;
C14 to C18 alkyl ammonium methosulfates;
   and any mixture thereof.

For hard surface cleaning detergents, the cationic surfactant is most preferred selected form the group consisting of quaternary C16 to C18 alkyl ammonium compounds, and any mixture thereof.

For fabric softener, the cationic surfactant is most preferred selected form the group consisting of C14 to C18 alkyl ammonium methosulfates, and any mixture thereof.

### Non-Ionic Surfactants

Suitable non-ionic surfactants for the detergent and cleaning composition according to the present invention may include any conventional non-ionic surfactants. Typical examples for non-ionic surfactants encompass:
C6 to C18 fatty alcohols, ethoxylated with 1 to 12 moles ethylene oxide;
alkoxylated C6 to C18 fatty alcohols such as
   C6 to C18 fatty alcohols, ethoxylated with 1 to 25 moles ethylene oxide,
   C6 to C18 fatty alcohols, propoxylated with 1 to 15 moles propylene oxide,
   C6 to C18 fatty alcohols, butoxylated with 1 to 10 moles butylene oxide, and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
   and any mixture thereof.

In a preferred variant of the detergent and cleaning composition according to the present invention, the non-ionic surfactant is selected from the group consisting of
C8 to C15 fatty alcohols, ethoxylated with 3 to 8 moles ethylene oxide;
alkoxylated C8 to C15 fatty alcohols such as
   C8 to C15 fatty alcohols, ethoxylated with 1 to 25 moles ethylene oxide,
   C8 to C15 fatty alcohols, propoxylated with 1 to 15 moles propylene oxide,
   C8 to C15 fatty alcohols, butoxylated with 1 to 10 moles butylene oxide, and combinations thereof;
C8 to C18 sophorolipids;
C8 to C18 rhamnolipids;
C7 to C15 alkyl polyglycosides;
C8 to C15 alkanolamides;
C8 to C15 fatty acid ester alkoxylates;
   and any mixture thereof.

In a more preferred variant of the detergent and cleaning composition according to the present invention, the non-ionic surfactant is selected from the group consisting of
C10 to C18 sophorolipids;
C10 to C18 rhamnolipids;
C8 to C14 alkyl polyglycosides;
Cocamide DEA/MEA;
C10 to C14 fatty acid ester alkoxylates;
   and any mixture thereof.

In a still more preferred variant of the detergent and cleaning composition according to the present invention, the non-ionic surfactant is selected from the group consisting of.
C10 to C18 sophorolipids;
C10 to C18 rhamnolipids;
C8 to C14 alkyl polyglycosides;
   and any mixture thereof.

Said non-ionic detergents are particularly beneficial for preparing “green” detergents and cleaning compositions.

For laundry detergents, dishwashing detergents and hard surface cleaning detergents, the non-ionic surfactant is most preferred selected from the group consisting of C10 to C18 sophorolipids, C10 to C18 rhamnolipids, C8 to C14 alkyl polyglycosides, and any mixture thereof.

In a further preferred variant, for laundry detergents the non-ionic surfactant is selected from the group consisting of C12 to C14 fatty alcohols, ethoxylated with 7 moles ethylene oxide, C13 to C15 fatty alcohols, ethoxylated with 7 moles ethylene oxide, and any mixture thereof.

In a further preferred variant, for hard surface cleaning, such as degreaser, the non-ionic surfactant is selected from the group consisting of C9 to C11 fatty alcohols, ethoxylated with 3 to 8 moles ethylene oxide, C10 fatty alcohol, ethoxylated with 3 to 8 moles ethylene oxide, and any mixture thereof.

In a further preferred variant, for automatic dishwashing, the non-ionic surfactant is selected from the group consisting of C12 to C14 fatty alcohols, ethoxylated with 5 mol ethylene oxide and/or propoxylated with 4 mol propylene oxide.

### Amphoteric/Zwitterionic Surfactants

Suitable amphoteric/zwitterionic surfactants for the detergent and cleaning composition according to the present invention may include any conventional amphoteric/zwitterionic surfactants. Typical examples for amphoteric/zwitterionic surfactants encompass:
C10 to C18 N-(alkyl)-N,N-dimethylamine oxide;
C10 to C18 N-(alkyl)-N,N-bis(2-hydroxyethyl)amine oxide;
C10 to C18 alkyl amido propyl dimethyl amine oxide;
C10 to C18 alkylbetaines;
C10 to C18 alkylamidobetaines;
C10 to C18 sulfobetaines;
   and any mixture of the above surfactants.

In a preferred variant of the detergent and cleaning composition according to the present invention, the amphoteric/zwitterionic surfactant is selected from the group consisting of
C10 to C15 N-(alkyl)-N,N-dimethylamine oxide;
C10 to C15 N-(alkyl)-N,N-bis(2-hydroxyethyl)amine oxide;
C10 to C15 alkyl amido propyl dimethyl amine oxide;
C10 to C15 alkylbetaines;
C10 to C15 alkylamidobetaines;
C10 to C15 sulfobetaines;
   and any mixture of the above surfactants.

In a more preferred variant of the detergent and cleaning composition according to the present invention, the amphoteric/zwitterionic surfactant is selected from the group consisting of
C12 to C14 N-(alkyl)-N,N-dimethylamine oxides;
C12 to C14 N-(alkyl)-N,N-bis(2-hydroxyethyl)amine oxides;
C12 to C14 alkyl amido propyl dimethyl amine oxides;
C12 to C14 alkylbetaines;
C12 to C14 alkylamidobetaines;
C12 to C14 sulfobetaines;
   and any mixture of the above surfactants.

For hand dishwashing detergents, the amphoteric/zwitterionic surfactant is most preferred selected from the group consisting of C12 to C14 alkylbetaines, and any mixture thereof.

In a preferred variant, the detergent and cleaning composition according to the present invention comprises an anionic surfactant or a mixture of two or even more anionic surfactants selected from the group consisting of.
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide; and
their preferred variants as specified before.

In a more preferred variant, the detergent and cleaning composition according to the present invention comprises a cationic surfactant or a mixture of two or even more cationic surfactants selected from the group consisting of
quaternary C8 to C18 alkyl ethanolamines;
quaternary C8 to C18 alkyl ammonium compounds;
C8 to C18 alkyl ammonium methosulfates; and
their preferred variants as specified before.

In a still more preferred variant, the detergent and cleaning composition according to the present invention comprises a non-ionic surfactant or a mixture of two or even more non-ionic surfactants selected from the group consisting of
C8 to C15 fatty alcohols, ethoxylated with 3 to 8 moles ethylene oxide;
alkoxylated C8 to C15 fatty alcohols such as
C8 to C15 fatty alcohols, ethoxylated with 1 to 25 moles ethylene oxide,
C8 to C15 fatty alcohols, propoxylated with 1 to 15 moles propylene oxide,
C8 to C15 fatty alcohols, butoxylated with 1 to 10 moles butylene oxide,
and combinations thereof;
C8 to C18 sophorolipids;
C8 to C18 rhamnolipids;
C7 to C15 alkyl polyglycosides;
C8 to C15 alkanolamides;
C8 to C15 fatty acid ester alkoxylates; and
their preferred variants as specified before.

The above specified surfactants can be used either singular or in the form of mixtures of two, three, or even more surfactants, either from the same surfactant category (anionic, cationic, non-ionic, amphoteric/zwitterionic) or as mixture of surfactants of different surfactant categories.

In a most preferred variant, the detergent and cleaning composition according to the present invention comprises a combined mixture of one or even more of anionic surfactant and one or even more of non-ionic surfactant as specified herein, i.e. a combination of one or more anionic surfactant and one or more non-ionic surfactant.

Alternatively, the detergent and cleaning composition according to the present invention comprises a combined mixture of one or even more of cationic surfactant and one or even more of non-ionic surfactant as specified herein, i.e. a combination of one or more cationic surfactant and one or more non-ionic surfactant.

The above numeric ranges recited with respect of the number of C atoms of the surfactants, given in the form “Cx to Cy” include the values defining the range and include each integer within the defined range, the range C10 to C18 includes C10, C11, C12, C13, C14, C15, C16, C17 and C18. For example, the term “C10 to C18 alkyl” includes decyl, undecyl, dodecyl, tridecyl, tetradecyl, pentadecyl, hexadecyl, heptadecyl and octadecyl. Analogously, the term “C12 to C14 alkyl” includes dodecyl, tridecyl and tetradecyl. For example, the term “C6 to C18 fatty alcohols” includes fatty alcohols having a carbon chain with 6, 7, 8, 9, 10, 11, 12, 13, 14, 15, 16, 17, or 18 carbon atoms. Analogously, the term “C6 to C18 rhamnolipids” includes structures comprising a rhamnolipid and a carbon chain having 6, 7, 8, 9, 10, 11, 12, 13, 14, 15, 16, 17 or 18 carbon atoms.

### Enzyme or Enzyme Formulation/Component (d1, d2, d3, d)

The detergent and cleaning composition according to the present invention comprises optionally at least one enzyme or an enzyme formulation, comprising at least one enzyme, as component (d1, d2, d3, d). The enzyme or enzyme mixture provide for cleaning performance, by removing stain and/or soil, and/or fabric care benefits.

Enzymes are known as effective chemicals for use with detergents and other cleaning agents to break down soils. Enzymes break down soils, make them more soluble, and enable surfactants to remove them from a surface to provide enhanced cleaning of a substrate. Specifically, enzymes can provide desirable activity for removal of, for example, protein-based, carbohydrate-based, or triglyceride-based stains from substrates. In addition, enzymes also help to improve wash results at lower temperatures. As a result, enzymes have been used for various cleaning applications in order to digest or degrade soils such as grease, oils (e.g. vegetable oils or animal fat), protein, carbohydrate, or the like. For example, enzymes may be added as a component of a composition for laundry, textiles, ware washing, cleaning-in-place, cleaning drains, floors, carpets, medical or dental instruments, meat cutting tools, hard surfaces, personal care, or the like.

Enzymes suitable for the detergents and cleaning compositions can act by degrading or altering one or more types of soil residues encountered on an instrument or device thus removing the soil or making the soil more removable by a surfactant or other component of the cleaning composition. Both degradation and alteration of soil residues can improve detergency by reducing the physicochemical forces that bind the soil to the instrument or device being cleaned, e.g., the soil becomes more water soluble. For example, one or more proteases can cleave complex, macro molecular protein structures present in soil residues into simpler short chain molecules which are, of themselves, more readily desorbed from surfaces, solubilized or otherwise more easily removed by detersive solutions containing said proteases.

Detersive enzymes according to the present invention have a cleaning, destaining, desoiling, or otherwise beneficial effect as a component of a detergent and cleaning composition for instruments, devices, or equipment, such as medical or dental instruments, devices, or equipment; or for laundry, textiles, ware-washing, cleaning-in-place, drains, carpets, meat cutting tools, hard surfaces, personal care, or the like.

Enzymes that can be used in the detergent and cleaning composition according to the present invention include enzymes that provide desirable activity for removal of protein-based, carbohydrate-based, or lipid-based (fat or soil-based) stains and/or soils from substrates; for cleaning, destaining, desoiling, and sanitizing presoaks, such as presoaks for medical and dental instruments, devices, and equipment; presoaks for flatware, cooking ware, and table ware; or presoaks for meat cutting equipment; for machine ware washing; for laundry and textile cleaning and destaining; for carpet cleaning and destaining; for cleaning-in-place (CIP) and destaining-in-place; for cleaning and destaining food processing surfaces and equipment; for drain cleaning; presoaks for cleaning; and the like.

Suitable enzymes used according to the present invention are selected from the group consisting of proteases, amylases, lipases, cellulases, cutinases, gluconases, peroxidases, pectinases, mannanases, esterases, hemicellulases, xylanases, phospholipases, pectate lyases, keratinases, reductases, nucleases (including Dnase and/or Rnase), phenoloxidases, lipoxygenases, ligninases, pullulanases, tannases, pentosanases, malanases, β-glucanases, arabinosidases, hyaluronidases, chondroitinases, oxidoreductases, and any mixture thereof.

More preferred, the enzyme in the detergents and cleaning compositions according to the present invention is selected from the group consisting of proteases, amylases, lipases, cellulases, mannanases, pectate lyases, and any mixture thereof.

The enzymes used according to the present invention are of any suitable origin, such as vegetable, animal, bacterial, fungal or yeast origin.

Proteases: Any protease or mixture of proteases, from any source, can be used in the detergents and cleaning compositions, provided that the selected enzyme is stable in the desired pH range (between about 6 and about 9). For example, the protease enzymes can be derived from a plant, an animal, or a microorganism such as a yeast, a mold, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant). Exemplary proteases are commercially available under the following trade names Alcalase®, Blaze®, Savinase®, Esperase®, Progress UNO™, Liquanase® and Pristine®, each available from Novozymes; and Preferenz® P and Excellenz® P, each available from DUPONT/IFF.

Amylases: Any amylase or mixture of amylases, from any source, can be used in the detergents and cleaning compositions, provided that the selected enzyme is stable in the desired pH range (between about 6 and about 9). For example, the amylase enzymes can be derived from a plant, an animal, or a microorganism such as a yeast, a mould, or a bacterium. Preferred amylase enzymes include, but are not limited to, those derived from a Bacillus, such as B. licheniformis, B. amyloliquefaciens, B. subtilis, or B. stearothermophilus. Amylase enzymes derived from B. subtilis are most preferred. The amylase can be purified or a component of a microbial extract, and either wild type or variant (either chemical or recombinant). Preferred amylases are commercially available under the trade names Stainzyme® and Amplify®, each available from Novozymes; and Preferenz® S, available from DUPONT/IFF.

Lipases: Any lipase or mixture of lipases, from any source, can be used in the detergents and cleaning compositions, provided that the selected enzyme is stable in the desired pH range (between about 6 and about 9). For example, the lipase enzymes can be derived from a plant, an animal, or a microorganism such as a fungus or a bacterium. Preferred protease enzymes include, but are not limited to, the enzymes derived from a Pseudomonas, such as Pseudomonas stutzeri ATCC 19.154, or from a Humicola, such as Humicola lanuginosa (typically produced recombinantly in Aspergillus oryzae). The lipase can be purified or a component of a microbial extract, and either wild type or variant (either chemical or recombinant). Preferred lipases are commercially available under the trade names Lipex®, available from Novozymes, and Preferenz® L, available from DUPONT/IFF.

Cellulases: Any cellulase or mixture of cellulases, from any source, can be used in the detergents and cleaning compositions, provided that the selected enzyme is stable in the desired pH range (between about 6 and about 9). For example, the cellulase enzymes can be derived from a plant, an animal, or a microorganism such as a fungus or a bacterium. Preferred cellulase enzymes include, but are not limited to, those derived from Humicola insolens, Humicola strain DSM1800, or a cellulase 212-producing fungus belonging to the genus Aeromonas and those extracted from the hepatopancreas of a marine mollusk, Dolabella Auricula Solander. The cellulase can be purified or a component of a microbial extract, and either wild type or variant (either chemical or recombinant). Preferred cellulases are commercially available under the trade names Celluclean® and Carezyme®, each available from Novozymes; and Revitalenz®, available from DUPONT/IFF.

Preferred enzyme selections depend upon the conditions of final utility, including the physical product form, use pH, use temperature, and soil types to be degraded or altered and are influenced by factors such as pH-activity and/or stability optima, thermostability, and stability to active detergents, builders and the like. The enzyme can be chosen to provide optimum activity and stability for any given set of utility conditions. In this respect, bacterial or fungal enzymes are preferred.

Protease enzymes, amylase enzymes and lipase enzymes are the most used enzymes in detergents and cleaning compositions. The protease enzymes are particularly advantageous for cleaning soils containing protein, e.g. egg, milk, meat residue, or the like. The amylase enzymes are particularly advantageous for removing starch-based soils, such as pasta and rice. The lipase enzymes are particularly advantageous for cleaning soils including fat/grease.

As one skilled in the art shall ascertain, enzymes are designed to work with specific types of soils. For example, according to an embodiment of the invention, ware wash applications may use a protease enzyme as it is effective at the high temperatures of the ware wash machines and is effective in reducing protein-based soils. Protease enzymes are particularly advantageous for cleaning soils containing protein, such as blood, cutaneous scales, mucus, grass, food (e.g. egg, milk, spinach, meat residue, tomato sauce), or the like.

According to the present invention, the enzyme containing detergent and cleaning composition may be varied based on the particular cleaning application and the types of soils in need of cleaning. For example, the temperature of a particular cleaning application will impact the enzymes selected for an enzyme composition according to the invention. Ware wash applications, for example, clean substrates at temperatures in excess of approximately 60° C., or in excess of approximately 70° C., or between approximately 65° C. to 80° C., and enzymes such as proteases are desirable due to their ability to retain enzymatic performance at such elevated temperatures. Laundry applications, for example, clean laundry at temperatures in excess of approximately 40° C., or in excess of approximately 50° C., or between approximately 65° C. to 90° C., and enzymes such as proteases are desirable due to their ability to retain enzymatic performance at such elevated temperatures.

Preferably, the at least one enzyme in the detergent and cleaning composition is selected from the group consisting of a protease, an amylase, a lipase, a cellulase, a gluconase, a peroxidase, or a mixture thereof.

In some variants, the enzyme in the detergent and cleaning composition is a protease, an amylase, a lipase, a cellulase, a gluconase, a peroxidase, a mannanase, or any mixture thereof.

Preferably the enzyme in the detergent and cleaning composition is a mixture of protease, an amylase, a lipase, a cellulase and/or pectate lyase.

Preferred detersive enzymes in the detergent and cleaning composition include a hydrolase such as a protease, an amylase, a lipase, or a combination thereof.

Preferably, the enzyme in the detergent and cleaning composition is a protease, amylase, lipase, cellulose, peroxidase, gluconase, or any mixture thereof.

In a still preferred variant, the enzyme in the detergent and cleaning composition disclosed here is a protease, amylase, lipase, or any mixture thereof.

Still more preferred, the enzyme in the detergent and cleaning composition is a protease, an amylase, or a mixture thereof.

Still more preferred, the enzyme in the detergent and cleaning composition is a protease, a lipase, or a mixture thereof.

Still more preferred, the enzyme in the detergent and cleaning composition is selected from an amylase, a lipase, or a mixture thereof.

In some other embodiments, the enzyme in the detergent and cleaning composition is a protease.

In yet some other variant, the enzyme in the detergent and cleaning composition is an amylase.

In yet some other variant, the enzyme in the detergent and cleaning composition is a lipase.

In yet some other variant, the enzyme in the detergent and cleaning composition is a cellulase.

Preferred enzymes in detergents and cleaning compositions according to the present invention for cleaning medical or dental devices or instruments include a protease, an amylase, a cellulase, a lipase, or a combination thereof.

Preferred enzymes in detergent and compositions according to the present invention for laundry or textiles include a protease, a cellulase, a lipase, a peroxidase, or a combination thereof.

Preferred enzymes in detergent and compositions for carpets include a protease, an amylase, or a combination thereof.

For a stain remover, the enzymes are preferably selected from the group consisting of protease, amylase, lipase, mannanase, pectate lyase, and any mixture thereof.

For a fabric softener, the enzymes are preferably cellulases.

In order to increase the bleaching effect, oxidoreductases are optionally added to the detergent and cleaning composition according to the present invention.

The oxidoreductases are selected from the group consisting of oxidases, oxygenases, catalases, peroxidases, such as halo-, chloro-, bromo-, lignin-, glucose- or manganese-peroxidases, dioxygenases or laccases, such as phenoloxidases and polyphenoloxidases, and any mixture thereof.

Commercial enzymes are obtainable in liquid or dried form (i.e. puck, powder, etc.), are sold as raw aqueous solutions or in assorted purified, processed and compounded forms established in the prior art, and include about 0.1% to about 80% by weight active enzyme generally in combination with stabilizers, buffers, cofactors, impurities and inert vehicles. The actual active enzyme content depends upon the method of manufacture and is not critical; assuming the detergent and cleaning composition has the desired enzymatic performance.

This includes for example the solid enzyme preparations obtained by granulation, extrusion or lyophilization or, particularly in the case of liquid or gel-like agents, solutions of the enzymes, advantageously as concentrated as possible, low in water and/or with added stabilizers. Alternatively, the enzymes can be encapsulated both for the solid and for the liquid administration form, for example by spray drying or extrusion of the enzyme solution together with a preferably natural polymer, or in the form of capsules, for example those in which the enzymes are enclosed, such as in a solidified gel, or in those of the core-shell type, in which an enzyme-containing core is coated with a protective layer that is impermeable to water, air, and/or chemicals. Further active substances, for example stabilizers, emulsifiers, pigments, bleaches or dyes, can additionally be applied in superimposed layers. Such capsules are applied using methods known per se, for example by vibratory or roll granulation or in fluidized bed processes. Advantageously, such granulates are low in dust, for example as a result of the application of polymeric film formers and are storage-stable on account of the coating. Furthermore, it is possible to package two or more enzymes together so that a single granulate exhibits multiple enzyme performance.

In a preferred variant according to the present invention, the enzyme is added to the detergent and cleaning composition as a single enzyme.

In some other variants, the enzyme added to the detergent and cleaning composition is preferably an enzyme cocktail of two, three, four or even more different enzymes. Typically, for laundry detergents an enzyme cocktail contains from two (preferably protease and amylase) to six enzymes.

In a more preferred variant, the at least one enzyme is added to the detergent composition according to the present invention as enzyme formulation comprising an enzyme or a cocktail of different enzymes in mixture with one or more stabilizer(s), preferably with one or more enzyme stabilizers, and optionally buffers, additives, and the like.

Preferably, an enzyme stabilizer is added to the enzyme formulation for stabilizing the enzyme in the detergent and cleaning composition from loss of performance (i.e. retain enzymatic activity or enzymatic retention). The enzymes are stabilized by the enzyme stabilizer through a physical protection by means of a protective layer.

The enzyme formulation may vary based upon the particular enzymes employed.

Negatively charged anionic surfactants trap Ca and/or Mg ions from the wash liquor and form a complex. This complex formation leads to a reduction in washing performance. To prevent this complex formation, chelating agents such as EDTA, HEDP etc. are added to the detergent and cleaning composition. However, these chelating agents do not only complex the Ca ions and/or Mg ions from the wash liquor, but also trap the Ca ions and Mg ions from the surface of the enzymes, which in turn leads to a denaturation. Thus, the enzymes lose their active form, which in turn results in a reduction of the enzymatic activity. Thus, enzyme stabilizers are added to the detergent and cleaning composition, which protect the enzymes. Accordingly, the chelating agent can only capture Ca ions and/or Mg ions from the wash liquor but can no longer trap Ca ions and/or Mg ions from the surface of the enzyme. Thus, the enzyme activity can be maintained by the addition of enzyme stabiliser.

The at least one enzyme employed herein is stabilized by the presence of water-soluble sources of calcium and/or magnesium ions in the finished detergents which provide such ions to the enzymes. Calcium ions are generally somewhat more effective than magnesium ions and are preferred herein if only one type of cation is being used.

Typical detergents, especially liquids, comprise from 1 to 30, preferably from 2 to 20, more preferably from 5 to 15, and most preferably from 8 to 12, millimoles of calcium ion per litre of finished composition.

It is to be understood that the foregoing levels of calcium and/or magnesium ions are sufficient to provide enzyme stability. More calcium and/or magnesium ions can be added to the compositions to provide an additional measure of grease removal performance. Accordingly, as a general proposition the compositions herein will typically comprise from 0.01% to 2% by weight of a water-soluble source of calcium or magnesium ions, or both. The amount can vary, of course, with the amount and type of enzyme employed in the composition.

Additional enzyme stability can be provided by the presence of various other art-disclosed stabilizers, especially borate species.

One group of stabilizers are reversible protease inhibitors. Benzamidine hydrochloride, borax, boric acids, boronic acids or their salts or esters are frequently used for this purpose, including in particular derivatives having aromatic groups. Typically, such enzyme stabilizers are used at levels in the compositions from 0.05% to 5% by weight, more preferably from 0.075% to 3% by weight of boric acid or other borate compound capable of forming boric acid in the composition (calculated on the basis of boric acid). Boric acid is preferred, although other compounds such as boric oxide, borax and other alkali metal borates (e.g., sodium ortho-, meta- and pyroborate, and sodium pentaborate) are suitable. Substituted boric acids (e.g., phenylboronic acid, butane boronic acid, and p-bromo phenylboronic acid) can also be used in place of boric acid.

Also peptide aldehydes, i.e. oligopeptides having a reduced C-terminus, in particular those from 2 to 50 monomers, or hydrogen sulfite adducts thereof are used for this purpose. The peptidic reversible protease inhibitors include, but are not limited to, ovomucoid and leupeptin. Specific, reversible peptide inhibitors for the protease subtilisin and fusion proteins from proteases and specific peptide inhibitors are also suitable for this purpose.

Further enzyme stabilizers are amino alcohols such as mono-, di-, triethanol- and propanolamine and mixtures thereof, aliphatic carboxylic acids up to C12, such as succinic acid, other dicarboxylic acids or salts of the acids mentioned.

End-capped fatty acid amide alkoxylates are also suitable for this purpose.

Preferably, the enzyme stabilizer in the enzyme formulation is selected from the group consisting of polyols such as glycol, such as monopropylene glycol, glycerine, mannitol, isomaltol, sorbitol, xylitol, threitol, erythritol, arabitol; amino alcohols such as mono-, di-, triethanolamine and -propanolamine; aliphatic carboxylic acids up to C12, such as succinic acid and salts thereof; dicarboxylic acids and salts thereof; end-capped fatty acid amide alkoxylates; salts, preferably calcium and magnesium salts, such as calcium chloride, calcium formate, magnesium chloride, magnesium formate; reversible enzyme inhibitors such as borate-containing compositions, such as 4-FBPA, boron-free inhibitors, such as disubstituted alaninamide, sodium formate; and any mixture thereof.

Most preferred, the enzyme stabilizer in the detergent and cleaning composition according to the present invention is selected from the group consisting of calcium chloride, calcium formate, magnesium chloride, magnesium formate, and any mixture thereof.

Furthermore, with the addition of said enzyme stabilizer, it can be prevented that the negatively charged anionic surfactants form a complex with Ca ions and/or Mg ions from the washing liquid thereby reducing or losing their washing performance.

The enzyme stabilizer or the enzyme formulation including the enzyme stabilizer is added to the detergent and cleaning composition in such amounts, that the enzyme stabilizer is present in the detergent and cleaning composition in an amount of 0.0001 to 5% by weight, based on the total weight of the detergent and cleaning composition. Preferably, the enzyme stabilizer is present in an amount of 0.001 to 4% by weight, based on the total weight of the degreasing detergent and cleaning composition. Most preferred, the detergent and cleaning composition includes the enzyme stabilizer in an amount of 0.01 to 3% by weight, based on the total weight of the composition.

Advantageously, organic, particularly preferably aromatic, compounds interacting with the enzymes are also added in order to enhance the activity of the oxidoreductases concerned (enhancers) or to ensure the flow of electrons in the case of strongly differing redox potentials between the oxidizing enzymes and the contaminants (mediators).

Alternatively, and still more preferred, the at least one enzyme is added to the detergent and cleaning composition according to the present invention as enzyme formulation in mixture with a specific type of a bleach boosting agent (b), such as alkanediols having a carbon chain of 5 to 11 carbon atoms as specified herein, glyceryl caprylate, 4-hydroxyacetophenone, tropolone, or a mixture of said bleach boosting agents, and optionally buffers, additives, and the like. Preferred combinations of an enzyme and a specific type of a bleach boosting agent (b), such as alkanediols having a carbon chain from 5 to 11 carbon atoms, glyceryl caprylate, 4-hydroxyacetophenone, tropolone, or a mixture of said bleach boosting agents, are described in detail below.

In a further preferred variant, the at least one enzyme is added to the detergent and cleaning composition according to the present invention as enzyme formulation in mixture with an enzyme stabilizer and with a specific type of bleach boosting agent (b), such as alkanediols having a carbon chain of 5 to 11 carbon atoms, glyceryl caprylate, 4-hydroxyacetophenone, tropolone, or a mixture of said bleach boosting agents, and optionally buffers, and the like.

Surprisingly, it turned out that in such formulations the addition of a specific type of bleach boosting agent (b), such as alkanediols as defined herein, glyceryl caprylate, 4-hydroxyacetophenone, tropolone, or a mixture of said bleach boosting agents, also enhances or boosts the enzyme stabilizing effect of the enzyme stabilizers as specified above.

Unexpectedly, the combination of a specific type of bleach boosting agent (b), such as alkanediols as defined herein, glyceryl caprylate, 4-hydroxyacetophenone, tropolone, or a mixture of said bleach boosting agents, and an enzyme stabilizer results in an enhanced enzyme stabilizing effect in the detergent and cleaning composition comprising an enzyme, in comparison to the use of the single enzyme stabilizer without the use of such bleach boosting agents.

A particular boosting effect can be observed, for a combined use of a bleach boosting agent (b), such as alkanediols having a carbon chain of 5 to 11 carbon atoms, glyceryl caprylate, 4-hydroxyacetophenone, tropolone, or a mixture of said bleach boosting agents and an enzyme stabilizer comprising calcium chloride, calcium formate, magnesium chloride, magnesium formate, and any mixture thereof.

For the detergent and cleaning composition according to the present invention, the list of the bleach boosting agents (b) specified herein can be arbitrary combined with the list of the enzyme stabilizers.

A remarkable enzyme stabilizing enhancing effect is observed, when one of the following bleach boosting agents (b) are used in combination with one or more of the above specified enzyme stabilizers, preferably calcium chloride, calcium formate, magnesium chloride, magnesium formate, and any mixture thereof:
1,2-pentanediol;
1,2-hexanediol;
1,2-heptanediol;
1,2-octanediol;
1,2-nonanediol;
1,2-decanediol;
1,2-undecanediol;
glyceryl caprylate;
4-hydroxyacetophenone;
tropolone;
a mixture comprising 1,2-hexanediol and 1,2-octanediol;
a mixture comprising 1,2-hexanediol and 1,2-octanediol and tropolone; and
a mixture comprising 4-hydroxyacetophenone and 1,2-octanediol.

Hence, the combined addition of a bleach boosting agent as defined herein and an enzyme stabilizer results in an improved enzyme stability compared to the enzyme stabilisation effect when only the enzyme stabilizer is used. The detergent and cleaning compositions comprising said mixtures show improved cleaning properties compared to a detergent and cleaning composition without the addition of such mixtures.

### Bleach Catalyst/Bleaching Stabilizer

In addition to the combination of ingredients to be used according to the present invention, the detergents and cleaning compositions of the present invention can further include one or more substances that catalyze or boost the bleaching agent(s) contained therein, so-called bleach catalysts. The bleach catalysts show high potential as enhancers for peroxide bleaching.

The bleach catalysts are bleach-catalyzing transition metal complexes and are preferably selected from the cobalt, iron, copper, titanium, vanadium, manganese and ruthenium complexes. Suitable ligands in the transition metal complexes are both inorganic and organic compounds, which include, in addition to carboxylates, in particular compounds having primary, secondary and/or tertiary amine and/or alcohol functions, such as pyridine, pyridazine, pyrimidine, pyrazine, imidazole, pyrazole, triazole, 2,2′-bispyridylamine, tris-(2-pyridylmethyl)amine, 1,4,7-triazacyclononane, 1,4,7-trimethyl-1,4,7-triazacyclononane, 1,5,9-trimethyl-1,5,9-triazacyclododecane, (bis-((1-methylimidazole-2-yl)-methyl))-(2-pyridylmethyl)-amine, N,N′-(bis-(1-methylimidazole-2-yl)-methyl)-ethylenediamine, N-bis-(2-benzimidazolylmethyl)aminoethanol, 2,6-bis-(bis-(2-benzimidazolylmethyl)aminomethyl)-4-methylphenol, N,N,N′,N′-tetrakis-(2-benzimidazolylmethyl)-2-hydroxy-1,3-diaminopropane, 2,6-bis-(bis-(2-pyridylmethyl)aminomethyl)-4-methylphenol, 1,3-bis-(bis-(2-benzimidazolylmethyl)aminomethyl)benzene, sorbitol, mannitol, erythritol, adonitol, inositol, lactose, and optionally substituted salens, porphins and porphyrins. The inorganic neutral ligands include in particular ammonia and water. If not all coordination sites of the transition metal central atom are occupied by neutral ligands, the complex contains further, preferably anionic, ligands, of these in particular mono- or bidentate ligands. These include in particular the halides such as fluoride, chloride, bromide and iodide, and the (NO2)- group, i.e., a nitro ligand or a nitrito ligand. The (NO2)- group may also be chelated to a transition metal or it may asymmetrically bridge or η1-O-bridge two transition metal atoms. In addition to the ligands mentioned, the transition metal complexes to be used in the activator system according to the invention may carry further, generally more simple, ligands, in particular mono- or polyvalent anion ligands. For example, nitrate, acetate, trifluoroacetate, formate, carbonate, citrate, perchlorate, and complex anions such as hexafluorophosphate are suitable. The anion ligands are intended to ensure charge balance between the transition metal central atom and the ligand system. It is also possible for oxo ligands, peroxo ligands and imino ligands to be present. In particular, such ligands can also have a bridging effect, such that polynuclear complexes are produced. In the case of bridged, binuclear complexes, the two metal atoms in the complex do not need to be the same. The use of binuclear complexes in which the two transitionmetal central atoms have different oxidation numbers is also possible. If anion ligands are absent or the presence of anion ligands does not result in charge balance in the complex, anionic counterions which neutralize the cationic transition metal complex are present in the transition metal complex compounds. These anionic counterions include in particular nitrate, hydroxide, hexafluorophosphate, sulfate, chlorate, perchlorate, the halides such as chloride or the anions of carboxylic acids such as formate, acetate, benzoate, citrate or oxalate. Examples of such additional transition metal complex compounds are Mn(IV)2(μ-O)3(1,4,7-trimethyl-1,4,7-triazacyclononane)-di-hexafluorophosphate, [N,N′-bis [(2-hydroxy-5-vinylphenyl)-methylene]-1,2-diamino-cyclohexane]-manganese-(111)-chloride, [N,N′-bis [(2-hydroxy-5-nitrophenyl)-methylene]-1,2-diamino-cyclohexane]-manganese-(111)-acetate, [N,N′-bis [(2-hydroxyphenyl)-methylene]-1,2-phenylendiamine]-manganese-(111)-acetate, [N,N′-bis [(2-hydroxyphenyl)-methylene]-1,2-diaminocyclohexane]-manganese-(111)-chloride, [N,N′-bis [(2-hydroxyphenyl)-methylene]-1,2-diaminoethane]-manganese-(111)-chloride, [N,N′-bis [(2-hydroxy-5-sulfonatophenyl)-methylene]-1,2-diaminoethane]-manganese-(111)-chloride, manganese oxalate, nitropentaamminecobalt (111) chloride, nitritopentaamminecobalt (111) chloride, hexaamminecobalt (111) chloride, chloropentaamminecobalt (111) chloride and the peroxo complex [(NH3)5Co—O—O—Co(NH3)5]Cl4.

With particular preference complexes of manganese in the oxidation state II, III, IV or IV are used, preferably one or more macrocyclic(s) ligand(s) with the N, NR, PR, O and/or S donor functions included. Ligands which have nitrogen donor functions are preferably used. It is particularly preferred to use bleaching catalyst(s) in the agents according to the invention which contain, as macromolecular ligands, 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me-TACN).

In a preferred variant, the detergent and cleaning composition according to the present invention comprises a bleaching catalyst, wherein the bleaching catalyst contains as macromolecular ligand
1,4,7-trimethyl-1,4,7-triazacyclononane (Me-TACN), or
1,4,7-triazacyclononane (TACN), or
1,5,9-trimethyl-1,5,9-triazacyclododecane (Me-TACD), or
2-methyl-1,4,7-trimethyl-1,4,7-triazacyclononane (Me/Me-TACN), or
2-methyl-1,4,7-triazacyclononane (Me/TACN), or
   wherein Me stands for Mn, Fe, Co, Ru or Mo, and any mixture thereof.

Suitable examples of manganese complexes are [Mnm2(-0)i(-OAc)2(TACN)2](ClO4)2, [Mη′″Mη′v(μ-0)2(μ-OAc)1(TACN)2](BPh4)2, [MnIv4(-0)6(TACN)4](ClO4)4, [Mnm2(-0)i(-OAc)2(Me-TACN)2](ClO4)2, [MηMIMηₗv(μ-0)ₗ(μ-OAü)2(Mβ-TAON)2](OIθ4)3, [MnIv2(-0)3(Me-TACN)2](PF6)2, and [Mη′v2(μ-0)3(Me/Me-TACN)2](PF6)2(OAc=OC(O)CH3), and any mixture thereof. Such manganese-based catalysts are well known in the art.

The abovementioned bleach catalysts significantly improve the bleaching performance when used in combination with a bleaching agent.

The detergents and cleaning compositions, in particular dishwashing detergents, preferably contain a bleach catalyst selected from the group consisting of the bleach-boosting transition metal salts and transition metal complexes, preferably from the group of complexes of manganese with 1,4,7-trimethyl-1,4,7-triazacyclononane (Me-TACN) or 1,2,4,7-tetramethyl-1,4,7-triazacyclononane (Me/Me-TACN).

The afore-mentioned bleach catalyzing transition metal complexes, in particular with the central atoms Mn and Co, are preferably used in an amount of up to 1% by weight, in particular from 0.001 to 0.1% by weight and particularly preferably from 0.01 to 0.05% by weight. %, based on the total weight of the composition used. In special cases, however, more bleach catalyst can also be used.

In order to stabilize the bleaching process, one or more bleaching stabilizers are added to the detergent and cleaning composition according to the present invention, preferably to the liquid detergent and cleaning composition. The bleaching stabilizers control the perhydroxyl ion (HO2-) and prevent the rapid breakdown of the perhydroxyl ion, i.e. they delay the generation of bleach inactive molecular oxygen and strength loss of hydrogen peroxide in the washing and cleaning process. Thus, bleaching stabilizers are utilized to guarantee a fairly consistent availability of the perhydroxyl ion for the bleaching activity.

Bleaching stabilizers are organic substances, that sequester and complex, and thus, inactivate metallic impurities which otherwise causes catalytic decomposition of hydrogen peroxide, the most being calcium, magnesium and iron.

Bleaching stabilizers can be present in the acid or salt form including alkali metal, ammonium, and substituted ammonium salts thereof, and mixtures thereof.

Preferably the bleaching stabilizer is selected from the group consisting of amino carboxylates, phosphonates or mixtures thereof.

Useful amino carboxylate bleaching stabilizers include, but are not limited to, the following: N-(1,2-dicarboxy-ethyl)-D, L-aspartic acid (IDS), N-(2-hydroxyethyl)iminodiacetic acid (EDG), aspartic acid-N-monoacetic acid (ASMA), aspartic acid-N,N-diacetic acid (ASDA), aspartic acid-N-mono-propionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), a-alanine-N,N-diacetic acid (a-ALDA), serine-N,N-diacetic acid (SEDA), isoserine-N,N-diacetic acid (ISDA), phenylalanine-N,N-diacetic acid (PHDA), anthranilic acid-N,N-diacetic acid (AND A), sulfanilic acid-N,N-diacetic acid (SLDA), taurine-N,N-diacetic acid (TUDA), sulfomethyl-N,N-diacetic acid (SMDA), N-(hydroxyethyl)-ethylidenediaminetriacetate (HEDTA), diethanolglycine (DEG), aminotris(methylenephosphonic acid) (ATMP).

Preferred bleaching stabilizers may contain an amino group and may be, e.g., an amino-polycarboxylate or a phosphonate. It may be a monomeric molecule comprising one, two or three amino groups (typically secondary or tertiary amino groups), and it may contain two, three, four or five carboxyl groups or even more carboxyl groups. The bleaching stabilizers may be phosphorus containing or without phosphorus. Suitable bleaching stabilizers includes those based on carboxylate groups includes EDTA (ethylene diamine tetraacetate), NTA (2,2′,2″-nitrilotriacetate), citrate, 2-hydroxypropan-1,2,3-tricarboxylate, DTPA (diethylenetriaminepentaacetic acid), MGDA (methylglycinediacetic acid OT N,N′-bis(carboxymethyl) alanine), EGTA (ethylene glycol tetraacetic acid), EDDS (ethylenediamine-N,W-disuccinic acid), GLDA (L-Glutamic acid, N,N-diacetic acid), The detergent and cleaning composition preferably may also include other polycarboxylates such as PAA [poly(acrylic acid)], PAA/PMA [copoly(acrylic acid/maleic acid)], or mixtures thereof.

Another group of preferred bleaching agents includes phosphonates. Aminoalkane and/or hydroxyalkane phosphonates are preferably used as phosphonates. Suitable examples of these phosphonate bleaching agents includes HEDP (I-hydroxyethylidene-1,1-diphosphonic acid), EDTMP [ethylenediamine tetra(methylene phosphonic acid], EDTMPA (ethylenediaminetetramethylene-tetraphosphonic acid), DTPMP (diethylenetriamine penta (methylene phosphonic acid), DTMPA (diethylenetriaminepenta(methylenephosphonic acid)) nitrilotris(methylenephosphonic acid) (NTMP), 2-phosphonobutane-1,2,4-tricarboxylic acid (PBTC), ethylenediamine tetramethylene phosphonate (EDTMP), and the higher homologs thereof. Among the hydroxyalkane phosphonates, 1-hydroxyethane-1,1-diphosphonate (HEDP) is of particular importance. The bleaching stabilizers may contain nitrogen such as in EDTA, NTA, DTPA, PDTA, GLDA, MGDA, EDDS, EDTMP, EDTMPA, and DTPMP or ASMA, ASDA, ASMP, IDA, SMAS, SEAS, SMGL, SEGL, MIDA, a-ALDA, SEDA, ISDA, PHDA, ANDA, SLDA, TUDA, SMDA, HEDTA, DEG, ATMP, or mixtures thereof.

Particularly preferred bleaching stabilizers include but are not limited to the following: ethylene-diamine-tetra-acetic acid (EDTA), diethylene triamine pentamethylene phosphonic acid (DTMPA, DTPMP), hydroxy-ethane diphosphonic acid (HEDP), ethylenediamine N,N-disuccinic acid (EDDS), methyl glycine di-acetic acid (MGDA), diethylene triamine penta acetic acid (DTPA), propylene diamine tetraacetic acid (PDTA), 2-hydroxypyridine-N-oxide (HPNO), methyl glycine diacetic acid (MGDA), glutamic acid N,N-diacetic acid (N,N-dicarboxymethyl glutamic acid tetrasodium salt (GLDA) and nitrilotriacetic acid (NTA) or mixtures thereof. The bleaching agent may be present in their acid form or a salt, preferably the bleaching stabilizer may be present as a sodium, ammonium or potassium salt.

Especially preferred bleaching stabilizer includes diethylenetriamine pentacetic acid (DTPA), ethylenediamine-N,N′-disuccinic acid (EDDS) and 1,1-hydroxyethane diphosphonic acid (HEDP) or the alkali metal, potassium, alkaline earth metal, ammonium or substituted ammonium salts thereof, or mixtures thereof. The most preferred bleaching stabilizer is a phosphonate. The phosphonate bleaching stabilizer includes HEDP in its acid form or salt form with alkali metal, potassium, alkaline earth metal, ammonium or substituted ammonium.

Most preferred are the following bleaching stabilizers: GLDA, MGDA, citrate, HEDP, and any mixture thereof.

In the detergents and cleaning compositions according to the present invention, the bleaching stabilizer is typically present in an amount from 0.1 to 10.0% by weight, based on the total weight of the compositions, preferably from 0.1 to 5.0% by weight, and more preferably from 0.1 to 3.0% by weight.

Preferably the detergents and cleaning compositions according to the present invention comprises at least 0.2% by weight bleaching stabilizer based on the total weight of the composition, still preferably at least 0.3% by weight, still preferably at least 0.5% by weight, most preferably at least 0.6% by weight, but typically not more than 3% by weight, still preferably not more than 2% by weight, most preferably not more than 1% by weight of the bleaching stabilizer.

However, in some automatic dish washing gels, the amount of GLDA can be from 30 to 40% by weight, based on the total weight of the composition.

### Optional Further Components

Within the context of the present invention, it is also possible, and in some cases advantageous, to combine the detergents and cleaning compositions according to the present invention with other active substances and/or additives, depending on the purpose of the composition, in order to obtain a ready-for-use composition or formulation. The active ingredients provide desired properties and functionalities to the detergents and cleaning compositions according to the present invention. The term “functional ingredient” or “functional additive” includes an ingredient that provides a beneficial property in a particular use. Some particular examples of functional ingredients are discussed in more detail below. However, a broad variety of other functional ingredients may also be used.

The detergents and cleaning compositions according to the present invention may comprise any of the ingredients customarily found in such compositions, such as, for example organic solvents, builders, and additional auxiliaries such as soil repellents, thickeners, colorants and fragrances or the like.

Preferably, the detergent and cleaning composition according to the present invention can advantageously be combined or varied with at least one active substance and/or at least one (functional) additive, such as for example solvents, builders, soil release agents, dispersing agents, foam inhibitors, sequestrant agents, chelating agents, anti-redeposition agents, dye transfer inhibition/colour protection agents, dye scavengers, dyes, greying inhibitors, optical brighteners, ultraviolet light absorbers, thickeners or rheology modifiers, hydrotropes, solubility modifiers, pH-adjusting agents, buffers, solvents, anti-static agents, anti-wrinkling agents, antimicrobial agents, odor removal/odor capturing agents, ultraviolet light protection agents, fragrances, sanitizing agents, disinfecting agents, water repellency agents, insect repellency agents, anti-pilling agents, souring agents, mildew removing agents, allergicide agents, and any mixture thereof.

The detergents and cleaning compositions according to the present invention can further include one or more antimicrobial agents.

The term “antimicrobial component” in the context of the present invention refers to a group of substances, in particular to agents that kills microorganisms, such as bacteria, yeast and/or fungi, or stops or inhibits their growth, which prevents products from microbial contamination. Without the addition of such agents the products spoil, which may manifest changes in smell, discoloration, mould growth, gas formation, the separation of emulsions or changes in viscosity, rendering the product unacceptable to the consumer.

Suitable antimicrobial agents include, but are not limited to, the antimicrobial classes such as phenolics, quaternary ammonium compounds, metal derivatives, amines, alkanol amines, nitro derivatives, analides, organosulfur and sulfur-nitrogen compounds and miscellaneous compounds. Exemplary phenolic agents include pentachlorophenol, orthophenylphenol, phenoxyethanol. Exemplary quaternary antimicrobial agents include benzalkonium chloride, cetylpyridiniumchloride, amine and nitro containing antimicrobial compositions such as hexahydro-1,3,5-tris(2-hydroxyethyl)-s-triazine, dithiocarbamates such as sodium dimethyldithiocarbamate, and a variety of other materials known in the art for their antimicrobial properties. Other exemplary antimicrobial agents include glutaraldehyde, Bronopol (2-bromo-2-nitropropane-1,3-diol), silver, and isothiazolones as such methylisothiazolinone, ethyl lauroyl arginate HCl, sold under the tradename Neolone™, sodium benzoate, benzyl alcohol, or methylbenzyl alcohol.

In a preferred variant according to the present invention, the detergents and cleaning compositions are further combined with benzyl alcohol, methylbenzyl alcohol, phenoxyethanol, and any mixture thereof. Said substances have a broad-spectrum activity against microorganisms and are added to the detergent compositions to inhibit microbial spoilage, and, thus, for stabilizing purposes.

In particular, the antimicrobial agents are added to liquid detergents due to their higher water content, which makes such compositions susceptible against microbial infestation and growth.

If an antimicrobial agent is included in the inventive detergents and cleaning compositions, it is preferably in an amount between about 0.0001% by weight and about 15% by weight, particularly in an amount of 0.001 to 10.0% by weight, most particularly in an amount of 0.001 to 5.0% by weight, based on the total weight of the composition.

Typically, the at least one bleaching agent is present in the detergent and cleaning composition according to the present invention in an amount of 1.0 to 30.0% by weight, based on the total weight of the composition. In a preferred variant, the detergents and cleaning compositions comprises the bleaching agent (a) in an amount of 2.0 to 27.0% by weight, more preferred in an amount of 3.0 to 25.0% by weight. Most preferred, the bleaching agent (a) is included in the detergent and cleaning composition according to the present invention in an amount of 5.0 to 20.0% by weight, based on the total weight of the composition.

Typically, the bleach activator is present in the detergent and cleaning composition according to the present invention in an amount of 0.1 to 60.0% by weight. In a preferred variant, the detergents and cleaning compositions comprises the bleach activator in an amount of 0.2 to 40.0% by weight, more preferred in an amount of 0.3 to 30.0% by weight. Most preferred, the bleach activator is included in the detergent and cleaning composition according to the present invention in an amount of 0.5 to 20.0% by weight, based on the total weight of the composition.

The 1,2-heptanediol (b1) or the 2,3-heptanediol (b2) or the mixture comprising 1,2-heptanediol and 2,3-heptanediol (b3) according to the present invention is present in the detergent and cleaning composition in an amount of 0.001 to 15.0% by weight, based on the total weight of the composition. In a preferred variant, the detergent and cleaning composition comprises the 1,2-heptanediol (b1) or the 2,3-heptanediol (b2) or the mixture comprising 1,2-heptanediol and 2,3-heptanediol (b3) in an amount of 0.01 to 10.0% by weight, based on the total weight of the composition. In a more preferred variant, the 1,2-heptanediol (b1) or 2,3-heptanediol (b2) or the mixture comprising 1,2-heptanediol and 2,3-heptanediol (b3) is advantageously used in the detergent and cleaning composition in an amount of at 0.1 to 5.0% by weight, based on the total weight of the composition. In a still more preferred variant, the 1,2-heptanediol (b1) or 2,3-heptanediol (b2) or the mixture comprising 1,2-heptanediol and 2,3-heptanediol (b3) is advantageously used in the detergent and cleaning composition in an amount of at 0.3 to 3.0% by weight, based on the total weight of the composition. In a most preferred variant, the 1,2-heptanediol (b1) or 2,3-heptanediol (b2) or the mixture comprising 1,2-heptanediol and 2,3-heptanediol (b3) is advantageously used in the detergent and cleaning composition in an amount of at 0.5 to 1.0% by weight, based on the total weight of the composition.

For the heptanediol mixture (b3), the above amounts relate to the total content of the 1,2-heptanediol and the 2,3-heptanediol in the mixture, i.e. the amount is the sum of the content of 1,2-heptanediol and 2,3-heptanediol in the mixture.

The at least one bleach boosting agent (b) according to the another aspect of the present invention is present in the detergent and cleaning composition in an amount of 0.001 to 15.0% by weight, based on the total weight of the composition. In a preferred variant, the detergent and cleaning composition comprises the at least one bleach boosting agent (b) in an amount of 0.01 to 10.0% by weight, based on the total weight of the composition. In a more preferred variant, the at least one bleach boosting agent (b) is advantageously used in the detergent and cleaning composition in an amount of at 0.1 to 5.0% by weight, based on the total weight of the composition. In a still more preferred variant, the at least one bleach boosting agent (b) is advantageously used in the detergent and cleaning composition in an amount of at 0.3 to 3.0% by weight, based on the total weight of the composition. In a most preferred variant, the at least one bleach boosting agent (b) is advantageously used in the detergent and cleaning composition in an amount of at 0.5 to 1.0% by weight, based on the total weight of the composition.

For the alkane mixture comprising at least one first linear alkanediol and one or more second linear alkanediol, the above amounts relate to the total content of the first linear alkanediol and the second linear alkanediol(s) in the mixture, i.e. the amount is the sum of the content of the first linear alkanediol and the second linear alkanediol in the mixture.

For a bleach boosting mixture comprising two or more boosting agents, the above amounts relate to the total content of the boosting agents in the mixture, i.e. the amount is the sum of the content of the single boosting agents in the mixture.

In a particular preferred variant according to the first aspect of the present invention, the detergent and cleaning composition comprises the 2,3-heptanediol or the 2,3-heptanediol of the mixture comprising 1,2-heptanediol and 2,3-heptanediol (b3) in an amount of 0.001 to 15.0% by weight, preferred in an amount of 0.01 to 10.0% by weight, more preferred in an amount of 0.1 to 5.0% by weight, still more preferred in an amount of 0.3 to 3.0% by weight, and most preferred in an amount of 0.5 to 1.0% by weight, based on the total weight of the composition.

Even more preferred, the detergent and cleaning composition comprises the 2,3-heptanediol or the 2,3-heptanediol of the mixture comprising 1,2-heptanediol and 2,3-heptanediol (b3) in an amount of 0.001 to 0.5% by weight, preferably in an amount of 0.005 to 0.1% by weight and most preferably in an amount of 0.01 to 0.075% by weight, based on the total weight of the composition or homecare product.

In a particular preferred variant according to the other aspect of the present invention, the detergent and cleaning composition comprises the 2,3-alkandediol as linear alkanediol or of the mixture comprising at least one first linear alkanediol and one or more second linear alkanediol in an amount of 0.001 to 15.0% by weight, preferably in an amount of 0.01 to 10.0% by weight, more preferred in an amount of 0.1 to 5.0% by weight, still more preferred in an amount of 0.3 to 3.0% by weight, and most preferred in an amount of 0.5 to 1.0% by weight, based on the total weight of the composition or homecare product.

Even more preferred, the detergent and cleaning composition comprises the 2,3-alkanediol as linear alkanediol or of the mixture comprising at least one first linear alkanediol and one or more second linear alkanediol in an amount of 0.001 to 0.5% by weight, preferably in an amount of 0.005 to 0.1% by weight and most preferably in an amount of 0.01 to 0.075% by weight, based on the total weight of the composition or homecare product.

Typically, the at least one surfactant is present in the detergent and cleaning composition according to the present invention in an amount of 0.001 to 90% by weight, based on the total weight of the composition. Preferably, the surfactant is present in an amount of 0.001 to 60% by weight, based on the total weight of the composition. More preferred, the detergent and cleaning composition according to the present invention comprises the surfactant in an amount of 0.01 to 50% by weight and most preferred in an amount of 0.1 to 40% by weight, based on the total weight of the composition.

Preferably, the at least one surfactant is present in the detergent and cleaning composition according to the present invention in an amount of 4 to 90% by weight, based on the total weight of the composition. More preferred, the detergent and cleaning composition according to the present invention comprises the surfactant in an amount of 10 to 60% by weight, still more preferred in an amount of 20 to 50% by weight and most preferred in an amount of 30 to 40% by weight, based on the total weight of the composition.

By contrast, light-duty compositions according to the present invention comprise the at least one surfactant in an amount of 0.001 to 40% by weight, based on the total weight of the composition. Preferably, the surfactant is present in an amount of 0.005 to 30% by weight, based on the total weight of the composition. The dish cleaning and/or rinsing composition according to the present invention comprises the surfactant in an amount of 0.01 to 25% by weight and preferred in an amount of 0.1 to 20% by weight, based on the total weight of the composition.

The enzyme(s) is/are normally incorporated into the detergent and cleaning composition according to the disclosure in an amount sufficient to yield effective cleaning during a washing procedure. An amount effective for cleaning refers to an amount that produces a clean, sanitary, and, preferably, corrosion free appearance to the material cleaned, particularly for medical or dental devices or instruments. An amount effective for cleaning also can refer to an amount that produces a cleaning, stain removal, soil removal, whitening deodorizing, or freshness improving effect on substrates such as medical or dental devices or instruments and the like. Such a cleaning effect can be achieved with amounts of enzyme as low as about 0.02% by weight of the detergent and cleaning composition.

In the detergents and cleaning compositions of the present disclosure, suitable cleaning can typically be achieved when an enzyme is present at about 0.0001 to about 35% by weight; preferably about 2 to about 15% by weight; preferably about 3 to about 10% by weight; preferably about 4 to about 8% by weight; preferably about 4, about 5, about 6, about 7, or about 8% by weight. The higher enzyme levels are typically desirable in highly concentrated cleaning formulations.

In the detergent and cleaning composition of the present invention, suitable cleaning can be achieved when the enzyme is present in the detergent and cleaning composition according to the present invention in an amount of 0.0001 to 5% by weight, based on the total weight of the composition. Preferably, the enzyme is present in an amount of 0.0001 to 4% by weight, based on the total weight of the composition. More preferred the detergent and cleaning composition according to the present invention comprises the enzyme in an amount of 0.001 to 3% by weight, based on the total weight of the composition. Most preferred the enzyme is present in the detergent and cleaning composition in an amount of 0.01 to 2% by weight, based on the total weight of the composition. Further preferred the enzyme is present in the detergent and cleaning composition in an amount of 0.05 to 2% by weight, based on the total weight of the composition.

Typically, the enzyme is present in the detergent and cleaning composition according to the present invention in an amount of 0.05 to 2.0% by weight. Usually, proteases and amylase are used in higher concentrations in the detergents and cleaning compositions, namely proteases in an amount of 0.4 to 1.5% by weight, amylases in an amount of 0.05 to 0.6% by weight, based on the total weight of the composition.

For an enzyme cocktail the above amounts relate to the total content of the enzymes in the mixture, i.e. the amount is the sum of the content of all enzymes in the mixture.

The detergents and cleaning compositions of the current disclosure are found, surprisingly, to have a superior cleaning performance, compared to detergents and cleaning compositions without the addition of an inventive bleach boosting agent.

Surprisingly, it has been found that the addition of an effective amount of 1,2-heptanediol or 2,3-heptanediol or a mixture comprising 1,2-heptanediol and 2,3-heptanediol or a specific type of bleach boosting agent, such as alkanediols as specified herein, glyceryl caprylate, 4-hydroxyacetophenone, tropolone, or a mixture of said bleach boosting agents, to a detergent and cleaning composition has a positive influence in that they enhance the bleaching power of a bleaching agent or bleaching agent mixture comprised therein. The detergents and cleaning compositions comprising a combination of bleaching agent and bleach boosting agent shows a superior bleaching performance, compared to detergents and cleaning compositions without such a bleach boosting agent.

Surprisingly, it has been found that the addition of an effective amount of 1,2-heptanediol or 2,3-heptanediol or a mixture comprising 1,2-heptanediol and 2,3-heptanediol or a specific type of bleach boosting agent, such as alkanediols, glyceryl caprylate, 4-hydroxyacetophenone, tropolone, or a mixture of said bleach boosting agents, to a detergent and cleaning composition, improves bleachable stain and/or soil removal, compared to a detergent and cleaning composition without the addition of such a bleach boosting agent.

Without wishing to being bound by theory it is believed that alkanediols act as co-surfactants and facilitate the access to bleachable stain and/or soil for bleaching agents during the washing or cleaning process.

Thus, the detergents and cleaning compositions which contain a bleaching agent or a mixture of bleaching agents in combination with a specific type of bleach boosting agent, such as alkanediols as defined herein, glyceryl caprylate, 4-hydroxyacetophenone, tropolone, or a mixture of said bleach boosting agents, exhibit improved overall performance, based on these two described effects, over detergents and cleaning compositions without such a bleach boosting agent.

Conversely, also because of the boosting effect, the amount of bleaching agent and other ingredients for increasing the bleaching effectiveness in these detergents and cleaning compositions can be reduced to achieve a similar cleaning effect, i.e. without loss of cleaning performance.

According to a further aspect of the present invention, the detergent and cleaning composition according to the present invention is used as such or for the preparation of a detergent and cleaning product.

The detergents and cleaning compositions or products as specified herein can be employed in a variety of cleaning methods. As used herein, the term “cleaning” refers to perform, facilitate, or aid in stain and/or soil removal, bleaching, etc. Preferably, the detergents and cleaning compositions or products are useful for textile cleaning, laundry, dishwashing, fabric care, for household, institutional and industrial hard surfaces cleaning, such as ware or other surfaces, cleaning medical and dental instruments, etc.

Preferably, the detergents and cleaning compositions or products can be employed for cleaning, washing, or pre-soaking medical or dental devices, instruments, or equipment, including any of the various medical or dental instruments or devices that can benefit from cleaning with enzyme cleaning composition. Exemplary medical and dental instruments and devices include instruments, devices, tools, appliances, apparatus, and equipment used in medicine or dentistry including those than can be cold sterilized, soaked or washed and then heat sterilized. The medical and/or dental instruments can be soiled with blood, mammalian tissue, including but not limited to human tissue, or other foreign matter.

Suitable examples of detergents and cleaning compositions or products encompass heavy-duty detergents, colour-care detergents, light-duty detergents, all-purpose washing agents, fabric softeners, fabric laundry scents, scent lotions, laundry wipes, stain removers (pre-spotter, Vanish type), washing machine cleaner, all-purpose cleaners, hand dishwashing detergents, auto dishwashing detergents, medical cleaning products, and the like.

In a preferred variant, the detergent and cleaning composition is a stain remover (pre-spotter, Vanish type).

The afore-mentioned detergents and cleaning compositions or products refer to a detergent and cleaning composition in the form of a liquid, a solid, tablets, encapsulated, diluted or concentrated form and optionally in two-compartment or multi-compartment form.

As used herein, a liquid includes free-flowing liquids, as well as pastes, gels, foams and mousses. Non-limiting examples of liquids include light-duty and heavy-duty liquid detergents and cleaning compositions, fabric enhancers, detergent gels commonly used for laundry, bleach and laundry additives. Gases, e.g. suspended bubbles, or solids, e.g. particles, may be included within the liquids.

A solid as used herein, includes powders, flakes, granules, pellets, tablets, microcapsules, beads, noodles, pearlized balls, lozenges, pucks, briquettes, bricks, blocks, or another solid form known to those of skill in the art.

A solid detergent and cleaning composition or product can be provided as a pressed solid block, a cast solid block, an extruded pellet or block, or a tablet. Furthermore, a solid detergent composition or product may be provided in the form of a unit dose. A unit dose refers to a solid detergent and cleaning composition unit sized so that the entire unit is used during a single washing cycle.

A solid detergent and cleaning composition or product may also be provided in the form of a multiple use (e.g., multi-use) solid, such as, a block or a plurality of pellets, and can be repeatedly used to generate aqueous use solutions of the detergent composition for multiple cycles or a predetermined number of dispensing cycles. A multiple use solid detergent composition can be repeatedly used to generate an aqueous detergent composition, e.g., use solution, for multiple washing cycles. Pressed solid detergent blocks are made suitable to provide stability such that reactive components in the compositions do not react with each other until a point of dilution and/or use. In some aspects, the order of introducing the components to form the solid are non-limiting as there is minimal and/or no water introduced into the solid compositions. However, in some aspects, pressed solid detergent blocks are made by using a binding system to minimize any damage to the coated granules which may be employed. Beneficially, a pressing process to make the pressed solid detergent blocks generates a pressed solid detergent block and prevents the reaction or mix of the components. In an aspect of the disclosure, the solid detergent composition remains unreacted or unmixed until a point of use, e.g. dilution.

In a pressed solid process, a flowable solid, such as granular solids or other particle solids including binding agents are combined under pressure. In a pressed solid process, flowable solids of the compositions are placed into a form (e.g., a mold or container). The method can include gently pressing the flowable solid in the form to produce the solid cleaning composition.

The detergents and cleaning compositions or products can be provided in concentrated form and diluted to a use solution or provided in a use solution. Preferably, the use compositions are diluted to a concentration between about 500 ppm and about 5000 ppm, more preferably between about 750 ppm and about 4500 ppm, most preferably between about 1000 ppm and about 4000 ppm.

The detergents and cleaning compositions or products according to the present invention are used for household cleaning, medical cleaning, institutional cleaning, such as cleaning in schools, airports, hospitals, or industrial cleaning.

The detergents and cleaning compositions or products according to the present invention can be prepared by combining and mixing the various ingredients according to usual and known methods. Preferably, the enzyme is added last to prevent denaturation or inactivation of the enzyme. Mixing can be performed by any suitable automatic or manual method. For example, automatic or manual stirring can be performed. The detergent compositions can be prepared in batch or continuous process.

Based on its afore described advantageously effects, the detergent and cleaning composition or product according to the present invention, comprising a combination of a bleaching agent and a bleach boosting agent, such as alkanediols as specified herein, glyceryl caprylate, 4-hydroxyacetophenone, tropolone, or a mixture of said bleach boosting agents, is particularly efficient in washing and cleaning processes for efficiently removing bleachable stain and/or soil from substrates.

Thus, the present invention relates in a further aspect to a method of treating a stained and/or soiled substrate, comprising the steps of
treating the substrate with the detergent and cleaning composition or product according to the present invention; and
rinsing said substrate in water to remove said composition or product.

Preferably, the method of treating a stained and/or soiled substrate takes place in a washing containing a wash liquor comprising water and the detergent and cleaning composition or product according to the present invention. The wash liquor may be applied to the substrate or the substrate may be immersed into the wash liquor.

The method may alternatively comprise direct application of the detergent and cleaning composition or product, i.e. undissolved without water on to part or whole of the substrate, so as to directly treat a bleachable stain and/or soil on the substrate. Such a process is preferably a pre-treatment and may be followed by treatment with or within a wash liquor.

The method according to the present invention is applied at both higher temperatures and well as lower temperatures. Ware wash applications, for example, clean substrates at temperatures in excess of approximately 60° C., or in excess of approximately 70° C., or between approximately 65° C. to 80° C. Laundry applications, for example, clean laundry at temperatures in excess of approximately 40° C., or in excess of approximately 50° C., or between approximately 65° C. to 90° C.

Preferably, the method is applied at low temperatures where removal of stain and/or soil is more problematic. Preferably, the treatment temperature is less than 50° C. and preferably less than 40° C. and more preferably less than 30° C.

Surprisingly it turned out, that the method according to the present invention is particularly efficient in bleachable stain and/or soil removal at said low temperatures. The cold-water bleaching performance in detergent systems accounts for their emergent utilization.

This is particularly advantageous in the treatment of sensitive substrates such as wool, silk, and synthetic fibers such as polyester, polyacrylic, nylon, which can be washed or cleaned only at low temperatures.

Preferably, the substrate is cotton.

More preferably, the substrate is wool or silk.

Still more preferred, the substrates are blended fabrics such as cotton and polyester, or synthetic fibers, such as polyester, polyacrylic, or nylon.

The use of the detergent and cleaning composition or product according to the present invention in the method according to the present invention provides for improved bleaching and improved removal of stain and/or soil, in particular of bleachable stain/and or oil, and, hence, results in an improved overall cleaning performance.

Based on the advantageously bleaching agent boosting and improved bleachable stain and/or soil removal effects, as described above for the bleach boosting agents, the present invention relates in a further aspect to the use of at least one bleach boosting agent selected from the group consisting of
(b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined herein;
(b^{II}) glyceryl caprylate;
(b^{III}) 4-hydroxyacetophenone;
(b^{IV}) tropolone; and
any mixture thereof;
for improving the bleaching power of a bleaching agent in a detergent and cleaning composition and/or for boosting bleachable stain and/or soil removal of a detergent and cleaning composition.

With respect to the bleach boosting agents and preferred variants thereof, reference is made to the previous description of the bleach boosting agents in connection with the detergents and cleaning composition according to the present invention, which is equally valid in connection with the use of at least one bleach boosting agent for improving the bleaching power of a bleaching agent in a detergent and cleaning composition and/or for boosting bleachable stain and/or soil removal of a detergent and cleaning composition, in order to avoid repetition.

Preferably, the bleaching agent is selected from the group consisting of
peroxygen bleaches, selected from the group consisting of
   hydrogen peroxide (H2O2), alkali metal peroxide,
   alkali metal percarbonates,
   alkali metal perborates,
   alkali metal perphosphates,
   alkali metal persulfates and
   alkali metal persilicates,
   and any mixture thereof;
percarboxylic acid bleaches and salts thereof;
   and any mixture thereof.

More preferred, the bleaching agent is selected from the group consisting of hydrogen peroxide, sodium percarbonate, sodium perborate, peracetic acid, glucose oxidase, phthalimido peroxycaproic acid, and any mixture thereof.

It was surprisingly found that the use of at least one bleach boosting agent as defined herein improves bleaching performance of a bleaching agent in a detergent and cleaning composition and improves bleachable stain and/or soil removal performance of a detergent and cleaning composition, resulting in an improve overall cleaning performance, compared to a detergent and cleaning composition without said bleach boosting substances. This superior effect is based on the combination of the bleaching agent and the bleach boosting agent.

Hence, the use of the bleach boosting agent according to the present invention is beneficial for improving the bleaching power of a bleaching agent in a detergent and cleaning composition and/or improving the cleaning performance of a detergent and cleaning composition in terms of stain and/or soil removal.

The improvement also allows for the reduction of bleaching agent in a detergent and cleaning composition without loss of cleaning performance.

Based on the advantageously bleach boosting effects, as described above for the bleach boosting agents, the present invention finally relates to a method of improving the bleaching power of a bleaching agent in a detergent and cleaning composition and/or of boosting stain and/or soil removal of a detergent and cleaning composition, comprising the steps of
(i) providing a detergent and cleaning composition comprising a bleaching agent; and
(ii) adding thereto an effective amount of at least one bleach boosting agent (b) selected from the group consisting of
   (b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol, as defined herein;
   (b^{II}) glyceryl caprylate;
   (b^{III}) 4-hydroxyacetophenone;
   (b^{V}) tropolone; and
   any mixture thereof.

With respect to the bleach boosting agents and preferred variants thereof, reference is made to the previous description of the bleach boosting agents in connection with the detergents and cleaning composition according to the present invention, which is equally valid in connection with the use of at least one bleach boosting agent for improving the bleaching power of a bleaching agent in a detergent and cleaning composition and/or for boosting bleachable stain and/or soil removal of a detergent and cleaning composition, in order to avoid repetition.

Preferably, the bleaching agent is selected from the group consisting of
peroxygen bleaches, selected from the group consisting of
   hydrogen peroxide (H2O2), alkali metal peroxide,
   alkali metal percarbonates,
   alkali metal perborates,
   alkali metal perphosphates,
   alkali metal persulfates and
   alkali metal persilicates,
and any mixture thereof;
percarboxylic acid bleaches and salts thereof;
   and any mixture thereof.

More preferred, the bleaching agent is selected from the group consisting of hydrogen peroxide, sodium percarbonate, sodium perborate, peracetic acid, glucose oxidase, phthalimido peroxycaproic acid, and any mixture thereof.

Surprisingly, it has been found that the addition of an effective amount of a specific type of bleach boosting agent, such as alkanediols having a carbon chain of 5 to 11 carbon atoms, glyceryl caprylate, 4-hydroxyacetophenone, tropolone, or a mixture of said bleach boosting agents, to a detergent and cleaning composition, enhances the bleaching power of a bleaching agent or a bleaching agent mixture comprised therein. The detergents and cleaning compositions comprising the bleach boosting agent shows a distinguished bleaching power, compared to detergents and cleaning compositions without such a bleach boosting agent. In addition, the combination of the inventive bleach boosting agents with a bleaching agent contributes to an improved bleachable stain and/or soil removal and results in improved cleaning performance of the detergent and cleaning composition, compared to a detergent and cleaning composition without said bleach boosting agents.

Conversely, also because of the bleaching agent boosting effect, the amount of bleaching agent or other ingredients for increasing/improving the bleaching effectiveness in these detergents and cleaning compositions can be reduced to achieve a similar cleaning effect.

The present invention shall now be described in detail with reference to the following examples, which are merely illustrative of the present invention, such that the content of the present invention is not limited by or to the following examples.

### EXAMPLES

### Example 1

The following tests are performed to show the influence of different bleach boosting agents according to the present invention on the bleaching power of different bleaching agents, and, thus, cleaning performance of the detergent and cleaning composition according to the present invention.

The detergent and cleaning composition is a laundry detergent and an auto dishwashing detergent.

In parallel, comparative tests under the same conditions are carried out for a detergent and cleaning composition with the same bleaching agent but without the bleach boosting agent.

The cleaning performance of the tested detergents and cleaning compositions according to the present invention and the comparative detergents cleaning compositions is tested as described below.

### Example 1.1: Laundry Detergent

The cleaning performance for the laundry detergent is analysed according to the standard A.I.S.E. (International Association for Soaps, Detergents and Maintenance Products) Laundry Detergent Testing Guidelines.

The cleaning performance test consists of assessing the stain removal efficiency of the tested laundry detergents on 14 stains.

| | |
|---|---|
| Test conditions: | Washing machine, Miele European Household front loader |
| Water hardness: | 2.5 mmol/l |
| Water temperature: | 40° C. |
| Wash cycle: | 6 cycles (Heavy-duty detergent: cotton cycle; |
| | light-duty detergent: delicate cycle) |
| Ballast load: | 3 kg, clean white ballast load |
| Ballast soil: | 4 SBL 2004 sheets (100% cotton, approx. 8 g soil/swatch) |
| Dosage: | recommended dosage for normal soil/medium hardness |
| Drying: | in line during one night |
| Stain sets: | Tea, chocolate, coffee, grass, red wine, grass/mud, fruit juice, |
| | blood, tomato puree, unused motor oil, salad dressing balsamic, |
| | cooked beef fat, French squeezy mustard, and make-up. |

The measurements/evaluation are taken on each stain before wash (to verify quality of stains) and after the wash.

The evaluation of the degree of stain removal can either be assessed by
(A) a sensory panel (scale 1 to 10: scale 1: no cleaning; scale 10: complete removal)
(B) spectrophotometer, or digital image analysis system to determine the Stains Removal Index (SRI) whiteness degree W.

The results are statistically treated using Tukey's HSD test (HSD=honestly significant difference) with 95% confidence level. The HSD value highlights the significant differences between each pair of products.

### Example 1.2: Machine Dishwashing Detergent

The cleaning performance for the machine dishwashing detergent is analysed according to the IKW Recommendations for the Quality Assessment of the Cleaning Performance of Dishwasher Detergents.

The cleaning performance test consists of assessing the stain removal efficiency of the tested laundry detergents on 14 stains.

| | |
|---|---|
| Test conditions: | Washing machine, Miele dishwasher GSL or Miele GSL 2 |
| Water hardness: | for classic products: 1.8 mmol/l |
| | for multifunctional products: 3.5 mmol/l |
| Water temperature: | in main wash cycle: 45° C. |
| Wash cycle: | at least 3 cycles |
| Dosage: | recommended dosage for normal soil/medium hardness |
| Stain sets: | Black tea (bleachable), |
| | milk, milk skin (persistent/alkaline-sensitive), |
| | starch mix, pasta (starch-containing, amylase sensitive), |
| | egg yolk, creme brulee, minced meat (protein-containing, |
| | protease sensitive) |
| Number of soiled items: | 6 of each type |

The measurements/evaluation are taken on each stain as described in the IKW Recommendation either by visual evaluation with reference to a photographic catalogue or gravimetric.

The obtained results are statistically treated using Tukey's HSD test (HSD=honestly significant difference) with 95% confidence level. The HSD value highlights the significant differences between each pair of products.

It can be seen from the above tests, the detergents and cleaning compositions according to the present invention show a superior cleaning performance in terms of stain removal and/or soil removal, compared to the cleaning performance of a detergent and cleaning composition without an inventive bleach boosting agent. This means conversely, that the bleaching performance in the detergent and cleaning composition is improved by the addition of the inventive bleach boosting agent, whereas in the detergent and cleaning composition without the addition of a bleach boosting agent the bleaching performance is lower.

### Example 2: Evaluation of Bleachable Stain Removal Performance of Stain Removers According to the Present Invention

The following tests are performed to show the influence of different bleach boosting agents according to the present invention on the bleaching power, and, thus, cleaning performance of a detergent and cleaning composition (stain remover) according to the present invention.

For evaluating bleachable stain removal performance, a stain remover comprising a bleaching agent (hydrogen peroxide; H2O2) was tested in combination with different bleach boosting agents. The stain remover was blended with different bleach boosting agents as specified in the following tables and evaluated in accordance with the following described spectro colorimeter measurement in comparison to a stain remover without the addition of bleach boosting agent (placebo).

The stain removal efficacy was tested according to the following test protocol:

Principle: The test consists of assessing the bleachable stain removal efficiency of the tested stain remover on four stains. Fabric stains are artificially applied to specified fabric types and allowed to set for the prescribed amount of time. The size of each sample of stain allows for a reproducible reading (50 mm diameter). These stain swatches are washed/soaked with the tested stain remover being compared and the relative degree of removal of the stains is evaluated. The test allows for comparing products' stain removal ability under the same condition.

Stains selection: In order to test the effectiveness of the stain remover, ready-to-use standardized multi-sample and multi-spot monitors were used (selected and manufactured by Warwick Equest and CFT).

Description of stains:
CS15: Bil(blue) berry juice on cotton
CS97: Highly discriminative tea on cotton.
KC H109: Coffee, espresso on knitted cotton.
KC H026: Red wine on knitted cotton

The stains are manufactured in a reproducible manner and of consistent quality. The stains are a mix of “natural stains” and “standardized stains”. The stains are homogeneously distributed and coloured before and after washing.

| Stain type | Stain name | Sample ID |
|---|---|---|
| Bleach | Blue berry juice | CS15 |
| | Tea | CS97 |
| | Coffee | KC H109 |
| | Red Wine | KC H026 |

Test conditions: Each stain is soaked in a glass beakers containing 20 g of the test solution, for 5 min precisely, which are measured with a timer.

Measurements/evaluation: Averaged reflectance measurements of the fabric are taken using the Spectro colorimeter Ci62 before the tissue is stained, after it is stained, and again after being treated with the tested stain remover and washed. Three measurements are carried out per stain. The performance of the product is evaluated instrumentally in terms of a Stain Removal Index (SRI). The SRI is a scale from 0 to 100, with 0 meaning no stain removal, and 100 meaning complete stain removal.

As describe in ASTM D4265, the SRI is calculated according to the following formula:

$$SRI = \frac{100 \times Δ E * ( US - UF ) - Δ E * ( WS - UF )}{Δ E * ( US - UF )}$$

where:
US=unwashed stain area
UF=unwashed (unstained) fabric area
ΔE*(US−UF)=Delta-E colour difference between the unwashed stain and the unwashed fabric
ΔE*(WS−UF)=Delta-E colour difference between the washed stain and the unwashed fabric.

The value ΔE (absolute colour difference) is calculated as:

$$Δ E *= \sqrt{Δ L {*}^{2} + Δ a {*}^{2} + Δ b {*}^{2}}$$

where:
L=reflectance
a=redness/greenness
b=yellowness/blueness

The tested stain removers are compared to each other as follows: the higher the SRI is, the better is the bleachable stain removal performance.

For testing the boosting efficacy of different bleach boosting agents in a stain remover, a stain remover formulation was used with the following composition:

| | Amount |
|---|---|
| Ingredients | (% by weight) |
| Water | ad 100.00 |
| Hydrogen peroxide 12% | 37.50 or 8.50 |
| Sodium C14-16 olefin sulfonate 38% | 1.50 |
| (NANSA ® LSS38/U) | |
| Bleach boosting agent | X |
| (as specified in the tables below) | |

To said stain remover, different boosting agents according to the present invention in different concentrations were added as specified in the following tables, and the stain removal performance was evaluated according to the test method described above.

In the following tables, the following abbreviations are used:
C5=1,2-pentanediol
C6=1,2-hexanediol
C7=1,2-heptanediol
C8=1,2-octanediol
C10=1,2-decanediol

### 2.1 Stain Removal Boosting Performance of Different 1,2-Alkanediols on Blue Berry Juice Stain

TABLE 1

| | | SRI sum |
|---|---|---|
| Stain remover | Bleach boosting agent | on blue |
| No. | (% by weight) | berry stain |
| FSR4 | C5 0.75 | 61.318 |
| FSR13 | C8 0.75 | 58.300 |
| FSR1 | Placebo (without bleach boosting agent) | 58.238 |
| | (stain remover formulation: H2O2 content: | |
| | 37.50% by weight) | |

Surprisingly, the addition of a 1,2-alkanediol to a stain remover formulation comprising the bleaching agent H2O2 (12%) (37.50% by weight) result in an improved SRI on blue berry juice stain compared to a stain remover formulation without the bleach boosting agent. By adding 1,2-pentanediol or 1,2-octanediol to a stain remover formulation, the bleaching performance can be improved. The best bleach boosting effect shows 1,2-pentanediol.

### 2.2 Stain Removal Boosting Performance of Different 1,2-Alkanediols on Tea Stain

TABLE 2

| Stain remover | Bleach boosting agent | SRI sum |
|---|---|---|
| No. | (% by weight) | on tea stain |
| FSR35 | C7 0.5 | 26.440 |
| FSR38 | C8 0.75 | 26.270 |
| FSR31 | C5 0.5 | 23.160 |
| FSR33 | C6 0.5 | 22.800 |
| FSR30 | Placebo (without bleach boosting agent) | 20.680 |
| | (stain remover formulation: H2O2 content: | |
| | 8.50% by weight) | |

Surprisingly, the addition of a 1,2-alkanediol to a stain remover formulation comprising the bleaching agent H2O2 (12%) (8.50% by weight) result in an improved SRI on tea stain compared to a stain remover formulation without the bleach boosting agent. By adding 1,2-pentanediol, 1,2-hexanediol, 1,2-heptanediol or 1,2-octanediol to a stain remover formulation, the bleaching performance can considerably be improved.

### 2.3 Stain Removal Boosting Performance of Different 1,2-Alkanediols on Coffee Stain

TABLE 3

| | | SRI sum |
|---|---|---|
| Stain remover | Bleach boosting agent | on coffee |
| No. | (% by weight) | stain |
| FSR34 | C6 0.75 | 39.440 |
| FSR32 | C5 0.75 | 37.080 |
| FSR30 | Placebo (without bleach boosting agent) | 33.690 |
| | (stain remover formulation: H2O2 content: | |
| | 8.50% by weight) | |

Surprisingly, the addition of a 1,2-alkanediol to a stain remover formulation comprising the bleaching agent H2O2 (12%) (8.50% by weight) result in an improved SRI on coffee stain compared to a stain remover formulation without the bleach boosting agent. By adding 1,2-pentanediol or 1,2-hexanediol to a stain remover formulation in the same concentration, the bleaching performance can considerably be improved. The best bleach boosting effect shows 1,2-hexanediol on coffee stain.

### 2.4 Stain Removal Boosting Performance of Different 1,2-Alkanediols on Red Wine Stain

TABLE 4

| | | SRI sum |
|---|---|---|
| Stain remover | Bleach boosting agent | on red |
| No. | (% by weight) | wine stain |
| FSR7 | C6 0.75 | 55.664 |
| FSR10 | C7 0.75 | 53.960 |
| FSR4 | C5 0.75 | 53.519 |
| FSR1 | Placebo (without bleach boosting agent) | 53.443 |
| | (stain remover formulation: H2O2 content: | |
| | 37.50% by weight) | |

Surprisingly, the addition of a 1,2-alkanediol to a stain remover formulation comprising the bleaching agent H2O2 (12%) (37.50% by weight) result in an improved SRI on red wine stain compared to a stain remover formulation without the bleach boosting agent. By adding 1,2-pentanediol, 1,2-hexanediol or 1,2-heptanediol to a stain remover formulation in the same concentration, the bleaching performance can be improved. This effect is of particular benefit, since red wine stain is a very persistent stain and difficult to be removed.

### Example 3: Formulation Examples

TABLE F1
Laundry pre-spotter (use before wash)

| No | Ingredients | Amount (%) |
|---|---|---|
| 1 | Hydrogen peroxide | 10.5 |
| 2 | C12-14 PARETH-7 | 2.4 |
| 3 | Sulfonic acid, C 13-17-sec- | 2.3 |
| | Alkyl-, Sodium salt | |
| 4 | Etidronic Acid | 0.7 |
| 5 | 2,3-heptanediol | 0.1 |
| 6 | 1,2-heptanediol | 0.9 |
| 7 | Fragrance | 0.4 |
| 8 | Aqua | add to 100 |

TABLE F2
Laundry powder

| No | Ingredients | Amount (%) |
|---|---|---|
| 1 | Sodium sulfate | add to 100 |
| 2 | Sodium chloride | 18 |
| 3 | Sodium percarbonate (Sodium carbonate peroxide) | 15 |
| 4 | Sodium carbonate | 10 |
| 5 | Sodium C10-13 Alkyl Benzenesulfonate | 9 |
| 6 | Sodium silicate | 9 |
| 7 | Zeolite | 7 |
| 8 | TAED | 3 |
| 9 | Cellulose | 2.2 |
| 10 | Tetrasodium Etidronate | 2 |
| 11 | MGDA | 1.7 |
| 12 | C12-14 Pareth-n | 1.5 |
| 13 | Sodium Soap C16-C18 Palm | 0.8 |
| 14 | Disodium 2,2′-([1,1′-biphenyl]-4,4′- | 0.6 |
| | diyldivinylene)bis(benzenesulphonate) | |
| 15 | 1,2-heptanediol | 0.9 |
| 16 | Fragrance | 0.4 |
| 17 | Protease | 1.5 |
| 18 | Amylase | 0.6 |
| 19 | Lipase | 0.2 |
| 20 | Mannanase | 0.1 |
| 21 | Pectate lyase | 0.1 |
| 22 | Benzotriazole | 0.3 |

TABLE F3
Automatic Dishwashing tablet

| No | Ingredients | Amount (%) |
|---|---|---|
| 1 | Sodium carbonate | add to 100 |
| 2 | Sodium citrate | 15 |
| 3 | MGDA | 15 |
| 4 | Sodium percarbonate (Sodium carbonate peroxide) | 13 |
| 5 | Fatty alcohol polyglycol ether | 4 |
| 6 | Polyacrylate sulphonated copolymer | 4 |
| 7 | Polyethylene glycol (MW 400-MW 8000) | 3 |
| 8 | Sodium sulphate | 5 |
| 9 | Sodium silicate | 5 |
| 10 | Zeolite | 4 |
| 11 | TAED | 2 |
| 12 | Cellulose | 1 |
| 13 | Tetrasodium Etidronate | 2 |
| 18 | 1,2-heptanediol | 0.9 |
| 19 | Fragrance | 0.4 |
| 20 | Mn-TACN | 0.04 |
| 21 | Protease | 1.7 |
| 22 | Amylase | 0.7 |
| 23 | Benzotriazole | 0.3 |

1. A detergent and cleaning composition, comprising
(a) at least one bleaching agent and optionally at least one bleach activator;
(b) at least one bleach boosting agent selected from the group consisting of
(b^{I}) at least one linear alkanediol having a carbon chain of 5 to 11 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol;
(b^{II}) glyceryl caprylate;
(b^{III}) 4-hydroxyacetophenone;
(b^{IV}) tropolone; and
any mixture thereof; and
(c) at least one surfactant; and
(d) optionally at least one enzyme or an enzyme formulation, comprising at least one enzyme.

2. The detergent and cleaning composition according to claim 1, wherein the at least one bleaching agent is selected from the group consisting of
chlorine bleaches, selected from the group consisting of sodium hypochlorite (NaOCl);
peroxygen bleaches, selected from the group consisting of
hydrogen peroxide (H2O2), alkali metal peroxide,
alkali metal percarbonates,
alkali metal perborates,
alkali metal perphosphates,
alkali metal persulfates and
alkali persilicates,
and any mixture thereof;
percarboxylic acid bleaches and salts thereof;
photoactivated bleaches, selected from sulfonated zinc, aluminium phthalocyanines, and any mixture thereof;
chlorine or bromine releasing bleaches, such as heterocyclic N-bromo and N-chloroamides, such as trichloroisocyanuric acid, tribromoisocyanuric acid, dibromoisocyanuric acid and dichloroisocyanuric acid; hydantoin compounds, such as 1,3-dichloro-5,5-dimethylhydantoin;
and any mixture thereof; and/or
wherein the at least one bleach activator is selected from the group consisting of
polyacylated alkylenediamines, preferably tetraacetylethylenediamine (TAED);
acylated triazine derivatives, preferably 1,5-diacetyl-2,4-dioxohexahydro-1,3,5-triazine (DADHT);
acylated glycolurils, preferably tetraacetylglycoluril (TAGU);
N-acylimides, preferably N-nonanoylsuccinimide (NOSI);
acylated phenolsulfonates, preferably n-nonanoyl- or isononanoyloxybenzenesulfonate (n- or iso-NOBS);
lactams, preferably benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof, optionally adsorbed onto solid carriers;
and any mixture thereof.

3. The detergent and cleaning composition according to claim 1, wherein the at least one linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, and any mixture thereof; and/or
the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, and any mixture thereof.

4. The detergent and cleaning composition according to claim 3, wherein the at least one linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, and any mixture thereof;
or
wherein the at least one linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, and any mixture thereof;
or
wherein the mixture comprising at least one first linear alkanediol and one or more second linear alkanediol is selected from the group consisting of
a mixture comprising 1,2-pentanediol and 2,3-pentanediol;
a mixture comprising 1,2-hexanediol and 2,3-hexanediol;
a mixture comprising 1,2-heptanediol and 2,3-heptanediol;
a mixture comprising 1,2-octanediol and 2,3-octanediol;
a mixture comprising 1,2-nonanediol and 2,3-nonanediol;
a mixture comprising 1,2-decanediol and 2,3-decanediol;
a mixture comprising 1,2-undecanediol and 2,3-undecanediol;
a mixture comprising 1,2-hexanediol and 1,2-octanediol;
a mixture comprising 1,2-hexanediol and 2,3-octanediol;
a mixture comprising 1,2-octanediol and 2,3-hexanediol;
a mixture comprising 1,2-octanediol and 2,3-heptanediol;
a mixture comprising 1,2-pentanediol and 2,3-hexanediol;
a mixture comprising 1,2-pentanediol and 2,3-heptanediol;
a mixture comprising 1,2-pentanediol and 2,3-octanediol;
a mixture comprising 1,2-pentanediol and 1,2-nonanediol;
a mixture comprising 1,2-pentanediol and 2,3-nonanediol;
a mixture comprising 1,2-heptanediol and 1,2-pentanediol;
a mixture comprising 1,2-heptanediol and 1,2-hexanediol;
a mixture comprising 1,2-heptanediol and 1,2-octanediol;
a mixture comprising 1,2-heptanediol and 2,3-octanediol;
a mixture comprising 1,2-heptanediol and 1,2-nonanediol;
a mixture comprising 1,2-heptanediol and 2,3-nonanediol;
a mixture comprising 1,2-heptanediol and 1,2-decanediol; and
a mixture comprising 1,2-heptanediol and 1,2-undecanediol.

5. The detergent and cleaning composition according to claim 1, wherein the mixture comprising at least one first linear alkanediol and one or more second linear alkanediol comprises the first linear alkanediol and the second alkanediol in a ratio in a range of 50:50 to 99.9:0.1.

6. The detergent and cleaning composition according to claim 1, wherein the at least one surfactant is selected from the group consisting of anionic surfactants, cationic surfactants, non-ionic surfactants, amphoteric/zwitterionic surfactants, and any mixture thereof.

7. The detergent and cleaning composition according to claim 1, wherein the at least one enzyme is selected from the group consisting of proteases, amylases, lipases, cellulases, cutinases, glucanases, peroxidases, pectinases, mannanases, esterases, hemicellulases, xylanases, phospholipases, pectate lyases, keratinases, reductases, nucleases, phenoloxidases, lipoxygenases, ligninases, pullulanases, tannases, pentosanases, malanases, β-glucanases, arabinosidases, hyaluronidases, chondroitinase, oxidoreductases, such as oxidases, oxygenases, catalases, peroxidases, such as halo-, chloro-, bromo-, lignin-, glucose- or manganese-peroxidases, dioxygenases or laccase such as phenoloxidases, polyphenol oxidases, and any mixture thereof.

8. The detergent and cleaning composition according to claim 1, further comprising a bleaching catalyst, wherein the bleaching catalyst contains as macromolecular ligands
1,4,7-trimethyl-1,4,7-triazacyclononane (Me-TACN),
1,4,7-triazacyclononane (TACN),
1,5,9-trimethyl-1,5,9-triazacyclododecane (Me-TACD),
2-methyl-1,4,7-trimethyl-1,4,7-triazacyclononane (Me/Me-TACN), or
2-methyl-1,4,7-triazacyclononane (Me/TACN),
wherein Me stands for Mn, Fe, Co, Ru or Mo, or any mixture thereof.

9. The detergent and cleaning composition according to claim 1, further comprising active substances and/or additives selected from the group consisting of solvents, builders, soil release agents, dispersing agents, foam inhibitors, sequestrant agents, chelating agents, anti-redeposition agents, dye transfer inhibition/colour protection agents, dye scavengers, dyes, greying inhibitors, optical brighteners, ultraviolet light absorbers, thickeners or rheology modifiers, hydrotropes, solubility modifiers, pH-adjusting agents, buffers, solvents, anti-static agents, anti-wrinkling agents, antimicrobial agents, odor removal/odor capturing agents, soil shielding/soil releasing agents, ultraviolet light protection agents, fragrances, sanitizing agents, disinfecting agents, water repellency agents, insect repellency agents, anti-pilling agents, souring agents, mildew removing agents, allergicide agents, and any mixture thereof.

10. The detergent and cleaning composition according to claim 1, comprising the bleaching agent in an amount of 1.0 to 30.0% by weight, based on the total weight of the composition; and/or
comprising the bleaching activator in an amount of 0.1 to 60.0% by weight, based on the total weight of the composition; and/or
comprising the at least one bleach boosting agent (b) in an amount of 0.001 to 15.0% by weight, based on the total weight of the composition; and/or
comprising the at least one surfactant in an amount of 0.001 to 90% by weight, based on the total weight of the composition; and/or
comprising the at least one enzyme in an amount of 0.0001 to 5% by weight, based on the total weight of the composition.

11. A method of preparing a detergent and cleaning product comprising formulating the product with the detergent and cleaning composition according to claim 1.

12. A detergent and cleaning product comprising the detergent and cleaning composition according to claim 1, wherein the detergent and cleaning composition or product is a heavy-duty detergent, colour-care detergent, light duty detergent, all-purpose washing agent, fabric softener, fabric laundry scent, scent lotion, laundry wipe, stain remover (pre-spotter, Vanish type), washing machine cleaner, homecare products, all-purpose cleaner, hand dishwashing detergent, auto dishwashing detergent, medical cleaning products,
wherein the product is in liquid, solid, gelled, bar, paste, spray, tablet, encapsulated, diluted or concentrated form and optionally in two-compartment or multi-compartment form;
and wherein the product is for household, medical, institutional, or industrial applications.

13. A method of treating a stained and/or soiled substrate, comprising the steps of
treating the substrate with the detergent and cleaning composition according to claim 1; and
rinsing said substrate in water to remove said composition or product.

14. (canceled)

15. A method of improving the bleaching power of a bleaching agent in a detergent and cleaning composition and/or of boosting stain and/or soil removal of a detergent and cleaning composition, comprising the steps of
(i) providing a detergent and cleaning composition comprising a bleaching agent; and
(ii) adding thereto an effective amount of at least one bleach boosting agent selected from the group consisting of
(b^{I}) at least one linear alkanediol having a carbon chain of 5 to 11 carbon atoms or a mixture comprising at least one first linear alkanediol having a carbon chain of 5 to 11 carbon atoms and one or more second linear alkanediol having a carbon chain of 5 to 11 carbon atoms which is different from the first linear alkanediol;
(b^{II}) glyceryl caprylate;
(b^{III}) 4-hydroxyacetophenone;
(b^{V}) tropolone; and
any mixture thereof.

16. The detergent and cleaning composition according to claim 5, wherein the mixture comprising at least one first linear alkanediol and one or more second linear alkanediol comprises the first linear alkanediol and the second alkanediol in a ratio in a range of 90:10 to 95:5.

17. The detergent and cleaning composition according to claim 6, wherein
the anionic surfactant is selected from the group consisting of
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide;
and any mixture thereof;
the cationic surfactant is selected from the group consisting of
quaternary C8 to C18 alkyl ethanolamines;
quaternary C8 to C18 alkyl ammonium compounds;
C8 to C18 alkyl ammonium methosulfates;
and any mixture thereof;
the non-ionic surfactant is selected from the group consisting of
C6 to C18 fatty alcohols, ethoxylated with 1 to 12 moles ethylene oxide;
alkoxylated C6 to C18 fatty alcohols such as
C6 to C18 fatty alcohols, ethoxylated with 1 to 25 moles ethylene oxide,
C6 to C18 fatty alcohols, propoxylated with 1 to 15 moles propylene oxide,
C6 to C18 fatty alcohols, butoxylated with 1 to 10 moles butylene oxide,
and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
and any mixture thereof; and
the amphoteric/zwitterionic surfactant is selected from the group consisting of
C10 to C18 N-(alkyl)-N,N-dimethylamine oxide;
C10 to C18 N-(alkyl)-N,N-bis(2-hydroxyethyl)amine oxide;
C10 to C18 alkyl amido propyl dimethyl amine oxide;
C10 to C18 alkylbetaines;
C10 to C18 alkylamidobetaines;
C10 to C18 sulfobetaines;
and any mixture thereof;
and any mixture of the above specified cationic, anionic, non-ionic and amphoteric/zwitterionic surfactants.

18. The detergent and cleaning composition according to claim 7 wherein the nucleases are DNases and/or RNases.

19. The detergent and cleaning composition according to claim 9, wherein the antimicrobial agent is selected from the group consisting of benzyl alcohol, methylbenzyl alcohol, phenoxyethanol, and any mixture thereof.

20. The detergent and cleaning composition according to claim 10, comprising the bleaching agent in an amount of 5.0.0 to 20.0% by weight, based on the total weight of the composition; and/or
comprising the bleaching activator in an amount of 0.5. to 20.0% by weight, based on the total weight of the composition; and/or
comprising the at least one bleach boosting agent (b) in an amount of 0.5 to 1.0% by weight, based on the total weight of the composition; and/or
comprising the at least one surfactant in an amount of 0.1 to 40% by weight, based on the total weight of the composition; and/or
comprising the at least one enzyme in an amount of 0.05 to 2% by weight based on the total weight of the composition.

21. The method of preparing a detergent and cleaning product according to claim 11, wherein the detergent and cleaning product is formulated for use in textile cleaning, laundry, fabric care, dishwashing, household, institutional and industrial cleaning, and cleaning medical and dental instruments.
